(19) United States
(12) Patent Application Publication
(10) Pub. No.: US 2026/0180358 A1
(43) Pub. Date: Jun. 25, 2026

(54) LOW VOLTAGE NETWORK DISTRIBUTED ENERGY MANAGEMENT

(71) Applicant: Itron, Inc., Liberty Lake, WA (US)

(72) Inventor: Frank Anthony Monforte, Encinitas, CA (US)

(21) Appl. No.: 18/987,259

(22) Filed: Dec. 19, 2024

(51) Int. Cl. H02J 13/00

(52) U.S. Cl. CPC H02J 13/12; H02J 13/14

(57) ABSTRACT

An electricity network can have an amount of electricity available for provisioning to a plurality of service sites served by a network manager. A service site may be determined from among the plurality of service sites. The service site may include local assets. The network may also include network manager-operated assets. An objective function may be used to determine a dynamic operating envelope for the service site, which indicates an amount of power that the service site may be permitted to put onto or take off the electricity network. In some instances, the network manager may use an objective function which uses a dynamic operating envelope when controlling manager-operated assets. The service site may receive an instance of such a dynamic operating envelope and control a local asset in response to the dynamic operating envelope. In some instances, the service site may use an objective function which uses a dynamic operating envelope when controlling local assets.

### BACKGROUND

In the course of providing utility services (e.g., electricity, water, gas, etc.), utility companies strive to maintain certain operational capacities, such as network uptime, meeting users' service consumption, and accommodating user output onto a network. Low voltage electric networks may provide users with electricity sourced from high or medium voltage sources (generators, energy storage systems, etc.). Low voltage networks may also include energy storage devices operated by a network manager responsible for the low voltage network. Users associated with low voltage networks may, at various service sites, have local energy generation (solar, wind, etc.), local energy storage (batteries), and local demands having a high draw (e.g., electric vehicles, HVAC, industrial equipment, etc.) or low draw (e.g., lighting, small appliances, etc.). Traditionally, network managers have had little or no control over the amount of energy consumption or generation individual consumers draw at the various service sites. Because storage may be diffused across both network manager operated storage and local energy storage, and because generation may be diffused across network manager operated sources and local energy sources, maintaining operational capacities for a low network grid becomes a difficult problem to manage according to conventional techniques of energy arbitrage.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1A is a schematic diagram illustrating a low voltage network managed by a power network operator (PNO) that receives energy and provides it to service sites, some of which are participants having a dynamic operating envelope (DOE).

FIG. 1B is a schematic diagram illustrating a low voltage network managed by an operator with detail as to the substations and transformers managed by the low voltage network operator.

FIG. 2 is a schematic diagram illustrating an exemplary framework for implementing objective function(s) from a PNO perspective including sources of elements, function elements, and function objectives.

FIG. 3 is a schematic diagram illustrating a service site comprising local assets and their connections to a DOE device.

FIG. 4 is a schematic diagram illustrating an exemplary framework for implementing objective function(s) from an end user perspective including sources of elements and function elements.

FIG. 5 is a flow diagram of an exemplary process by which a PNO perspective framework for implementing DOEs and objective functions may be structured.

FIG. 6 is a flow diagram of an exemplary process by which an end user perspective framework for implementing DOEs and objective functions may be structured.

FIG. 7 is a schematic diagram illustrating exemplary computing components and devices by which various frameworks for implementing DOEs and objective functions may be executed.

### DETAILED DESCRIPTION

As discussed above, maintaining operational capacities for a low voltage network grid is difficult due to distributed generation and storage sources at customer sites, over which a network manager has historically had little or no control. This application describes techniques for determining and using dynamic operating envelopes (DOEs) to help manage resources of one or more utility networks. This application also describes use of DOEs to manage local generation, storage, and consumption of electricity or other resources at individual service sites. As used herein, the term service site refers to any site to which a resource is provided, including residential, commercial, and industrial service sites. Service sites are sometimes also referred to as service points, service locations, or simply sites.

Utility companies or other power network operators (PNOs) strive to maintain the operation of their networks. PNOs must be prepared for various electric grid events, such as minimum demand events (when demand falls below minimum levels) or extreme demand events (when demand spikes to high levels), in addition to periodic variance and other routine complications (e.g., maintenance, weather, infrastructure damage). Distributed generation (rooftop solar, wind, etc.), distributed high-demand appliances (electric vehicles, etc.), distributed storage (home batteries, electric vehicles, etc.), and increasingly controllable appliances and equipment have increased the complexity of this task and of such events. While utility companies are one example of PNOs, alternate PNOs include governments, municipal services, public utility districts, regulatory agencies, third party companies, and/or other entities who operate, manage, and/or control power networks.

Minimum demand events occur when net loads, which are defined as total demand for power reduced by distributed generation, have fallen at or below levels such that voltage levels and operating frequencies cannot be sustained. These minimum demand events may be caused by excess energy generated by solar photovoltaic (PV) generation and/or wind generation, for example. These distributed energy generation sources may be categorized, in some examples, as one or more fleets of energy generation resources. A fleet may refer to a defined group composed of multiple distributed generation sources. Some PNOs are forced to initiate strategic power outages across portions of a network in order to manage these events. Additional examples of strategies to manage these events include solar PV inverter controls that allow PNOs to turn off or disconnect the solar PV generation source and grid-connected Energy Storage Systems (ESSs) that can be selectively charged to ensure net loads remain above minimum demand levels. Solar PV inverter controls can raise net load levels by reducing distributed generation. ESSs can be used to transfer excess generation from low demand periods to high demand periods by charging the ESSs during low demand periods and discharging the ESSs during high demand periods, which is known as energy arbitrage.

Extreme demand events, which may also be referred to as excess demand events, occur when the physical or logistical limitations of the network do not allow sufficient power to be delivered to meet demand. These limitations can arise due to insufficient grid connected generation or insufficient capacity to deliver power to end users. Strategic power outages across portions of a network are one approach that has been taken to extreme demand events. However, such outages are undesirable because they leave some users without power. Historically, solutions to extreme demand events have included passive control (e.g., public announcements requesting that users voluntarily reduce loads), direct control (e.g., control by a PNO or third-party of appliances such as HVAC cycling, thermostat changes, reduced lighting, water heater control, shutting down production process equipment, etc.), and utilizing ESSs and energy arbitrage to meet excess demand with stored power. In some examples, these solutions may require the PNO to determine optimal dispatch of grid-connected and non-grid connected (or distributed) generation, load, and storage to mitigate an event.

Some PNOs may only manage high-voltage energy systems, including generators and ESSs. These PNOs may use an Advanced Distribution Management Systems (ADMS). Other PNOs may only or primarily manage low-voltage energy systems, intended to directly deliver energy to users at service sites. As used herein, the term service site is interchangeable with service point and service location. These PNOs may utilize a Low Voltage Distributed Energy Resource Management Systems (LVDERMS). LVDERMS PNOs may, in some examples, only manage energy downstream of a substation feeder, including transformers and/or service sites. These LVDERMS PNOs may acquire energy from an ADMS PNO, or provide energy for an ADMS PNO to store in an ESS. In other examples, LVDERMS PNOs may also manage one or more low voltage energy generation sources and/or ESSs in addition to interfacing with one or more ADMS PNOs. In some examples, the ESSs used by LVDERMS PNOs may include batteries (e.g., 40 megawatt batteries), fuel cells (e.g., hydrogen fuel cells, methane fuel cells, etc.), kinetic storage (e.g., pumped hydro storage, flywheel storage, etc.). In some examples, users and service sites may not directly interface with an ADMS PNO.

Service sites managed by an LVDERMS PNO may have local energy storage, local energy distribution, or other local assets which may result in a need to manage them as having distributed energy resources (DER), hence “Distributed Energy Resource Management Systems” (DERMS). Some of these service sites may be considered and/or managed by, in some examples without limitation, Virtual Power Plants (VPP). Some VPP may comprise a plurality of DER service sites, and thus be considered DER aggregators.

LVDERMS PNOs, due to directly managing energy delivery downstream of a PNO, may benefit from knowledge of activity at the service site (i.e., “behind the meter”), such as the number, types, and/or magnitude/capacities of loads, generation sources, and storage sources. The LVDERMS PNOs may also benefit from knowledge about the timing and importance of the various loads at the service sites. LVDERMS PNOs will also have different considerations than ADMS PNOs due to the different voltage levels managed and due to the differing infrastructure. The heterogenous distribution of ownership and management of energy production, energy demand, and energy storage between users, LVDERMS PNOs, and ADMS PNOs increases the complexity of managing network functionality and determining optimal dispatch.

As mentioned above, this application describes techniques for handling this increased complexity using dynamic operating envelopes (DOEs). Because of the nature of power networks, how one end user manages their premise-level load and generation may impact the load and generation activity of other end users served by the same distribution transformer or feeder. As such, PNOs may orchestrate the load and generation activity across disparate end users, each with their own power needs. DOEs limit variability of net power generation and/or consumption at individual services sites by providing upper and lower bounds (hence, an operating envelope) on net loads/generation at each service site. These DOEs help avoid localized (e.g., within their serving distribution transformer) under/over voltage and frequency conditions. DOEs provide end users with additional control over management of their load, storage, and generation assets. In some examples, these DOEs are determined and/or provided by a PNO, such as the LVDERMS PNO supplying power or other resources to a particular service site. In some examples, the DOE may be determined based on historical ranges of net consumption and/or net generation for a particular service site. In some examples, the DOE may be negotiated between the PNO and the end user of the service site. If an end user's net loads at the service site remain within their assigned DOE (or within a factor of safety of their DOE), then their activity may not adversely impact the load and generation activity of the end users that are connected to the same Distribution Transformer/Feeder. DOEs may be used in addition to or alternatively to control of PNO controlled LVDERMS energy generation and storage resources to balance energy generated and consumed on the grid. The DOEs may be determined by a network manager computing device using one or more objective functions. Objective function(s) may also be used by a user when determining how to respond to a dynamic operating envelope imposed by the PNO.

Voltage and frequency control is a concern for both PNOs and end users. The PNO perspective is with respect to protecting the low voltage network and the grid-connected and non-grid connected load, storage, and generation assets and scheduling and dispatching these assets. The end user perspective is their need for power and how they can utilize their appliances, equipment, storage, and generation to meet their needs. DOEs can bridge these two perspectives. Both parties have a goal of maximizing network operation. Rather than direct control of end user load and generation assets, PNOs can provide end users with DOEs that they can operate within without disrupting voltage and frequency levels of the low voltage network. At the same time, by keeping net loads within the boundaries of their prescribed DOEs, end users are free to operate their equipment in the manner that best meets their needs knowing they are not adversely impacting the network and their neighbours. In some examples, not all service sites are required or available to operate within DOEs. That is, some service sites may lack distributed generation and/or storage equipment, and/or some customers of service sites that have distributed generation or storage may opt out of using DOEs. In these examples, only service sites which are indicated to be participants are provided with and expected to operate within DOEs, and the information associated with non-participant sites may be used as a constraint when determining DOEs for participant sites. In some examples, users may opt in to be a participant site. In some examples, service sites that include distributed generation and/or storage equipment may be included as participants unless they opt out of using DOEs.

Techniques for control of an LVDERMS managed network are discussed herein. Some examples of such techniques are from the perspective of PNOs, other examples are from the perspective of end users. The examples from the perspective of the end user service sites may be complimentary to and/or usable with the examples from the perspective of the PNO. However, the techniques from the perspective of the PNO may be used independently of the techniques from the perspective of the end user service sites, and vice versa. Such techniques may use objective functions to meet certain goals of the PNO or end user. The techniques may minimize costs associated with electricity services, quantify strategies for managing events, and incorporate a variety of considerations and parameters (e.g., node counts, decision horizons, time information, grid topography, ESS information, weather information, power generation information, power storage information, network capacity information, forecasts, event status, network history, regulatory information, classifications).

In some examples, from the perspective of PNOs, the techniques may include multiple operations. A first operation may involve receiving network information associated with a portion of the network to identify participant service sites and service sites that are candidates to be participant service sites, and a second operation may involve determining a DOE for a specific service site that is determined to be a participant service site or a candidate to be a participant service site.

In some examples, from the perspective of end users, the techniques may also involve multiple operations. A first operation may involve receiving a DOE (e.g., from a PNO); a second operation may involve monitoring or receiving local information associated with local power generation, storage, and/or demand; and a third operation may involve controlling local generation, storage, and/or demand based at least in part on the DOE.

Examples of these techniques, as discussed herein, may include or be based on one or more objective function frameworks with various constraints and forms of control by the PNO and/or the end user. As described herein, when an action or operation is described as being performed by a particular entity (e.g., a PNO or an end user), it should be understood that the action or operation may be performed by one or more computing devices associated with the entity with or without input from a human user. Examples of suitable computing devices are described elsewhere in this application. As used herein, the term objective function may be used interchangeably with terms such as constrained model. Such frameworks may be designed to represent actions that minimize a particular parameter, such as an overall cost of services. Such frameworks may, by way of example, be designed to accommodate a decision horizon with a minimum number of hours ahead (e.g., a minimum of 48 hours ahead, 24 hours ahead, etc.) to utilize grid-connected ESS to move power from light load periods to heavy load periods. In other examples, the decision horizon can be extended to span multiple days, weeks, or months. Some frameworks may be from the perspective of the end user or service site, and such end user or service site perspective frameworks may use control from PNO perspective frameworks as operating constraints. Various algorithms may be used to implement these techniques. Details of several example mixing and matching algorithms are described later.

Examples are provided for controlling an electricity grid. However, the techniques are not limited to use in connection with an electricity grid. Rather, the techniques describe herein may be applied to constrained control of other networks while achieving certain operational goals. By way of example and not limitation, the techniques may be applied to networks with distributed demands, storages, and generations such as internet services, data storage, water, gas, supercomputing devices with many nodes, etc.

In the context of the electric power industry, network information as described herein may reflect utility data associated with an electricity grid or a portion of an electricity grid. The electricity grid may be supplied by electricity generated from a variety of sources, including but not limited to fossil fuels, solar power, wind power, nuclear power, geothermal power, hydroelectric power, tidal power, etc. The information may contain an identifier that a particular service site is a participant or non-participant. The information may include service information. The service information may be consumption information that may reflect an aggregate sum of consumption over a period of time, a dollar (or other economic) amount of consumption, peak consumption, maximum load patterns, average consumption, median consumption, consumption level at a specific time point, consumption patterns, aberrant consumption behavior including outliers or spikes, a profile of what electricity supply source provides electricity, distance of electricity travel, cost of providing electricity, responsiveness to promotions or other commercial efforts, redundancy levels, maintenance demands, security information, company-assigned scores, as non-limiting examples. The information may additionally include information such as specific electrical equipment (e.g., model numbers, serial numbers, software or firmware versions, etc.), coordinates, etc.

The network information may reflect consumption at a number of service sites. The service sites may reflect individual customers, individual physical locations or sub-locations, aggregated non-customer users, aggregated customers or output interfaces, specific topological graph representation endpoints, etc. One customer or user may correspond to exactly one service site, or may correspond to multiple service sites. Customers or users may draw electricity for residential, industrial, commercial, or other utility purposes. The service sites of the network may be organized under one or more parent sites. In some examples, the parent sites may correspond to transformers. In other examples, parent sites may correspond to upstream distribution substations or other facilities. In some examples, there is only one layer of parent sites managed by an LVDERMS PNO. In other examples, there are multiple layers organized in a hierarchical structure. In some examples, parent sites may also have connections to one another, or serve as endpoint service sites as well.

### PNO Perspective

Generally, the techniques herein from the PNO perspective begin with determining an amount or metric of electricity services, such as electricity production available, for provisioning to a plurality of service sites served by the PNO (who may be referred to as an electricity service operator or electricity network operator). At least some of the service sites served by the PNO may be participant service sites, which have agreed to be subject to a DOE. Other service sites may be non-participating sites that do not have requisite equipment to be participants and/or that have opted out of being participants. An electricity network managed by the PNO may also include at least one of a network operator managed generation source, a network operator managed distribution source, and/or a network operator managed storage device. This network may be a low voltage network. Hence, the network may include at least one of a network operator managed low voltage generation source (e.g., solar, wind, hydroelectric, etc.), a network operator managed distribution source (e.g., transformer, transmission tower, meter, cables, etc.), and/or a network operator managed low voltage storage device (e.g., ESS).

Next, for a particular determined, service site from among that plurality of service sites, an objective function may be used to manage the electricity services provided, which may be a portion of the electricity services available. The service site may include a number of assets, some examples of which include, without limitation, a local energy generation source (e.g., distributed generation, solar energy generation source, hydroelectric energy source, wind energy source, heat pump energy source, geothermal energy source, biomass energy source, fuel energy source, reactor energy source), a local energy storage device (e.g., distributed storage, battery, electric vehicle), and/or one or more loads (e.g., equipment, HVAC, electric vehicle, appliances, lighting). Managing the electricity services provided may be performed in a passive manner, an active manner, or a combination thereof. By way of example, a passive manner may be a notification informing suggested management or a specific state, while an active manner may be powering down specific appliances.

In the case of participant sites, the management of the electricity services may involve the use of one or more DOEs to place boundaries on the consumption and/or generation of participant sites. A DOE may be based on actual, historical, and/or predicted amounts of electricity production and/or storage available, and may define boundaries which comprise limits on the electricity services the particular service site (which may also be referred to as a specific service site or a particular participant service site), is permitted to put onto or take off the electricity grid during a period of time. This may be considered using an objective function to determine the DOE, wherein the DOE defines, as a portion of an amount of electricity available to the plurality of service sites, an amount of power that a particular service site is permitted to put onto or take off the electricity grid during a period of time.

These boundaries may be or be organized as a set of boundaries. These may be net limits; may be gross limits, may be a combination thereof; and/or may separately indicate maximum input, maximum output, minimum input, and minimum output. The DOE may also include more granular controls and/or indications such as specific stored energy requirements (e.g., backup energy storage levels, minimum charge of an EV, etc.), etc.

This DOE (and/or any associated controls) may, in some examples, vary based at least in part on multiple periods of time, or variable decision horizons. This DOE (and/or any associated controls) may, in some examples, be implemented at certain periods of time and/or at certain statuses, such as minimum/extreme demand events. The DOE (and/or any associated controls) may be based on an input, output, information, and/or a metric associated with the particular service site and/or multiple service sites. The DOE (and/or any associated controls) may then be communicated to the particular service site. This may include in some examples communicating directly to a given user or computing device, while in other examples it may include communicating to a third party the PNO or the end user have agreed to control at least a portion of the services at the service site. The specifics may vary from particular service site to particular service site in the plurality of service sites, and may include a combination of options as well. Information used in the DOE, objective functions, and the like, including forecasts, grid status, service site status, compliance, etc. may in some examples be collected by sensors, meters, and other similar devices.

Control may also be exerted over various PNO-managed assets, such as a low voltage generation source, a distribution source, a low voltage storage device, receiving and/or purchasing more energy from a high voltage source, etc. This control may be exerted by one or more computing devices, a PNO authorized entity, a PNO authorized user or employee, etc. as examples without limitation. Such control may be based at least in part on monitoring, recording, receiving, and/or analyzing network information including power provided by at least one high or medium voltage energy power generation source and/or at least one high or medium voltage energy power storage source. This source/storage (or other assets such as transformers, relays, etc.) may or may not be managed or controlled by the PNO. The monitoring (and/or similar operations such recording, receiving, and/or analyzing network information) may be performed continuously/real-time, substantially real-time, at consistent and/or variable discrete points, or a combination thereof. This information may be stored temporarily and/or indefinitely in various formats, such as a time series, timestamps, or log data; and may be retrievable. Other grid information (e.g., voltage, frequency, flow of network communication traffic, etc.) may also be monitored, recorded, received, and/or analyzed in similar manners. This PNO-managed asset control may be considered, in part, altering at least a portion of a configuration (or organization) of the network. Such exemplary actions may be taken in order to implement energy arbitrage. Other such exemplary actions may be long-term such as construction, infrastructure decisions, maintenance decisions, monitoring decisions, computational decisions, simulational decisions, experimental decisions, model scrutiny decisions, analysis decisions, and/or other business decisions such as other network operators to interface with and/or energy types to leverage (e.g., more or less solar, hydroelectric, natural gas, nuclear, geothermal, wind, etc.).

Broadly, compliance with the DOE in accordance with the techniques herein may, by way of example, comprise first monitoring a net power put onto or taken off the electricity grid by a service site, determining whether the net power exceeds the boundaries of the DOE, and applying a consequence to the service site based at least in part on the net power exceeding the amount of power that the particular service site is permitted by the DOE to put onto the electricity grid or take off the electricity grid. This consequence may include, without limitation, control (e.g., turning off an appliance), a cost, a penalty, a warning (e.g., a mobile notification), etc. The consequence may be determined or applied by a meter, a service switch, etc. Then, the service site may manage, based at least in part on the DOE, local energy generation or local energy storage to maintain net power associated with the service site to remain within the permitted power set by the boundaries of the DOE.

Compliance with this DOE may then be used to generate forecasts with respect to, by way of example and without limitation, future network (grid) status, future service point status, service costs, etc. These forecasts may be generated based upon an assumption that the DOE will be complied to either absolutely, or to a certain extent (e.g., 90% compliance, 95% compliance, etc.). This assumption may also be based upon constraints and/or the objective functions presented herein as portions of the exemplary frameworks. These forecasts may additionally or alternatively be based upon applying various inputs, perturbations, experimental parameters, event data, and/or other similar operations to the exemplary frameworks. The forecasts may comprise analyzing outputs of the exemplary frameworks, comparing outputs, visualizing outputs, determining metrics from the outputs, etc. The forecasts may, in some examples, be generated by an ML model trained on features associated with the exemplary frameworks. Such forecasts can be used by the PNO to determine the amount or capacity of PNO operated generation and storage assets that may be needed to be balance consumption and generation on the LV network.

As used herein, costs and penalties may comprise financial penalties measured in units of currency, such as dollars. However, costs and penalties may additionally or alternative include loss or limitation of rights, scores, priorities, metrics, probabilities, machine-learned model outputs, distributions, non-deterministic measurements, deterministic measurements, weighted composite values, computational complexity, computation cost, times, latencies, satisfaction levels, retention levels, compliance levels, goal achievement levels, and/or other representations of quantitative and/or qualitative measurements. A few specific examples of cost or penalties that may apply to repeat offenders (e.g., service sites that repeatedly exceed the DOE) include: having the limits on their DOE adjusted (expanded or contracted), having their rate agreement adjusted (e.g., cost of energy increased), having their eligibility to be a participant site revoked (e.g., be converted to a non-participant site), and/or being required to allow the PNO to actively control one or more generation, storage, and/or consumption devices at the service site to stay within the respective DOE. The costs may be net or gross costs. Costs/opportunity costs (which may be also seen as gains) may also be considered incentives and/or disincentives in some examples. In some such examples, this may be based at least in part on a negative or positive sign associated with the cost, in others it may merely be a matter of perspective, and in yet others it may be based at least in part on an evaluation of who is bearing the cost and/or gain. One such example may be that while a local asset producing solar energy for a service point may be considered a “savings” for the end user because it is “free,” it may alternatively be a “cost” if it could have been sold onto the grid as an output for a greater price than a later purchase. Similarly, to a PNO it may be a “cost” if it causes a minimum demand event, represents a lack of sale, or may be an “incentive” if it means that energy can be sold to higher-paying buyers. Costs may be associated with times, periods of time, classifications, etc. By way of example, a temporary incentive to join a participant program for DOEs by way of a temporary discount on electrical services may be a non-limiting example of a cost associated with a period of time. Additional incentives or costs may take the form of actions, such as purchasing a distributed energy storage or distributed energy generation asset in order to comply with a DOE.

The plurality of service sites, and determination (identification/selection) of the particular service site, may also include a classification (or categorization). This classification may indicate a level of control, or a participation status. By way of example, some service sites may be participant service sites, and some may be non-participant service sites. Hence, the particular service site may be a particular participant service site. Participation status may be defined in a binary manner (participating and non-participating), on a sliding scale dependent on control type available, etc. In some examples, non-participant service sites may have little to no controls available for the network operator to exert, while in yet other examples the non-participant service sites may have similar controls to the participant service sites and classification is determined based on an opt-in/opt-out, a determination of ease of control implementation, and/or a determination of a likelihood/confidence of compliance/efficiency of control implementation. In other examples, service sites may be split across multiple levels of participation. In some such multiple level examples, all service sites may be considered to be participants. Additionally, without limitation, service sites may be classified according to distance, available assets (measured in value, priority, controllability such as “smart”/internet of things devices, connectivity), historic information, forecasts (associated with grid status, weather, construction, future service sites etc.), regulation, load/demand levels (such as electric vehicle charging levels), overall service site count, network status information, compliance information, infrastructure information, coordinate, customer information, PNO-defined labels, commercial information, grid topology, neighboring service sites, etc. In some examples, a portion of the information used to determine the classification may be anonymized. In some examples, a classification of a group/subset of the plurality of service sites may indicate that all such service sites will receive an identical or substantially similarly derived DOE and/or control. In some examples, a classification of a group/subset of the plurality of service sites may include a transparency level wherein end user(s) associated with particular service site(s) may have an access level to the computation of the DOE. Classification, such as participant status, may also include a transparency level wherein the PNO has additional information regarding activity and assets “behind the meter.” In some examples, service site(s) classified as non-participants may have an amount of services or an amount of power associated, which may be used when determining DOEs for other service sites. This may be represented by data about historical and/or predicted consumption at the non-participant service sites. End user decision to be a participant may also be based at least in part on factors determined by the PNO, regulation, market dynamics, barriers to entry, etc. (such as monetary incentives, autonomy incentives, cultural incentives to be less reliant on fluctuations, user anxiety regarding available electricity, energy priority incentives for participation, ease of use, opportunity costs).

The service point(s) may also have relationships to each other and/or specific infrastructure, which may be network and/or relationship information. This information may be formatted as a dataset in some examples. This relationship information may reflect physical electrical connection information representing how the various components (service points, nodes, etc.) from which the information was drawn are connected to one another. Alternatively, as non-limiting examples, the relationships may reflect proposed connections, emergency situations, a simplified perspective, or commercial connections. In some examples, the relationship information may include further data beyond just the connections between the service points and parent structures such as the type of connections used, specific coordinates in a multi-dimensional space, a geographic longitude or latitude associated with the service points and/or parents, information about the date upon which the connection was made, the personnel that made the connection, or other features of the service points and/or connections. In some examples, some features of the relationship information may be encoded or represented as colors, specific numeric or alphanumeric values, lists of connections, proximity thresholds, directed vectors, hierarchy classifications, semantic labels, probability distributions, similarity scores, etc. In some examples, the information associated with a specific grid or portion of a grid may be determined by sequentially querying each service point or record of a service point (such as in a dataset or in association with a monitoring/receiving/analyzing service) for a classification associated with that service point and for information regarding any parents the service point may have. The service points and parent nodes (representations of substations, transformers, and/or other organizational features) may also be organized into collections of service points or collections of parent nodes based at least in part on topology structure, real-world correspondence, or other configuration needs.

In order to determine controls and/or DOEs, objective functions comprising a number of elements and/or terms may be used. These objective functions may include one or more objectives and/or control variables which are solved for. Objectives (and/or control variables) may be, without limitation, variables in the objective function for which a value, range of values, or defining formula can be derived by solving the objective function. These elements may, by way of example, be a plurality of elements associated with at least one of grid information, local information (service site information), status information, or objective function parameter information as generally discussed herein. Examples, without limitation, of such objectives and/or elements may include a minimum total power delivery cost, a minimum power generation cost, a minimum power storage cost, a minimum control cost, a minimum participation opportunity cost, and a minimum dynamic operating envelope compliance cost. Some of these elements may be provided by input of a user, administrator, other application, end user, and/or be determined by a machine-learned model based at least in part on historic information.

Additional examples of function elements may include a decision horizon, a time status, a number and/or topology and/or subset of nodes, a weather status, a power generation status, a power storage status, a network capacity status, a network forecast status, a node capacity status, a grid event status, a grid regulatory status, a grid position status associated with nodes of the network, a power demand status associated with nodes of the network, a power received status associated with nodes of the network, a power delivered status associated with nodes of the network, a price status for power associated with nodes of the network, a node control status associated with operator/third party/user control of nodes of the network, a network performance status, a compliance metric, a classification of a metric associated with nodes of the network, and/or a historic metric associated with nodes of the network. Some of these elements may similarly be provided by input of a user, administrator, other application, end user, and/or be determined by a machine-learned model based at least in part on historic information. In some examples, some elements may be considered parameters and/or parametrized.

These objective functions may also include static/fixed and/or variable terms provided or required as parameters. In some examples, all parameters may be necessary and therefore all parameters must be determined and/or have values in order to execute the objective functions. In other examples, some parameters may be necessary and other parameters may be optional; wherein optional parameters may not be necessary to arrive at solutions. Therefore, the objective functions may be tolerant of additional and/or incomplete data. Some objective functions may also be subject to one or more constraints, which also may be represented in expression form. The objective function(s) may represent and/or be solved according to one or more algorithms. In some examples, the solution(s) may be deterministic, in other examples they may be non-deterministic. In some examples, the solution(s) may include or be associated with error(s), uncertainties, precision level(s), accuracy level(s), confidence level(s), and/or other metrics.

In some examples, the techniques, information, and/or expressions may abstract, precompute, remove, simplify, extract, and/or assume a portion of the included information or operation. Such an action may be done deliberately to better model and/or simulate inaccuracies, errors, and/or lack of confidence with respect to actual conditions. In other examples, operations and/or information may be subdivided first for parallel or partial processing based on parameters including complexity, size, computational efficiency, security needs, privacy, etc. The divided activity and/or results may continue to be presented as divided, or may be combined together.

The objective functions and/or related operations discussed herein may be represented by way of example in various exemplary frameworks. A framework, by way of example and not limitation, may be considered to have at least one objective function and a number of constraints, wherein solving the objective function subject to the constraint(s) indicates an activity or metric related to achieving an objective of the objective function. A framework may also be referred to as a methodology, a configuration, an approach, a strategy, a representation, a system, etc. Some frameworks may have multiple objective functions, such as one or more objective functions for determining control (e.g. generation control, storage control, direct control of local assets, soft constraints), one or more objective functions for determining DOEs, and other associated objective functions. The objective functions may share constraints, may provide inputs to each other/depend on each other, and/or may have disjoint sets of constraints and parameters. In some examples where the constraints and/or parameters overlap, the constraints and/or parameters may be calculated first and/or shared directly, while in other examples even though there is overlap they may be independently computed and/or received differently. This may enable parallel processing. In some examples the framework(s), objective function(s), and/or constraint(s) may be updateable.

A specific exemplary framework may be selected for use, or a combination of features from various frameworks may be implemented. This implementation may be based on a variety of factors. By way of example, the implementation may be selected based on a geographic location associated with the network, PNO, service site, etc. The implementation may be selected based on a determination of particular assets (e.g., generation sources, storage sources, and/or loads) at the service site and/or demographic data associated with the service site and/or end user(s). The implementation may be selected by a user input, company policy, a user or PNO sophistication, a service purchase level, monitoring of service site activity (which may or may not include load disaggregation), and may be based on the intended use of the framework, a cost, and/or a computational efficiency.

The implementation may also be selected based at least in part on features of the network. Features may include measurements of a collection of service points and/or assets (including sub-service point local assets) associated with the network. Examples of such features include estimations of the number of service points assigned to parent nodes (through actual count, mean, median, mode, or other measurements demonstrating complexity of the topology). The implementation may be selected based on a system of thresholds associated with the measurements. The thresholds may or may not be pre-assigned, and may correspond to stated needs and/or goals, geographic information, demographic information, intended uses, user input, alterations for testing, predictions, assumptions, etc. The threshold may be determined or set based at least in part on the laws, rules, and/or utility grid structures of a particular geographical location. These features may be independently solved at a discrete point, at regular points, at irregular points, or continuously to indicate that a certain methodology is the appropriate methodology to be used.

In some examples, multiple frameworks may be used. The techniques may apply the multiple frameworks in order, may apply various frameworks to various portions of the dataset, or may include an evaluation and determination not to use certain frameworks made available in certain circumstances. In some examples, various implementations and/or associated metrics may be compared to determine a tailored and/or tuned implementation. In some examples, there may be a mandatory implementation and one or multiple optional implementation. The selection of framework and/or application/implementation of the framework may be performed by a user (such as a PNO employee or tester), by one or more specifically-developed computational algorithms, by the PNO, by a licensed entity, by a third party, by one or more trained machine-learned models, or any combination thereof. The techniques exemplified by frameworks associated with the PNO perspective may be performed by the PNO, computing devices associated with the PNO, distributed computing devices (including computation at transformer, transmission tower, and/or meter level), computing devices licensed by the PNO, computing devices at a central location, by PNO employees, by regulatory agencies, by third parties associated with the PNO and/or end users, and/or a combination thereof.

Operations and features of the techniques discussed herein may be performed by one or more computing devices. The computing device(s) may comprise a system including one or multiple components, some of which may be or may include one or more non-transitory computer-readable media which may cause processors to perform operations when executed. The components may, in other examples, be software, computational modules, specifically-developed computational algorithms, or trained machine-learned models. The components may, in other examples, be computing devices, processing units, or processors. By way of example and not limitation, the components may comprise one or more Central Processing Units (CPUs), Graphics Processing Units (GPUs), or any other device or portion of a device that processes electronic data to transform that electronic data into other electronic data that may be stored in registers and/or computer readable media. In some examples, integrated circuits (e.g., ASICs), gate arrays (e.g., FPGAs), and other hardware devices can also be considered processors insofar as they are configured to implement encoded instructions. The components may operate independently, in serial, or in parallel. In other examples, components and/or computing devices may be specifically printed chips optimized to perform the techniques disclosed herein, or logic circuits which perform the techniques herein based on instructions that may be encoded in software, hardware, or a combination of the two. The components and/or computing devices may be associated with access or authorization levels.

Computer readable media associated with the techniques herein may store an operating system and one or more software applications, instructions, programs and/or data to implement the techniques described herein and the functions attributed to the various systems. In various implementations, the computer readable media may be implemented using any suitable computer readable media technology, such as static random-access memory (SRAM), synchronous dynamic RAM (SDRAM), nonvolatile/Flash-type memory, or any other type of computer readable media capable of storing information. The architectures, systems, and individual elements described herein may include many other logical, programmatic, and physical components, of which those discussed herein are merely examples that are related to the discussion of the disclosed techniques. As can be understood, the features discussed herein are described as divided for exemplary purposes. However, the operations performed by the various features may be combined or performed by other features. Control, communication, intra- and inter-framework transmission, and/or received data may be performed digitally, physically, by signal, by sensor, by alarm, by radio, by sound, by phone, by mail, by other modalities, and/or any combination thereof.

Suitable computing devices for the operations of features herein may include, by way of example and not limitation, smart utility meters, photovoltaic inverters, electric vehicle chargers, asset management hubs, central computing systems, databases, PNO-managed personal computers, mobile devices, substation management interfaces, central utility management interfaces, transformer-level management interfaces, automated energy purchasing interfaces, etc.

Generally, in addition to the exemplary PNO perspective frameworks as discussed herein, many of the considerations and features discussed may additionally apply to the exemplary end user perspective frameworks, as well as vice versa. The frameworks from each perspective may be, in part or in whole, combined, interoperable, independent, parallel, sequential, dependent, etc.

### Example PNO Framework 1

A first exemplary framework using an objective function for control from a PNO perspective may establish a least cost dispatch of grid-connected generation that balances the net demand for power while adhering to the operating constraints of the low voltage network. Under this framework, PNOs may take as given at least: (1) forecasts of aggregate net demand for power by network node (e.g., transformer/phase, feeder/phase, substation, transmission zone); (2) grid-connected generation supply curve; (3) low voltage network capacity constraints; and (4) minimum demand requirements for maintaining the operating security of the low voltage network. This framework may be referred to as a least cost dispatching of grid connected generation framework.

The objective of the least cost dispatch objective function may be to minimize the total cost of delivered generation. The value of the delivered power may be quantified using the Locational Marginal Price (LMP) each end user pays for each unit (e.g., kWh) of power delivered. The LMP may be composed of three cost elements. The first element may be the market clearing price for power. This price may be determined where the aggregate demand for power intersects with the aggregate supply curve. The latter represents the bid-offer curves of each grid-connected generation unit sorted from least to highest cost. The second element of the LMP accounts may be the value of power lost due to Transmission & Distribution losses. The third element of the LMP may represent the relative cost of delivering power to network nodes (n) that are highly congested. Of these three elements, by way of example, the market clearing price may represent roughly 95% of the LMP. To simplify the modeling framework a forecast of the LMP price may be used rather than including the bid-offer curves of each generation unit.

An objective function based on this framework may be determined as:

$$\frac{Minimize}{{ϑ}_{t}^{u , d}} {\sum }_{d = 1}^{D} {\sum }_{t = 1}^{T} {\sum }_{u = 1}^{U} {\sum }_{n = 1}^{N} L M {P}_{t}^{n , d} ( {ϑ}_{t}^{u , d} {ρ}_{t}^{n , u , d} G r i d G e {n}_{t}^{u , d} )$$

The objective of this function is to minimize the total cost of dispatched grid-connected generation by selecting values for

$${ϑ}_{t}^{u , d}$$

which represent the fraction of total scheduled generation for grid-connected generation unit (u) that is dispatched on day (d) and period (t). In the exemplary function as shown above,

$$L M {P}_{t}^{n , d}$$

is the locational marginal price ($/kWh) for power delivered to end users connected to network node (n) on day (d) and period (t);

$${ϑ}_{t}^{u , d}$$

is the fraction of available grid-connected generation for unit (u) that is dispatched on day (d) and period (t);

$${ρ}_{t}^{n , u , d}$$

adjusts for generation unit (u) Transmission & Distribution losses associated with delivering power to network node (n) on day (d) and period (t);

$$G r i d G e {n}_{t}^{u , d}$$

is the available dispatchable generation for grid-connected generation unit (u) on day (d) and period (t); D represents the number of days in the decision horizon; days within the decision horizon are indexed by (d); T represents the total number of time periods in a day (e.g., 288 five-minute intervals, 96 15-minute intervals, 48 30-minute time intervals, and 24 60-minute time intervals), where periods within a day in the decision horizon are indexed by (t); U represents the total number of grid-connected generation units; individual generation units are indexed by (u); and N represents the number of network connection points or nodes; individual network nodes are indexed by (n).

The objective function may be subject to a number of constraints in this first example framework to ensure an operationally feasible least cost dispatch solution. Examples of such constraints include energy balance constraints, generation dispatch constraints, and network capacity constraints (grid-edge and non-grid-edge).

Energy balance constraints may ensure net grid supply of power exactly offsets the net demand for power for each day (d) and period (t) in the decision horizon (D). The Energy Balance Constraint may be expressed from the perspective of the Network Operator as:

$${NetLoad}_{t}^{N , d} = {NetGridSupply}_{t}^{N , d}$$

In this example, the net load

$${NetLoad}_{t}^{N , d}$$

is a forecast of total delivered power less total received power from all end users served by the network (N) on day (d) and period (t). The elements that make up Net Load for power may be defined as:

$${Delivered}_{t}^{n , e , d} = IF [ ( {Load}_{t}^{n , e , d} - {DER}_{t}^{n , e , d} ) \geq 0 ]$$

$${Received}_{t}^{n , e , d} = IF [ ( {Load}_{t}^{n , e , d} - {DER}_{t}^{n , e , d} ) \leq 0 ]$$

$${NetLoad}_{t}^{N , d} = {\sum }_{n = 1}^{N} {\sum }_{e = 1}^{E ∈ n} {Delivered}_{t}^{n , e , d} + {\sum }_{n = 1}^{N} {\sum }_{e = 1}^{E ∈ n} {Received}_{t}^{n , e , d}$$

With respect to this framework,

$${Load}_{t}^{n , e , d}$$

is the demand for electricity regardless of how it is sourced for end user (e) served by network node (n) on day (d) and period (t);

$$D E {R}_{t}^{n , e , d}$$

represents a combination of load control, Battery Energy Storage System charging/discharging, and on-premises generation that is used to offset on-premises demand for electricity for end user (e) on day (d) and period (t);

$${Delivered}_{t}^{n , e , d}$$

is the additional power required to be pulled in from the network node (n) to meet an end user (e) power requirements on day (d) and period (t); and

$${Received}_{t}^{n , e , d}$$

is excess power pushed onto the network at node (n) from end user (e) on day (d) and period (t).

In this example of the Energy Balance Constraint, the net grid-connected supply may be defined as the sum of grid-connected generation adjusted for Transmission and Distribution losses plus net (i.e., gross discharge less discharge losses) discharged power from grid-connected Energy Storage less gross (i.e., power pulled from the grid before charging losses are applied) charging of grid-connected Energy Storage. This may be represented, with terms as described above, as:

$$N e t G r i d S u p p l {y}_{t}^{N , d} = {\sum }_{n - 1}^{N} \{ {\sum }_{u}^{U} {ϑ}_{c}^{u , d} {ρ}_{c}^{n , u , d} G r i d G e {n}_{t}^{u , d} \}$$

Generation dispatch constraints impose operating minimum and maximum values for each grid-connection generation resource. These constraints may impose dispatchable generation limits for each generation resource. These constraints may be represented as:

$${ϑ}_{t}^{u , d} \leq 1.$$

$${\overline{ϑ}}_{t}^{u , d} \leq {ϑ}_{t}^{u , d}$$

As used in this representation,

$${ϑ}_{t}^{u , d}$$

is the fraction of available grid-connected generation for unit (u) that is dispatched on day (d) and period (t) and

$${\overline{ϑ}}_{t}^{u , d}$$

represents the minimum required fraction of generation unit (u) that must be dispatched on day (d) and period (t); minimum dispatchable fraction may be set prior to ensure the optimum solution satisfies the minimum generation requirements for the stability and security of the network.

In some examples of this formula, no feasible solution may exist when the minimum dispatchable generation requirements are combined with uncontrolled on-premises generation. Infeasibility may indicate a need to curtail a portion of distributed generation to satisfy the minimum dispatchable generation requirements.

Network capacity constraints may be grid-edge or non-grid-edge. Grid-edge network capacity constraints may represent the operating capacities of the network lines and equipment for delivering (i.e., delivered) and receiving power to/from end users located at the edge of the network. Non-grid-edge constraints may represent the operating capacities of the network lines and equipment for flowing power between network nodes. Together these constraints may ensure the physical feasibility of the optimal solution.

The grid-edge network capacity constraints may be represented as:

$${\sum }_{e = 1}^{E ∈ n} {Delivered}_{t}^{n , e , d} \leq D e l i v e r e d C a p a c i t {y}_{t}^{n , d} , ∀ n ∈ Grid Edge$$

$${\sum }_{e = 1}^{E ∈ n} \vert {Received}_{t}^{n , e , d} \vert \geq {ReceivedCapacity}_{t}^{n , d} , ∀ n ∈ Grid Edge$$

$$OperatingCapacit {y}_{t}^{n , d} = D e l i v e r C a p a c i t {y}_{t}^{n , d ,} + ReceiveCapacit {y}_{t}^{n , d} , ∀ n ∈ Grid Edge$$

As used in this representation,

$$D eliveredCapacit {y}_{t}^{n , d}$$

represents the physical capacity for delivered power to all end users located on network node (n) on day (d) and period (t). The values for these time series will be non-negative. These constraints apply for all (∀) nodes (n) on network (N) that are located at the edge of the delivery network. Additionally, E∈n represents the list of end users (E) that are directly served by network node (e);

$${Delivered}_{t}^{n , e , d}$$

is total power delivered from network node (n) to end user (e) on day (d) and period (t);

$$R e c e i ν e d C a p a c i t {y}_{t}^{n , d}$$

represents the physical capacity for received power from all end users located on network node (n) on day (d) and period (t). The values for these time series will be non-positive. These constraints apply for all (∀) nodes (n) on network (N) that are located at the edge of the delivery network.

$${Received}_{t}^{n , e , d}$$

is the total power received by network node (n) from end user (e) on day (d) and period (t); convention is for received flows to be negative which is why the sum is over the absolute values of the received flows. Lastly,

$${OperatingCapacity}_{t}^{n , d}$$

is the total capacity for power flow through network node (n) on day (d) and period (t).

The non-grid-edge network capacity constraints may be represented as:

$$D eliveredCapacit {y}_{t}^{n , d} \geq {\sum }_{j = 1}^{J ∈ n} {Delivered}_{t}^{n , j , d} , ∀ n ∈ N$$

$$ReceivedCapacit {y}_{c}^{n , d} \leq {\sum }_{j = 1}^{J ∈ n} \vert {Received}_{t}^{n , j , d} \vert , ∀ n ∈ N$$

$${OperatingCapacity}_{t}^{n , d} = D e l i v e r C a p a c i t {y}_{t}^{n , d ,} + R e c e i v e C a p a c i t {y}_{t}^{n , d} , ∀ n ∈ N$$

As used in this representation,

$$D eliveredCapacit {y}_{t}^{n , d}$$

represents the physical capacity for flowing power to downstream nodes (j) that are directly connected to network node (n) on day (d) and period (t). The values for these time series will be non-negative. These constraints apply for all (∀) nodes (n) on network (N).

$${Delivered}_{t}^{n , j , d}$$

is total power delivered from network node (n) to downstream network node (j) that is directly connected to network node (n) on day (d) and period (t).

$$R e ceivedCapacit {y}_{t}^{n , d}$$

represents the physical capacity for receiving power flowing from either downstream or upstream network nodes (j) that are directly connected to network node (n) on day (d) and period (t). The values for these time series will be non-positive. These constraints apply for all (∀) nodes (n) on network (N).

$${Received}_{t}^{n , j , d}$$

is the total power received by network node (n) upstream and downstream network PGP nodes (j) that are directly connected to network node (n) on day (d) and period (t); convention is for received flows to be negative which is why the sum is over the absolute values of the received flows. Lastly,

$${OperatingCapacity}_{t}^{n , d}$$

is total capacity for power flow through network node (n) on day (d) and period (t).

### Example PNO Framework 2

A second exemplary framework is similar to the first framework, with the addition of one or more energy storage systems (ESS). This framework may establish a least cost dispatch of grid-connected generation and ESS that balances the net demand for power while adhering to the operating constraints of the low voltage network. Under this framework, PNOs may take as given at least: (1) forecasts of aggregate net demand for power by network node (e.g., transformer/phase, feeder/phase, substation, transmission zone); (2) grid-connected generation supply curve; (3) operating characteristics of ESS that are used for energy arbitrage across time periods (4) low voltage network capacity constraints; and (5) minimum demand requirements for maintaining the operating security of the low voltage network. This framework may be referred to as a least cost dispatching of grid connected generation and energy storage framework.

The objective of the least cost dispatch objective function may be to minimize the total cost of delivered generation. The second exemplary framework may be considered to build upon the first framework by introducing grid-connected ESSs as additional sources of power to meet end user net loads. Grid services that ESS units can provide may include frequency regulation, voltage support, and energy arbitrage. Frequency regulation and voltage support may be scheduled services that in many cases are dispatched in real-time. Energy arbitrage may provide the ability for a network operator to move excess power across periods of the day. The latter may be used to smooth out energy deliveries from both grid and non-grid connected renewable generation resources, as well as provide support for must run grid generation under low or minimum demand conditions. ESS that are used for frequency regulation and voltage support may be treated as automatically dispatched resources and as such may not be considered as part of the problem the objective function is directed towards solving. ESS that are used for energy arbitrage over a multi period decision horizon to determine their utilization may be included as one of the control operations available to network operators.

An objective function based on this framework may be determined as:

$$\frac{Minimi z e}{{ϑ}_{t}^{u , d} , {δ}_{t}^{s , d}} {\sum }_{d = 1}^{D} {\sum }_{f = 1}^{T} {\sum }_{u = 1}^{U} {\sum }_{n = 1}^{N} {L MP}_{t}^{n , d} ( {ϑ}_{t}^{u , d} {ρ}_{t}^{n , u , d} {GridGen}_{t}^{u , d} ) + {\sum }_{d = 1}^{D} {\sum }_{f = 1}^{T} {\sum }_{u = 1}^{U} {\sum }_{n = 1}^{N} L M {P}_{t}^{n , d} ( {ϑ}_{t}^{s , d} {ρ}_{t}^{n , s , d} {E SSDischarge}_{t}^{s , d} )$$

The objective of this function, as an example, is to minimize the total cost of dispatched grid-connected generation and storage by selecting values for

$${ϑ}_{t}^{u , d}$$

which represent the fraction of total scheduled generation for grid-connected generation unit (u) that is dispatched on day (d) and period (t) and values for

$${ϑ}_{t}^{s , d}$$

which represent the fraction of total available ESS (s) energy that is dispatched on day (d) and period (t).

In the exemplary function as shown above,

$$L M {P}_{t}^{n , d}$$

is the locational marginal price ($/kWh) for power delivered to end users connected to network node (n) on day (d) and period (t);

$${ϑ}_{t}^{u , d}$$

is the fraction of available grid-connected generation for unit (u) that is dispatched on day (d) and period (t);

$${ρ}_{t}^{n , u , d}$$

adjusts for generation unit (u) Transmission & Distribution losses associated with delivering power to network node (n) on day (d) and period (t);

$$G r i d G e {n}_{t}^{u , d}$$

is the available dispatchable generation for grid-connected generation unit (u) on day (d) and period (t);

$$E S S D i s c h a r g {e}_{t}^{s , d}$$

is the available dischargeable energy for ESS (s) on day (d) and period (t);

$${ρ}_{t}^{n , s , d}$$

adjusts for ESS (s) losses associated with discharging power to the network node (n) on day (d) and period (t);

$${ϑ}_{t}^{s , d}$$

is the fraction of available dischargeable energy for ESS (s) on day (d) and period (t) that is allowed to be discharged as needed; D represents the number of days in the decision horizon; days within the decision horizon are indexed by (d); T represents the total number of time periods in a day (e.g., 288 five-minute intervals, 96 15-minute intervals, 48 30-minute time intervals, and 24 60-minute time intervals, where periods within a day in the decision horizon are indexed by (t); U represents the total number of grid-connected generation units; individual generation units are indexed by (u); and N represents the number of network connection points or nodes; individual network nodes are indexed by (n).

The objective function may be subject to a number of constraints in this second framework to ensure an operationally feasible least cost dispatch solution. Examples of such constraints include energy balance constraints (net grid load and net grid supply), generation dispatch constraints, network capacity constraints (grid-edge and non-grid-edge), and network storage system constraints (ESS capacity and ESS charging).

Energy balance constraints may ensure net grid supply of power exactly offsets the net demand for power for each day (d) and period (t) in the decision horizon (D). The Energy Balance Constraint may be expressed from the perspective of the Network Operator as:

$$N e t L o a {d}_{t}^{N , d} = N e t G r i d S u p p l {y}_{t}^{N , d}$$

In this example, the net load

$${NetLoad}_{c}^{N , d}$$

is a forecast of total delivered power less total received power from all end users served by the network (N) on day (d) and period (t). The elements that make up Net Load for power may be defined as:

$$\begin{matrix}\begin{matrix}{Delivered}_{t}^{n , e , d} = IF [ ( {Load}_{t}^{n , e , d} - D E {R}_{t}^{n , e , d} ) \geq 0 ] \\ {Received}_{t}^{n , e , d} = IF [ ( {Load}_{t}^{n , e , d} - D E {R}_{t}^{n , e , d} ) \leq 0 ]\end{matrix} \\ NetLoa {d}_{t}^{N , d} = {\sum }_{n = 1}^{N} {\sum }_{e = 1}^{E ∈ n} {Delivered}_{t}^{n , e , d} + {\sum }_{n = 1}^{N} {\sum }_{e = 1}^{E ∈ n} {Received}_{t}^{n , e , d}\end{matrix}$$

With grid-connected Energy Storage Systems (ESS) the amount of power required may be augmented by the power added to the ESS units via charging activity. The elements that make up total Net Load for power may be defined as follows:

$${NetLoad}_{t}^{N , d} = {\sum }_{n = 1}^{N} {\sum }_{e = 1}^{E ∈ n} {Delivered}_{t}^{n , e , d} + {\sum }_{n = 1}^{N} {\sum }_{e = 1}^{E ∈ n} {Received}_{t}^{n , e , d} + {\sum }_{s = 1}^{S} {ESSCharge}_{t}^{s , d}$$

With respect to these Net Load constraints,

$${ESSCharge}_{t}^{s , d}$$

is the amount of gross energy that could be added to ESS (s) on day (d) and period (t);

$${Load}_{t}^{n , e , d}$$

is the demand for electricity regardless of how it is sourced for end user (e) served by network node (n) on day (d) and period (t);

$${DER}_{t}^{n , e , d}$$

represents a combination of load control, Battery Energy Storage System charging/discharging, and on-premises generation that is used to offset on-premises demand for electricity for end user (e) on day (d) and period (t);

$${Delivered}_{t}^{n , e , d}$$

is the additional power required to be pulled in from the network node (n) to meet an end user (e) power requirements on day (d) and period (t); and

$${Received}_{t}^{n , e , d}$$

is excess power pushed onto the network at node (n) from end user (e) on day (d) and period (t).

In this example of the Energy Balance Constraint, the net grid-connected supply may be defined as the sum of grid-connected generation adjusted for Transmission and Distribution losses plus net (i.e., gross discharge less discharge losses) discharged power from grid-connected Energy Storage. This may be represented as:

$${NetGridSupply}_{t}^{N , d} = {\sum }_{n - 1}^{N} \{ {\sum }_{u}^{U} {ϑ}_{t}^{u , d} {ρ}_{t}^{n , u , d} {GridGen}_{t}^{u , d} + {\sum }_{s = 1}^{S} {ϑ}_{t}^{s , d} ( {ρ}_{t}^{n , s , d} {ESSDischarge}_{t}^{s , d} ) \}$$

With respect to the exemplary Net Grid Supply constraint equation,

$${ϑ}_{t}^{u , d}$$

is the fraction of available grid-connected generation for unit (u) that is dispatched on day (d) and period (t);

$${ρ}_{t}^{n , u , d}$$

adjusts for generation unit (u) Transmission & Distribution losses associated with delivering power to network node (n) on day (d) and period (t);

$${GridGen}_{t}^{u , d}$$

is the available dispatchable generation for grid-connected generation unit (u) on day (d) and period (t);

$${ESSDischarge}_{t}^{s , d}$$

is the dischargeable energy stored in ESS (s) on day (d) and period (t);

$${ρ}_{t}^{n , s , d}$$

is the fraction of discharged energy that is delivered to the network node (n) from ESS (s) on day (d) and period (t); and

$${ϑ}_{t}^{s , d}$$

is the fraction of available energy that can discharged from ESS (s) on day (d) and period (t) that is allowed to be discharged.

Generation dispatch constraints impose operating minimum and maximum values for each grid-connection generation resource. These constraints may impose dispatchable generation limits for each generation resource. These constraints may be represented as:

$${ϑ}_{t}^{u , d} \leq 1.$$

$${\overline{ϑ}}_{t}^{u , d} \leq {ϑ}_{t}^{u , d}$$

As used in this representation,

$${ϑ}_{t}^{u , d}$$

is the fraction of available grid-connected generation for unit (u) that is dispatched on day (d) and period (t) and

$${\overline{ϑ}}_{t}^{u , d}$$

represents the minimum required fraction of generation unit (u) that must be dispatched on day (d) and period (t); minimum dispatchable fraction may be set prior to ensure the optimum solution satisfies the minimum generation requirements for the stability and security of the network.

In some examples of this formula, no feasible solution may exist when the minimum dispatchable generation requirements are combined with uncontrolled on-premises generation. Infeasibility may indicate a need to curtail a portion of distributed generation to satisfy the minimum dispatchable generation requirements.

Network capacity constraints may be similar to those of the first framework. In such an example, the network capacity constraints may be grid-edge or non-grid-edge. Grid-edge network capacity constraints may represent the operating capacities of the network lines and equipment for delivering (i.e., delivered) and receiving power to/from end users located at the edge of the network. Non-grid-edge constraints may represent the operating capacities of the network lines and equipment for flowing power between network nodes. Together these constraints may ensure the physical feasibility of the optimal solution.

The grid-edge network capacity constraints may be represented as:

$${\sum }_{e = 1}^{E ∈ n} {Delivered}_{t}^{n , e , d} \leq {DeliveredCapacity}_{t}^{n , d} , ∀ n ∈ Grid Edge$$

$${\sum }_{e = 1}^{E ∈ n} \vert {Received}_{t}^{n , e , d} \vert \geq {ReceivedCapacity}_{t}^{n , d} , ∀ n ∈ Grid Edge$$

$${OperatingCapacity}_{t}^{n , d} = {DeliverCapacity}_{t}^{n , d ,} + {ReceiveCapacity}_{t}^{n , d} , \text{} ∀ n ∈ Grid Edge$$

As used in this representation,

$${DeliveredCapacity}_{t}^{n , d}$$

represents the physical capacity for delivered power to all end users located on network node (n) on day (d) and period (t). The values for these time series will be non-negative. These constraints apply for all (∀) nodes (n) on network (N) that are located at the edge of the delivery network. Additionally, E∈n represents the list of end users (E) that are directly served by network node (e);

$${Delivered}_{t}^{n , e , d}$$

is total power delivered from network node (n) to end user (e) on day (d) and period (t);

$${ReceivedCapacity}_{t}^{n , d}$$

represents the physical capacity for received power from all end users located on network node (n) on day (d) and period (t). The values for these time series will be non-positive. These constraints apply for all (∀) nodes (n) on network (N) that are located at the edge of the delivery network.

$${Received}_{t}^{n , e , d}$$

is the total power received by network node (n) from end user (e) on day (d) and period (t); convention is for received flows to be negative which is why the sum is over the absolute values of the received flows. Lastly,

$${OperatingCapacity}_{t}^{n , d}$$

is the total capacity for power flow through network node (n) on day (d) and period (t).

The non-grid-edge network capacity constraints may be represented as:

$${DeliveredCapacity}_{t}^{n , d} \geq {\sum }_{j = 1}^{J ∈ n} {Delivered}_{t}^{n , j , d} , ∀ n ∈ N$$

$${ReceivedCapacity}_{t}^{n , d} \leq {\sum }_{j = 1}^{J ∈ n} \vert {Received}_{t}^{n , j , d} \vert , ∀ n ∈ N$$

$${Op eratingCapacity}_{t}^{n , d} = {DeliveryCapacity}_{t}^{n , d ,} + {ReceiveCapacity}_{t}^{n , d} , ∀ n ∈ N$$

As used in this representation,

$${DeliveredCapacity}_{t}^{n , d}$$

represents the physical capacity for flowing power to downstream nodes (j) that are directly connected to network node (n) on day (d) and period (t). The values for these time series will be non-negative. These constraints apply for all (∀) nodes (n) on network (N).

$${Delivered}_{t}^{n , j , d}$$

is total power delivered from network node (n) to downstream network node (j) that is directly connected to network node (n) on day (d) and period (t).

$${ReceivedCapacity}_{t}^{n , d}$$

represents the physical capacity for receiving power flowing from either downstream or upstream network nodes (j) that are directly connected to network node (n) on day (d) and period (t). The values for these time series will be non-positive. These constraints apply for all (∀) nodes (n) on network (N).

$${Received}_{t}^{n , j , d}$$

is the total power received by network node (n) upstream and downstream network nodes (j) that are directly connected to network node (n) on day (d) and period (t); convention is for received flows to be negative which is why the sum is over the absolute values of the received flows. Lastly,

$${OperatingCapacity}_{t}^{n , d}$$

is total capacity for power flow through network node (n) on day (d) and period (t).

Network storage system constraints may also be used to represent imposed operating restrictions on how ESS units are charged and discharged. The charging and discharging activity may be determined by solving objective function subject to discharge constraints. In some examples of this second framework, the network storage system constraints may be represented as ESS capacity constraints and ESS charging constraints.

With respect to ESS capacity constraints, they may tie current energy stored to the prior period storage plus current period charging and discharging activity. In these constraints, charging activity may be treated as a demand for power from the network. Charging efficiency factors may be used to model energy losses as part of the charging process. In contrast, discharging activity may be treated as a supply of power to the network. The amount of energy discharged may be removed from the ESS. Discharge losses may be accounted for in the Energy Balance Constraints presented above. A separate set of constraints may be defined for each ESS (s) and day (d) and period in the decision horizon (D). An exemplary representation of these constraints may be:

$$E S S E n e r g {y}_{t}^{s , d} = E S S n e r g {y}_{t - 1}^{s , d} + ( {ρ}^{s} E S S C h a r g {e}_{t}^{s , d} ) - E S S D i s c h a r g {e}_{t}^{s , d}$$

Lower and upper bounds on the State of Charge (SOC) for each ESS (s) for each day (d) and period (t) may also be imposed by further constraints. These SOC bounds may be externally supplied operating constraints. These may be represented as:

$${ESSEnergy}_{t}^{s , d} \leq {ESS Max SOC}^{s , D} {ESSCapacity}^{s , d}$$

$${ESSEnergy}_{t}^{s , d} \geq {ESS Min SOC}^{s , D} {ESSCapacity}^{s , d}$$

With respect to ESS charging constraints, they may be represented by equations which place operating constraints on charging activity. A first set of constraints may be used to ensure that charging will always be non-negative. A second set of constraints may be used to ensure that charging activity in any period does not exceed the physical charging limits of the ESS. Hence, in this exemplary second framework, there may be be two sets of constraints for each ESS (s) for each day (d) and period (t). These constraints may be represented as:

$${ESSCharge}_{t}^{s , d} \geq 0$$

$${ESSCharge}_{t}^{s , d} \leq {ESSChargeCap}^{s , D}$$

ESS charging constraints may also include ESS discharge constraints, which may be represented by a set of equations used to place operating constraints on discharging activity. A first set of discharge constraints may be used to ensure that discharging will always be non-negative. A second set of discharge constraints may be used to ensure that discharging activity in any period does not exceed the physical discharge limits of the ESS. Thus, there may be two sets of constraints for each ESS (b) for each day (d) and period (t) in the decision horizon (D). These constraints may be represented as:

$${ESSDischarge}_{t}^{s , d} \geq 0$$

$${ESSDisharge}_{t}^{s , d} \leq {ESSDischargeCap}^{s , D}$$

With respect to the exemplary network storage system constraint formulae presented above,

$${ESSEnergy}_{t}^{s , d}$$

is the total energy (MWh) stored in ESS (s) on day (d) and period (t); the prior period is indexed by (t−1); ESSCapacity^{s,D} is the energy capacity (MWh) of ESS (s) in the decision horizon (D); ESSMaxSOC^{s,D} is the targeted maximum SOC for ESS (s) in the decision horizon (D); ESSMinSOC^{s,D} is the targeted minimum SOC for ESS (s) in the decision horizon (D);

$${ESSCharge}_{t}^{s , d}$$

is the total gross charge (kW per period) of ESS (s) on day (d) and period (t); ESSChargeCap^{s,D} is the charging capacity (kW per period) of ESS (s) in decision horizon (D); δ^{s} is the fraction of gross charge that is stored in ESS (s); 0≤δ^{s}≤1;

$${ESSDischarge}_{t}^{s , d}$$

is the discharge (kWh per period) from ESS (s) on day (d) and period (t); and ESSDischargeCap^{s,D} is the discharge capacity (kW per period) from ESS (s) in decision horizon (D).

### Example PNO Framework 3

A third exemplary framework is similar to the first and second frameworks, with the addition of a distributed generation control that balances the net demand for power while adhering to the operating constraints of the low voltage network and minimum demand conditions. Under this framework, PNOs may take as given at least: (1) forecasts of aggregate net demand for power by network node (e.g., transformer/phase, feeder/phase, substation, transmission zone); (2) grid-connected generation supply curve; (3) operating characteristics of ESS that are used for energy arbitrage across time periods (4) low voltage network capacity constraints; (5) minimum demand requirements for maintaining the operating security of the low voltage network; and (6) the portion of distributed generation that is under PNO direct control. This framework may be referred to as a minimum demand and distributed generation control framework. This framework may be considered to particularly address minimum demand events.

This third exemplary framework may be extended to allow network operator control over distributed generation. Network operator control over distributed generation may be required when total Net Load falls below levels required for dispatching grid-connected generation for frequency regulation and voltage support. To avoid the sag in net loads, operators may require the ability to dispatch generation control to a fleet of distributed generation units for which end users may have agreed to participate in a Generation Control market program. Solar inverter control may be an example of such a direct control. Such end users or service sites may be referred to as market participants, while those who have not agreed to participate or are otherwise unable to participate may be referred to as non-market participants. The exemplary framework may be designed to determine, as an objective of the objective function, the level of distributed generation control that is required to avoid minimum demand levels. An exemplary objective function as per this third framework that includes dispatching of grid-connected generation, ESS, and market participant controllable distributed generation may be described as:

$$\frac{Minimize}{{ϑ}_{t}^{u , d} , {ϑ}_{t}^{s , d} , {ϑ}_{t}^{n , d}} {\sum }_{d = 1}^{D} {\sum }_{t = 1}^{T} {\sum }_{u = 1}^{U} {\sum }_{n = 1}^{N} {LMP}_{t}^{n , d} ( {ϑ}_{t}^{u , d} {ρ}_{t}^{n , u , d} {GridGen}_{t}^{u , d} ) + {\sum }_{d = 1}^{D} {\sum }_{t = 1}^{T} {\sum }_{s = 1}^{S} {\sum }_{n = 1}^{N} {LMP}_{t}^{n , d} ( {ϑ}_{t}^{s , d} {ρ}_{t}^{n , s , d} {ESSDischarge}_{t}^{s , d} ) - {\sum }_{d = 1}^{D} {\sum }_{t = 1}^{T} {\sum }_{n = 1}^{N} {\sum }_{e = 1}^{E ∈ P} {OPP}_{t}^{n , d} ( ( 1 - {ϑ}_{t}^{n , d} ) {GEN}_{t}^{n , e , d} )$$

The objective of this exemplary function according to the third framework is to minimize the total cost of electricity services. The objective function as shown has three components. The first is the total cost of electricity dispatched from the fleet of grid-connected generation units. The second cost is the total cost of energy discharged to the network from the fleet of dispatchable ESS units. The third is the opportunity cost to market participants for allowing their generation to be reduced. This latter may be used to raise the overall cost of electricity services. This may incentivize the function to dispatch as little of distributed generation control as possible while adhering to the physical constraints of the network. The three control variables that are solved for in this exemplary function as written are

$${ϑ}_{t}^{u , d}$$

representing the fraction of available grid-connected generation for unit (u) that is dispatched on day (d) and period (t);

$${ϑ}_{t}^{s , d}$$

representing the fraction of available dischargeable energy for ESS (s) on day (d) and period (t) that is allowed to be discharged as needed; and

$${ϑ}_{t}^{n , d}$$

representing the portion of the expected uncontrollable distributed generation that is allowed to be generated for each market participant located on network node (n) on day (d) and period (t), where

$$( 1 - {ϑ}_{t}^{n , d} )$$

is the generation opportunity lost due to the DER control activity.

This objective function, as part of the framework, may indicate that the network operator can dispatch both grid-connected and market participating non-grid connected generation resources in a way that reduces the cost of electricity to all end users, both market and non-market participants.

In the exemplary function as shown above,

$${LMP}_{t}^{n , d}$$

is the locational marginal price ($/kWh) for power delivered to end users connected to network node (n) on day (d) and period (t);

$${ρ}_{t}^{n , u , d}$$

adjusts for generation unit (u) Transmission & Distribution losses associated with delivering power to network node (n) on day (d) and period (t);

$${GridGen}_{t}^{u , d}$$

is the available dispatchable generation for grid-connected generation unit (u) on day (d) and period (t);

$${ESSDischarge}_{t}^{s , d}$$

is the available dischargeable energy for ESS (s) on day (d) and period (t);

$${ρ}_{t}^{n , s , d}$$

adjusts for ESS (s) losses associated with discharging power to the network node (n) on day (d) and period (t);

$${GEN}_{t}^{n , e , d}$$

is the expected or forecasted uncontrollable distributed generation for market participant (e) located on network node (n) on day (d) and period (t);

$${OPP}_{t}^{n , d}$$

is the marginal value ($/kWh) market participants assign to forgoing a unit of distributed generation located on network node (n) on day (d) and period (t); D represents the number of days in the decision horizon; days within the decision horizon are indexed by (d); T represents the total number of time periods in a day (e.g., 288 five-minute intervals, 96 15-minute intervals, 48 30-minute time intervals, and 24 60-minute time intervals), where periods within a day in the decision horizon are indexed by (t); E∈P represents the list of end users (E) that agree to participate in the DER control market program; U represents the total number of grid-connected generation units, where individual generation units are indexed by (u); N represents the number of network connection points or nodes; individual network nodes are indexed by (n); and E presents the total number of end users located on network node (n), where individual end users are indexed by (e).

The objective function may be subject to a number of constraints in this third framework to ensure an operationally feasible least cost dispatch solution. Examples of such constraints include energy balance constraints (net grid load and net grid supply), generation dispatch constraints, network capacity constraints (grid-edge and non-grid-edge), and network storage system constraints (ESS capacity and ESS charging).

Energy balance constraints may ensure net grid supply of power exactly offsets the net demand for power for each day (d) and period (t) in the decision horizon (D). The Energy Balance Constraint may be expressed from the perspective of the Network Operator as:

$${NetLoad}_{t}^{N , d} = {NetGridSupply}_{t}^{N , d}$$

In this example, the net load

$${NetLoad}_{t}^{N , d}$$

is a forecast of total delivered power less total received power from all end users served by the network (N) on day (d) and period (t). With grid-connected Energy Storage Systems (ESS) the net load may be augmented by the amount of power that is added to the ESS units via charging activity. To model DER control programs, end users may be segmented between those that have agreed to participate in the DER control program (indexed by P and p) versus end users that have not agreed to participate (indexed by NP and np). Given this segmentation, the elements that make up Net Load for power may be defined as three sets of equations. The first set of equations, which may indicate non-market participant delivered and received power, may be represented as:

$${NP\_Delivered}_{t}^{n , e ∈ NP , d} = IF [ ( {Load}_{t}^{n , e ∈ NP , d} - {GEN}_{t}^{n , e ∈ NP , d} ) \geq 0 ] \\ {NP\_Received}_{t}^{n , e ∈ NP , d} = IF [ ( {Load}_{t}^{n , e ∈ NP , d} - {GEN}_{t}^{n , e ∈ NP , d} ) \leq 0 ]$$

The second set of equations, which may indicate market participant delivered and received power, may be represented as:

$${P\_Delivered}_{t}^{n , e ∈ P , d} = IF [ ( {Load}_{t}^{n , e ∈ P , d} - {ϑ}_{t}^{n , d} {GEN}_{t}^{n , e ∈ P , d} ) \geq 0 ] \\ {P\_Received}_{t}^{n , e ∈ P , d} = IF [ ( {Load}_{t}^{n , e ∈ P , d} - {ϑ}_{t}^{n , d} {GEN}_{t}^{n , e ∈ P , d} ) \leq 0 ]$$

Hence, the total net load (third set) may be represented as:

$${NetLoad}_{t}^{N , d} = {\sum }_{n = 1}^{N} {\sum }_{e = 1}^{E ∈ n} ( {NP\_Delivered}_{t}^{n , e ∈ NP , d} + {P\_Delivered}_{t}^{n , e ∈ P , d} ) + {\sum }_{n = 1}^{N} {\sum }_{e = 1}^{E ∈ n} ( {NP\_Received}_{t}^{n , e ∈ NP , d} + {P\_Received}_{t}^{n , e ∈ P , d} ) + {\sum }_{s = 1}^{S} {ESSCharge}_{t}^{s , d}$$

With respect to these Net Load constraints as described in this example,

$${ESSCharge}_{t}^{s , d}$$

is the amount of gross energy that could be added to ESS (s) on day (d) and period (t);

$${Load}_{t}^{n , e , d}$$

is the demand for electricity regardless of how itis sourced for end user (e) served by network node (n) on day (d) and period (t);

$${DER}_{t}^{n , e , d}$$

represents on-premises generation that is used to offset on-premises demand for electricity for end user (e) on day (d) and period (t);

$${NP\_Delivered}_{t}^{n , e ∈ NP , d}$$

is the additional power required to be pulled in from the network node (n) to meet non-market participant (NP) end user (e) power requirements on day (d) and period (t);

$${NP\_Received}_{t}^{n , e ∈ NP , d}$$

is excess power pushed onto the network at node (n) from non-market participant (NP) end user (e) on day (d) and period (t);

$${P\_Delivered}_{t}^{n , e ∈ P , d}$$

is the additional power required to be pulled in from the network node (n) to meet market participant (P) end user (e) power requirements on day (d) and period (t);

$${P\_Received}_{t}^{n , e ∈ P , d}$$

is excess power pushed onto the network at node (n) from market participant (P) end user (e) on day (d) and period (t); and

$${ϑ}_{t}^{n , d}$$

is the portion of the expected distributed generation that is allowed to be generated for each market participant (P) located on network node (n) on day (d) and period (t).

The net grid-connected supply component of the Energy Balance Constraint may be similar to the second exemplary framework. In this example of the Energy Balance Constraint, the net grid-connected supply may be defined as the sum of grid-connected generation adjusted for Transmission and Distribution losses plus net (i.e., gross discharge less discharge losses) discharged power from grid-connected Energy Storage. This may be represented as:

$${NetGridSupply}_{t}^{N , d} = {\sum }_{n - 1}^{N} \{ {\sum }_{u}^{U} {ϑ}_{t}^{u , d} {ρ}_{t}^{n , u , d} G r i d G e {n}_{t}^{u , d} + {\sum }_{s = 1}^{s} {ϑ}_{t}^{n , s , d} ( {ρ}_{t}^{n , s , d} E S S D i s c h a r g {e}_{t}^{s , d} ) \}$$

With respect to the exemplary Net Grid Supply constraint equation,

$${ϑ}_{t}^{u , d}$$

is the fraction of available grid-connected generation for unit (u) that is dispatched on day (d) and period (t);

$${ρ}_{t}^{n , u , d}$$

adjusts for generation unit (u) Transmission & Distribution losses associated with delivering power to network node (n) on day (d) and period (t);

$$G r i d G e {n}_{t}^{u , d}$$

is the available dispatchable generation for grid-connected generation unit (u) on day (d) and period (t);

$$E S S D i s c h a r g {e}_{t}^{s , d}$$

is the dischargeable energy stored in ESS (s) on day (d) and period (t);

$${ρ}_{t}^{n , s , d}$$

is the fraction of discharged energy that is delivered to the network node (n) from ESS (s) on day (d) and period (t); and

$${ϑ}_{t}^{s , d}$$

is the fraction of available energy that can discharged from ESS (s) on day (d) and period (t) that is allowed to be discharged.

Generation dispatch constraints impose operating minimum and maximum values for each grid-connection generation resource. These constraints may impose dispatchable generation limits for each generation resource. These constraints may be similar to those in the first and second exemplary frameworks. These constraints may be represented as:

$${ϑ}_{t}^{u , d} \leq 1.$$

$${\overline{ϑ}}_{t}^{u , d} \leq {ϑ}_{t}^{u , d}$$

As used in this representation,

$${ϑ}_{t}^{u , d}$$

is the fraction of available grid-connected generation for unit (u) that is dispatched on day (d) and period (t) and

$${\overline{ϑ}}_{t}^{u , d}$$

represents the minimum required fraction of generation unit (u) that must be dispatched on day (d) and period (t); minimum dispatchable fraction may be set prior to ensure the optimum solution satisfies the minimum generation requirements for the stability and security of the network.

In some examples of this formula, no feasible solution may exist when the minimum dispatchable generation requirements are combined with uncontrolled on-premises generation. Infeasibility may indicate a need to curtail a portion of distributed generation to satisfy the minimum dispatchable generation requirements.

Network capacity constraints may be similar to those of the first and second exemplary frameworks. In such an example, the network capacity constraints may be grid-edge or non-grid-edge. Grid-edge network capacity constraints may represent the operating capacities of the network lines and equipment for delivering (i.e., delivered) and receiving power to/from end users located at the edge of the network. Non-grid-edge constraints may represent the operating capacities of the network lines and equipment for flowing power between network nodes. Together these constraints may ensure the physical feasibility of the optimal solution.

The grid-edge network capacity constraints may be represented as:

$${\sum }_{e = 1}^{E ∈ n} {Delivered}_{t}^{n , e , d} \leq {DeliveredCapacity}_{t}^{n , d} , ∀ n ∈ Grid Edge$$

$${\sum }_{e = 1}^{E ∈ n} \vert {Received}_{t}^{n , e , d} \vert \geq {ReceivedCapacity}_{t}^{n , d} , ∀ n ∈ Grid Edge$$

$${OperatingCapacity}_{t}^{n , d} = {DeliverCapacity}_{t}^{n , d ,} + {ReceiveCapacity}_{t}^{n , d} ,$$

$$∀ n ∈ Grid Edge$$

As used in this representation,

$${DeliveredCapacity}_{t}^{n , d}$$

represents the physical capacity for delivered power to all end users located on network node (n) on day (d) and period (t). The values for these time series will be non-negative. These constraints apply for all (∀) nodes (n) on network (N) that are located at the edge of the delivery network. Additionally, E∈n represents the list of end users (E) that are directly served by network node (e);

$${Delivered}_{t}^{n , e , d}$$

is total power delivered from network node (n) to end user (e) on day (d) and period (t);

$${ReceivedCapacity}_{t}^{n , d}$$

represents the physical capacity for received power from all end users located on network node (n) on day (d) and period (t). The values for these time series will be non-positive. These constraints apply for all (∀) nodes (n) on network (N) that are located at the edge of the delivery network.

$${Received}_{t}^{n , e , d}$$

is the total power received by network node (n) from end user (e) on day (d) and period (t); convention is for received flows to be negative which is why the sum is over the absolute values of the received flows. Lastly,

$${OperatingCapacity}_{t}^{n , d}$$

is the total capacity for power flow through network node (n) on day (d) and period (t).

The non-grid-edge network capacity constraints may be represented as:

$${DeliveredCapacity}_{t}^{n , d} \geq {\sum }_{j = 1}^{J ∈ n} {Delivered}_{t}^{n , j , d} , ∀ n ∈ N$$

$${ReceivedCapacity}_{t}^{n , d} \leq {\sum }_{j = 1}^{J ∈ n} \vert {Received}_{c}^{n ,} \vert , ∀ n ∈ N$$

$${OperatingCapacity}_{t}^{n , d} = {DeliverCapacity}_{t}^{n , d ,} + {ReceiveCapacity}_{t}^{n , d} ,$$

$$∀ n ∈ N$$

As used in this representation,

$${DeliveredCapacity}_{t}^{n , d}$$

represents the physical capacity for flowing power to downstream nodes (j) that are directly connected to network node (n) on day (d) and period (t). The values for these time series will be non-negative. These constraints apply for all (∀) nodes (n) on network (N).

$${Delivered}_{t}^{n , j , d}$$

is total power delivered from network node (n) to downstream network node (j) that is directly connected to network node (n) on day (d) and period (t).

$${ReceivedCapacity}_{t}^{n , d}$$

represents the physical capacity for receiving power flowing from either downstream or upstream network nodes (j) that are directly connected to network node (n) on day (d) and period (t). The values for these time series will be non-positive. These constraints apply for all (∀) nodes (n) on network (N).

$${Received}_{t}^{n , j , d}$$

is the total power received by network node (n) upstream and downstream network nodes (j) that are directly connected to network node (n) on day (d) and period (t); convention is for received flows to be negative which is why the sum is over the absolute values of the received flows. Lastly,

$${OperatingCapacity}_{t}^{n , d}$$

is total capacity for power flow through network node (n) on day (d) and period (t).

Network storage system constraints may also be similar to the second exemplary framework. They may similarly be used to represent imposed operating restrictions on how ESS units are charged and discharged. The charging and discharging activity may be determined by solving objective function subject to discharge constraints. In some examples of this second framework, the network storage system constraints may be represented as ESS capacity constraints and ESS charging constraints.

With respect to ESS capacity constraints, they may tie current energy stored to the prior period storage plus current period charging and discharging activity. In these constraints, charging activity may be treated as a demand for power from the network. Charging efficiency factors may be used to model energy losses as part of the charging process. In contrast, discharging activity may be treated as a supply of power to the network. The amount of energy discharged may be removed from the ESS. Discharge losses may be accounted for in the Energy Balance Constraints presented above. A separate set of constraints may be defined for each ESS (s) and day (d) and period in the decision horizon (D). An exemplary representation of these constraints may be:

$${ESSEnergy}_{t}^{s , d} = {ESSnergy}_{t - 1}^{s , d} + ( {ρ}^{s} {ESSCharge}_{t}^{s , d} ) - {ESSDischarge}_{t}^{s , d}$$

Lower and upper bounds on the State of Charge (SOC) for each ESS (s) for each day (d) and period (t) may also be imposed by further constraints. These SOC bounds may be externally supplied operating constraints. These may be represented as:

$${ESSEnergy}_{t}^{s , d} \leq ESS Max {SOC}^{s , D} {ESSCapacity}^{s , d}$$

$${ESSEnergy}_{t}^{s , d} \geq ESS Min {SOC}^{s , D} {ESSCapacity}^{s , d}$$

With respect to ESS charging constraints, they may be represented by equations which place operating constraints on charging activity. A first set of constraints may be used to ensure that charging will always be non-negative. A second set of constraints may be used to ensure that charging activity in any period does not exceed the physical charging limits of the ESS. Hence, in this exemplary second framework, there may be be two sets of constraints for each ESS (s) for each day (d) and period (t). These constraints may be represented as:

$$E S S C h a r g {e}_{t}^{s , d} \geq 0$$

$$ESSC h a r g {e}_{t}^{s , d} \leq E S S C h a r g e C a {p}^{s , D}$$

ESS charging constraints may also include ESS discharge constraints, which may be represented by a set of equations used to place operating constraints on discharging activity. A first set of discharge constraints may be used to ensure that discharging will always be non-negative. A second set of discharge constraints may be used to ensure that discharging activity in any period does not exceed the physical discharge limits of the ESS. Thus, there may be two sets of constraints for each ESS (b) for each day (d) and period (t) in the decision horizon (D). These constraints may be represented as:

$$E S S D i s c h a r g {e}_{t}^{s , d} \geq 0$$

$$ESSD i s c h a r g {e}_{t}^{s , d} \leq E S S D i s c h a r g e C a {p}^{s , D}$$

With respect to the exemplary network storage system constraint formulae presented above,

$$E S S E n e r g {y}_{t}^{s , d}$$

is the total energy (MWh) stored in ESS (s) on day (d) and period (t); the prior period is indexed by (t−1); ESSCapacity^{s,D} is the energy capacity (MWh) of ESS (s) in the decision horizon (D); ESSMaxSOC^{s,D} is the targeted maximum SOC for ESS (s) in the decision horizon (D); ESSMinSOC^{s,D} is the targeted minimum SOC for ESS (s) in the decision horizon (D);

$$E S S C h a r g {e}_{t}^{s , d}$$

is the total gross charge (kW per period) of ESS (s) on day (d) and period (t); ESSChargeCap^{s,D} is the charging capacity (kW per period) of ESS (s) in decision horizon (D); δ^{s} is the fraction of gross charge that is stored in ESS (s); 0≤δ^{s}≤1;

$$E S S D i s c h a r g {e}_{t}^{s , d}$$

is the discharge (kWh per period) from ESS (s) on day (d) and period (t); and ESSDischargeCap^{s,D} is the discharge capacity (kW per period) from ESS (s) in decision horizon (D).

### Example PNO Framework 4

A fourth exemplary framework may be similar to the first, second, and third frameworks, with the addition of distributed load control (as well as distributed generation control) that balances the net demand for power while adhering to the operating constraints of the low voltage network and minimum demand conditions. Under this framework, PNOs may take as given at least: (1) forecasts of aggregate net demand for power by network node (e.g., transformer/phase, feeder/phase, substation, transmission zone); (2) grid-connected generation supply curve; (3) operating characteristics of ESS that are used for energy arbitrage across time periods (4) low voltage network capacity constraints; (5) minimum demand requirements for maintaining the operating security of the low voltage network; (6) the portion of distributed generation that is under PNO direct control; and (7) the list of control end user appliances and end-use equipment that is under PNO direct control. This framework may be referred to as an excess demand and DER load control framework. This framework may be considered to additionally address extreme demand events.

This fourth exemplary framework may be considered to now be extended to allow network operator control over distributed demand. This extension may include active and/or passive control of end user appliances and end-use equipment. This level of control may be required when network constraints prevent sufficient power being delivered to end users. To avoid rolling brown outs or black outs, a network operator may activate load control programs. These load controls may, in some examples, only be or primarily be extended to end users or service sites which have agreed to participate (market participants). In some examples, distributed generation control and distributed load control may be associated, such that a market participant opts-in to both. In other examples, the two may be separated. In yet other examples, only a portion of each of generation and/or load may be controlled. Market participants may also be defined by an opt-out system, a regulatory system, technical or physical feasibility, or a variety of other such determinations. By way of example and without limitation, for the purposes of this exemplary framework, market participants shall be assumed to be participating in both load and generation control, though not necessarily in equal portions.

By way of example, there may be two generic classes of load control programs. Passive load control programs, the first class, may rely on end users to take actions to reduce their loads. Market participants may be notified via public information announcements or price signals that load reduction is requested. Active load control programs, the second class, may utilize direct third-party control of appliances and end-use equipment to reduce demand for power. Both classes of load control programs may be initiated by a network operator. An exemplary objective function as per this fourth framework that includes dispatching of grid-connected generation, ESS, controllable distributed generation, and market participant in Load Control programs may be described as:

$$\frac{Minimize}{{ϑ}_{t}^{u , d} , {ϑ}_{t}^{s , d} , {ϑ}_{t}^{n , d} , {ϑ}_{t}^{n , c , d}} {\sum }_{d = 1}^{D} {\sum }_{t = 1}^{T} {\sum }_{u = 1}^{U} {\sum }_{n = 1}^{N} L M {P}_{t}^{n , d} ( {ϑ}_{t}^{u , d} {ρ}_{t}^{n , u , d} G r i d G e {n}_{t}^{u , d} ) + {\sum }_{d = 1}^{D} {\sum }_{t = 1}^{T} {\sum }_{s = 1}^{S} {\sum }_{n = 1}^{N} L M {P}_{t}^{n , d} ( {ϑ}_{t}^{s , d} {ρ}_{t}^{n , s , d} E S S D i s c h a r g {e}_{t}^{s , d} ) - {\sum }_{d = 1}^{D} {\sum }_{t = 1}^{T} {\sum }_{n = 1}^{N} {\sum }_{e = 1}^{E ∈ P} {GENOPP}_{t}^{n , d} ( ( 1 - {ϑ}_{t}^{n , d} ) G E {N}_{t}^{n , e , d} ) - {\sum }_{d = 1}^{D} {\sum }_{t = 1}^{T} {\sum }_{n = 1}^{N} {\sum }_{c = 1}^{C} {\sum }_{e = 1}^{E ∈ c} {OPP}_{t}^{n , c , d} [ ( 1 - {ϑ}_{t}^{n , c , d} ) {Load}_{t}^{n , c , e , d} ]$$

The objective of this exemplary function according to the fourth framework is to minimize the total cost of electricity services. The exemplary objective function as shown above has four cost components. The first is the total cost of electricity dispatched from the fleet of grid-connected generation units. The second cost is the total cost of energy discharged to the network from the fleet of dispatchable ESS units. The third is the opportunity cost to market participants for allowing their generation to be reduced. This latter component is used to raise the overall cost of electricity services. This incentivizes the objective function to dispatch as little of distributed generation control as possible while adhering to the physical constraints of the network. The fourth is the end user opportunity cost of forgoing a unit of electricity services due to load control. Likewise, to curtail distributed generation, load control actions may raise costs which in turn may incentivize the function to dispatch as little of load control as possible. The four control variables that are solved for in this exemplary function as written are

$${ϑ}_{t}^{u , d}$$

representing the fraction of available grid-connected generation for unit (u) that is dispatched on day (d) and period (t);

$${ϑ}_{t}^{s , d}$$

representing the fraction of available dischargeable energy for ESS (s) on day (d) and period (t) that is allowed to be discharged as needed;

$${ϑ}_{t}^{n , d}$$

representing the portion of the expected uncontrollable distributed generation that is allowed to be generated for each market participant located on network node (n) on day (d) and period (t), where

$$( 1 - {ϑ}_{t}^{n , d} )$$

is the generation opportunity lost due to the DER control activity; and

$${ϑ}_{t}^{n , c , d}$$

representing the portion of expected uncontrollable appliance or end-use usage subject to control under load control program (c) active on network node (n) on day (d) and period (t), where

$$( 1 - {ϑ}_{t}^{n , c , d} )$$

is the opportunity electricity services lost due to the load control activity (c).

This objective function, as part of the framework, may indicate that the network operator can dispatch grid-connected generation, ESS, market participating non-grid connected generation, and market participating load control programs in a way that reduces the cost of electricity to all end users, both market and non-market participants.

In the exemplary function as shown above,

$${LMP}_{t}^{n , d}$$

is the locational marginal price ($/kWh) for power delivered to end users connected to network node (n) on day (d) and period (t);

$${ρ}_{t}^{n , u , d}$$

adjusts for generation unit (u) Transmission & Distribution losses associated with delivering power to network node (n) on day (d) and period (t);

$${GridGen}_{t}^{u , d}$$

is the available dispatchable generation for grid-connected generation unit (u) on day (d) and period (t);

$$E S S D i s c h a r g {e}_{t}^{s , d}$$

is the available dischargeable energy for ESS (s) on day (d) and period (t);

$${ρ}_{t}^{n , s , d}$$

adjusts for ESS (s) losses associated with discharging power to the network node (n) on day (d) and period (t);

$$G E {N}_{t}^{n , e , d}$$

is the expected or forecasted uncontrollable distributed generation for market participant (e) located on network node (n) on day (d) and period (t);

$$G E N O P {P}_{t}^{n , d}$$

is the marginal value ($/kWh) market participants assign to forgoing a unit of distributed generation located on network node (n) on day (d) and period (t);

$$L o a {d}_{t}^{n , c , e , d}$$

is end user (e) located on network node (n) expected uncontrolled appliance or end-use equipment power usage that is part of Load Control program (c) on day (d) and period (t);

$$O P {P}_{t}^{n , c , d}$$

is the marginal value ($/kWh) market participants assign to forgoing a unit of usage of appliance or end-use equipment that is under control by Load Control program (c); D represents the number of days in the decision horizon; days within the decision horizon are indexed by (d); T represents the total number of time periods in a day (e.g., 288 five-minute intervals, 96 15-minute intervals, 48 30-minute time intervals, and 24 60-minute time intervals), where periods within a day in the decision horizon are indexed by (t); E∈P represents the list of end users (E) that agree to participate in the DER control market program; U represents the total number of grid-connected generation units, where individual generation units are indexed by (u); N represents the number of network connection points or nodes; individual network nodes are indexed by (n); and E presents the total number of end users located on network node (n), where individual end users are indexed by (e).

The objective function may be subject to a number of constraints in this fourth framework to ensure an operationally feasible least cost dispatch solution. Examples of such constraints include energy balance constraints (net grid load and net grid supply), generation dispatch constraints, network capacity constraints (grid-edge and non-grid-edge), and network storage system constraints (ESS capacity and ESS charging).

Energy balance constraints may ensure net grid supply of power exactly offsets the net demand for power for each day (d) and period (t) in the decision horizon (D). The Energy Balance Constraint may be expressed from the perspective of the Network Operator as:

$${NetLoad}_{t}^{N , d} = {NetGridSupply}_{t}^{N , d}$$

In this example, the net load

$${NetLoad}_{t}^{N , d}$$

is a forecast of total delivered power less total received power from all end users served by the network (N) on day (d) and period (t). With grid-connected Energy Storage Systems (ESS) the net load may be augmented by the amount of power that is added to the ESS units via charging activity. To model DER control programs, end users may be segmented between those that have agreed to participate in the DER control program (indexed by P and p) versus end users that have not agreed to participate (indexed by NP and np). Given this segmentation, the elements that make up Net Load for power may be defined as three sets of equations. The first set of equations, which may indicate non-market participant delivered and received power, may be represented as:

$${NP\_Delivered}_{t}^{n , e ∈ NP , d} = IF [ ( {Load}_{t}^{n , e ∈ NP , d} - {GEN}_{t}^{n , e ∈ NP , d} ) \geq 0 ]$$

$${NP\_Received}_{t}^{n , e ∈ NP , d} = IF [ ( {Load}_{t}^{n , e ∈ NP , d} - {GEN}_{t}^{n , e ∈ NP , d} ) \leq 0 ]$$

The second set of equations, which may indicate market participant delivered and received power, may be represented as:

$${P\_Delivered}_{t}^{n , e ∈ P , d} = IF [ ( {Load}_{t}^{n , e ∈ P , d} - {ϑ}_{t}^{n , c , d} {Load}_{t}^{n , c , e ∈ c , d} - {ϑ}_{t}^{n , d} {GEN}_{t}^{n , e ∈ P , d} ) \geq 0 ]$$

$${P\_Received}_{t}^{n , e ∈ P , d} = IF [ ( {Load}_{t}^{n , e ∈ P , d} - {ϑ}_{t}^{n , c , d} {Load}_{t}^{n , c , e ∈ c , d} - {ϑ}_{t}^{n , d} {GEN}_{t}^{n , e ∈ P , d} ) \leq 0 ]$$

Hence, the total net load (third set) may be represented as:

$$\begin{matrix}{NetLoad}_{t}^{N , d} = {\sum }_{n = 1}^{N} {\sum }_{e = 1}^{E ∈ n} ( {NP\_ Delivered}_{t}^{n , e ∈ NP , d} + {P\_ Delivered}_{t}^{n , e ∈ P , d} ) \\ + {\sum }_{n = 1}^{N} {\sum }_{e = 1}^{E ∈ n} ( {NP\_Received}_{t}^{n , e ∈ NP , d} + {P\_Received}_{t}^{n , e ∈ P , d} ) \\ + {\sum }_{s = 1}^{S} {ESSCharge}_{t}^{s , d}\end{matrix}$$

With respect to these Net Load constraints as described in this example,

$${ESSCharge}_{t}^{s , d}$$

is the amount of gross energy that could be added to ESS (s) on day (d) and period (t);

$${Load}_{t}^{n , e , d}$$

is the demand for electricity regardless of how it is sourced for end user (e) served by network node (n) on day (d) and period (t);

$${DER}_{t}^{n , e , d}$$

represents on-premises generation that is used to offset on-premises demand for electricity for end user (e) on day (d) and period (t);

$${NP\_Delivered}_{t}^{n , e ∈ NP , d}$$

is the additional power required to be pulled in from the network node (n) to meet non-market participant (NP) end user (e) power requirements on day (d) and period (t);

$${NP\_Received}_{t}^{n , e ∈ NP , d}$$

is excess power pushed onto the network at node (n) from non-market participant (NP) end user (e) on day (d) and period (t);

$${P\_Delivered}_{t}^{n , e ∈ P , d}$$

is the additional power required to be pulled in from the network node (n) to meet market participant (P) end user (e) power requirements on day (d) and period (t), where the power required is adjusted by end user participation in load control activity

$$( {ϑ}_{t}^{n , c , d} {Load}_{t}^{n , c , e ∈ c , d} ) ; {P\_Received}_{t}^{n , e ∈ P , d}$$

is excess power pushed onto the network at node (n) from market participant (P) end user (e) on day (d) and period (t), where the power received is adjusted by end user participation in load control activity

$$( {ϑ}_{t}^{n , c , d} {Load}_{t}^{n , c , e ∈ c , d} ) ; {ϑ}_{t}^{n , d}$$

is the portion of the expected distributed generation that is allowed to be generated for each market participant (P) located on network node (n) on day (d) and period (t); and

$${ϑ}_{t}^{n , c , d}$$

is the portion of uncontrolled appliance or equipment power requirements that are reduced due to load control activity for program (c) active on network node (n) on day (d) and period (t).

The net grid-connected supply component of the Energy Balance Constraint may be similar to the third exemplary framework. In this example of the Energy Balance Constraint, the net grid-connected supply may be defined as the sum of grid-connected generation adjusted for Transmission and Distribution losses plus net (i.e., gross discharge less discharge losses) discharged power from grid-connected Energy Storage. This may be represented as:

$${NetGridSupply}_{t}^{N , d} = {\sum }_{n - 1}^{N} \{ {\sum }_{u}^{U} {ϑ}_{t}^{u , d} {ρ}_{t}^{n , u , d} {GridGen}_{t}^{u , d} + {\sum }_{s = 1}^{S} {ϑ}_{t}^{n , s , d} ( {ρ}_{t}^{n , s , d} {ESSDischarge}_{t}^{s , d} ) \}$$

With respect to the exemplary Net Grid Supply constraint equation,

$${ϑ}_{t}^{u , d}$$

is the fraction of available grid-connected generation for unit (u) that is dispatched on day (d) and period (t);

$${ρ}_{t}^{n , u , d}$$

adjusts for generation unit (u) Transmission & Distribution losses associated with delivering power to network node (n) on day (d) and period (t);

$${GridGen}_{t}^{u , d}$$

is the available dispatchable generation for grid-connected generation unit (u) on day (d) and period (t);

$${ESSDischarge}_{t}^{s , d}$$

is the dischargeable energy stored in ESS (s) on day (d) and period (t);

$${ρ}_{t}^{n , s , d}$$

is the fraction of discharged energy that is delivered to the network node (n) from ESS (s) on day (d) and period (t); and

$${ϑ}_{t}^{s , d}$$

is the fraction of available dischargeable energy for ESS (s) on day (d) and period (t) that is allowed to be discharged as needed.

Generation dispatch constraints impose operating minimum and maximum values for each grid-connection generation resource. These constraints may impose dispatchable generation limits for each generation resource. These constraints may be similar to those in the first, second, and third exemplary frameworks. These constraints may be represented as:

$${ϑ}_{t}^{u , d} \leq 1.$$

$${\overline{ϑ}}_{t}^{u , d} \leq {ϑ}_{t}^{u , d}$$

As used in this representation,

$${ϑ}_{t}^{u , d}$$

is the fraction of available grid-connected generation for unit (u) that is dispatched on day (d) and period (t) and

$${\overline{ϑ}}_{t}^{u , d}$$

represents the minimum required fraction of generation unit (u) that must be dispatched on day (d) and period (t); minimum dispatchable fraction may be set prior to ensure the optimum solution satisfies the minimum generation requirements for the stability and security of the network.

In some examples of this formula, no feasible solution may exist when the minimum dispatchable generation requirements are combined with uncontrolled on-premises generation. Infeasibility may indicate a need to curtail a portion of distributed generation to satisfy the minimum dispatchable generation requirements.

Network capacity constraints may be similar to those of the first, second, and third exemplary frameworks. In such an example, the network capacity constraints may be grid-edge or non-grid-edge. Grid-edge network capacity constraints may represent the operating capacities of the network lines and equipment for delivering (i.e., delivered) and receiving power to/from end users located at the edge of the network. Non-grid-edge constraints may represent the operating capacities of the network lines and equipment for flowing power between network nodes. Together these constraints may ensure the physical feasibility of the optimal solution.

The grid-edge network capacity constraints may be represented as:

$${\sum }_{e = 1}^{E ∈ n} {Delivered}_{t}^{n , e , d} \leq {DeliveredCapacity}_{t}^{n , d} , ∀ n ∈ Grid Edge$$

$${\sum }_{e = 1}^{E ∈ n} \vert {Received}_{t}^{n , e , d} \vert \geq {ReceivedCapacity}_{t}^{n , d} , ∀ n ∈ Grid Edge$$

$${Op eratingCapacity}_{t}^{n , d} = {DeliverCapacity}_{t}^{n , d ,} + {ReceiveCapacity}_{t}^{n , d} , ∀ n ∈ Grid Edge$$

As used in this representation,

$${DeliveredCapacity}_{t}^{n , d}$$

represents the physical capacity for delivered power to all end users located on network node (n) on day (d) and period (t). The values for these time series will be non-negative. These constraints apply for all (∀) nodes (n) on network (N) that are located at the edge of the delivery network. Additionally, E∈n represents the list of end users (E) that are directly served by network node (e);

$${Delivered}_{t}^{n , e , d}$$

is total power delivered from network node (n) to end user (e) on day (d) and period (t);

$${ReceivedCapacity}_{t}^{n , d}$$

represents the physical capacity for received power from all end users located on network node (n) on day (d) and period (t). The values for these time series will be non-positive. These constraints apply for all (∀) nodes (n) on network (N) that are located at the edge of the delivery network.

$${Received}_{t}^{n , e , d}$$

is the total power received by network node (n) from end user (e) on day (d) and period (t); convention is for received flows to be negative which is why the sum is over the absolute values of the received flows. Lastly,

$${OperatingCapacity}_{t}^{n , d}$$

is the total capacity for power flow through network node (n) on day (d) and period (t).

The non-grid-edge network capacity constraints may be represented as:

$${DeliveredCapacity}_{t}^{n , d} \geq {\sum }_{j = 1}^{J ∈ n} {Delivered}_{t}^{n , j , d} , ∀ n ∈ N$$

$${ReceivedCapacity}_{t}^{n , d} \leq {\sum }_{j = 1}^{J ∈ n} \vert {Received}_{t}^{n , j , d} \vert , ∀ n ∈ N$$

$${OperatingCapacity}_{t}^{n , d} = {DeliverCapacity}_{t}^{n , d ,} + {ReceiveCapacity}_{t}^{n , d} , ∀ n ∈ N$$

As used in this representation,

$${DeliveredCapacity}_{t}^{n , d}$$

represents the physical capacity for flowing power to downstream nodes (j) that are directly connected to network node (n) on day (d) and period (t). The values for these time series will be non-negative. These constraints apply for all (∀) nodes (n) on network (N).

$${Delivered}_{t}^{n , j , d}$$

is total power delivered from network node (n) to downstream network node (j) that is directly connected to network node (n) on day (d) and period (t).

$${ReceivedCapacity}_{t}^{n , d}$$

represents the physical capacity for receiving power flowing from either downstream or upstream network nodes (j) that are directly connected to network node (n) on day (d) and period (t). The values for these time series will be non-positive. These constraints apply for all (∀) nodes (n) on network (N).

$${Received}_{t}^{n , j , d}$$

is the total power received by network node (n) upstream and downstream network nodes (j) that are directly connected to network node (n) on day (d) and period (t); convention is for received flows to be negative which is why the sum is over the absolute values of the received flows. Lastly,

$${OperatingCapacity}_{t}^{n , d}$$

is total capacity for power flow through network node (n) on day (d) and period (t).

Network storage system constraints may also be similar to the second and third exemplary frameworks. They may similarly be used to represent imposed operating restrictions on how ESS units are charged and discharged. The charging and discharging activity may be determined by solving objective function subject to discharge constraints. In some examples of this second framework, the network storage system constraints may be represented as ESS capacity constraints and ESS charging constraints.

With respect to ESS capacity constraints, they may tie current energy stored to the prior period storage plus current period charging and discharging activity. In these constraints, charging activity may be treated as a demand for power from the network. Charging efficiency factors may be used to model energy losses as part of the charging process. In contrast, discharging activity may be treated as a supply of power to the network. The amount of energy discharged may be removed from the ESS. Discharge losses may be accounted for in the Energy Balance Constraints presented above. A separate set of constraints may be defined for each ESS (s) and day (d) and period in the decision horizon (D). An exemplary representation of these constraints may be:

$$ESSEn {ergy}_{t}^{s , d} = ESSn {ergy}_{t - 1}^{s , d} + ( {ρ}^{s} {ESSCharge}_{t}^{s , d} ) - {ESSDischarge}_{t}^{s , d}$$

Lower and upper bounds on the State of Charge (SOC) for each ESS (s) for each day (d) and period (t) may also be imposed by further constraints. These SOC bounds may be externally supplied operating constraints. These may be represented as:

$$ESSEn {ergy}_{t}^{s , d} \leq ESSM {axSOC}^{s , D} ESSCapa {city}^{s , d}$$

$$ESSEn {ergy}_{t}^{s , d} \geq ESSM {inSOC}^{s , D} ESSCapa {city}^{s , d}$$

With respect to ESS charging constraints, they may be represented by equations which place operating constraints on charging activity. A first set of constraints may be used to ensure that charging will always be non-negative. A second set of constraints may be used to ensure that charging activity in any period does not exceed the physical charging limits of the ESS. Hence, in this exemplary second framework, there may be be two sets of constraints for each ESS (s) for each day (d) and period (t). These constraints may be represented as:

$${ESSCharge}_{t}^{s , d} \geq 0$$

$${ESSCharge}_{t}^{s , d} \leq {ESSChargeCap}^{s , D}$$

ESS charging constraints may also include ESS discharge constraints, which may be represented by a set of equations used to place operating constraints on discharging activity. A first set of discharge constraints may be used to ensure that discharging will always be non-negative. A second set of discharge constraints may be used to ensure that discharging activity in any period does not exceed the physical discharge limits of the ESS. Thus, there may be two sets of constraints for each ESS (b) for each day (d) and period (t) in the decision horizon (D). These constraints may be represented as:

$${ESSDischarge}_{t}^{s , d} \geq 0$$

$${ESSDischarge}_{t}^{s , d} \leq {ESSDischargeCap}^{s , D}$$

With respect to the exemplary network storage system constraint formulae presented above,

$$ESSEn {ergy}_{t}^{s , d}$$

is the total energy (MWh) stored in ESS (s) on day (d) and period (t); the prior period is indexed by (t−1); ESSCapacity^{s,D} is the energy capacity (MWh) of ESS (s) in the decision horizon (D); ESSMaxSOC^{s,D} is the targeted maximum SOC for ESS (s) in the decision horizon (D); ESSMinSOC^{s,D} is the targeted minimum SOC for ESS (s) in the decision horizon (D);

$${ESSCharge}_{t}^{s , d}$$

is the total gross charge (kW per period) of ESS (s) on day (d) and period (t); ESSChargeCaps^{s,D} is the charging capacity (kW per period) of ESS (s) in decision horizon (D); δ^{s} is the fraction of gross charge that is stored in ESS (s); 0≤δ^{s}≤1;

$${ESSDischarge}_{t}^{s , d}$$

is the discharge (kWh per period) from ESS (s) on day (d) and period (t); and ESSDischargeCap^{s,D} is the discharge capacity (kW per period) from ESS (s) in decision horizon (D).

### Example PNO Framework 5

A fifth exemplary framework may be similar to the first, second, third, and fourth frameworks, with the addition of a dynamic operating envelope (DOE) to minimize the overall cost of operating the network while ensuring that distribution transformers stay within voltage and current operating limits. This may include providing market incentives and directions. The DOEs may also be used to reduce on-premises generation activity during Minimum Demand conditions and reduce demand for electricity services during High Demand conditions. This framework may be referred to as a dynamic operating envelopes managed net load framework. Similar to the first, second, third, and fourth frameworks, the fifth framework may comprise an objective function and constraints. In some examples, the fifth framework may further comprise a technique for calculating one or more DOEs.

Under this framework, PNOs may take as given at least: (1) forecasts of aggregate net demand for power by network node (e.g., transformer/phase, feeder/phase, substation, transmission zone); (2) grid-connected generation supply curve; (3) operating characteristics of ESS that are used for energy arbitrage across time periods (4) low voltage network capacity constraints; (5) minimum demand requirements for maintaining the operating security of the low voltage network; (6) the portion of distributed generation that is under PNO direct control; and (7) the list of control end user appliances and end-use equipment that is under PNO direct control. However, the portions of distributed generation under PNO direct control and the portion of end-use load under PNO control may differ from the other exemplary frameworks due to indirect control corresponding to DOEs. The compliance with the DOE cannot, in some examples, be taken as a given. In other examples, it may be assumed to be at a certain level. This compliance level may be full compliance, partial compliance, or dependent upon a constraint.

With the addition of DOEs, the fifth exemplary framework may be considered to be extended to allow a PNO to expand their DER asset control from direct control via dispatchable actions targeted toward participating end user DER assets to indirect control via dispatchable DOEs. This may comprise, in some examples, the entirety of the control. In other examples, the PNO may maintain some level of direct control as well. This may be based at least in part on, by way of example and not limitation, a hierarchy, a situation, a tier, an opt-in, an opt-out, regulation, or other similar alternatives. The additions of DOEs also may be considered to simplify the need to separate end user generation and load, as the upper and lower bounds of a DOE may be considered to encompass both forms of network activity.

These DOE controls may, in some examples, only be or primarily be extended to end users or service sites which have agreed to participate (market participants). In some examples, direct control and DOE control may be associated, such that a market participant opts-in to both. In other examples, the two may be separated. In yet other examples, only a portion of each of DOE and/or direct control may be available for various subsets of end users. Market participants may also be defined by an opt-out system, a regulatory system, technical or physical feasibility, or a variety of other such determinations. By way of example and without limitation, for the purposes of this exemplary framework, market participants shall be assumed to be participating in both DOE and direct control, though not necessarily in equal portions.

An exemplary objective function, which incorporates DOEs, may be described as:

$$\frac{Minimize}{{ϑ}_{t}^{u , d} , {ϑ}_{t}^{s , d} , {ϑ}_{t}^{n , d} , {ϑ}_{t}^{n , c , d} , {ϑ}_{t}^{n , ∅ , MinCap , d} , {ϑ}_{t}^{n , ∅ , MaxCap , d}} {\sum }_{d = 1}^{D} {\sum }_{t = 1}^{T} {\sum }_{u = 1}^{U} {\sum }_{n = 1}^{N} {LMP}_{t}^{nd} ( {ϑ}_{t}^{u , d} {ρ}_{t}^{n , u , d} {GridGen}_{t}^{u , d} ) + {\sum }_{d = 1}^{D} {\sum }_{t = 1}^{T} {\sum }_{s = 1}^{S} {\sum }_{n = 1}^{N} {LMP}_{t}^{n , d} ( {ϑ}_{t}^{s , d} {ρ}_{t}^{n , s , d} {ESSDischarge}_{t}^{s , d} ) - {\sum }_{d = 1}^{D} {\sum }_{t = 1}^{T} {\sum }_{n = 1}^{N} {\sum }_{e = 1}^{E ∈ P} {GENOPP}_{t}^{n , d} ( ( 1 - {ϑ}_{t}^{n , d} ) {GEN}_{t}^{n , e , d} ) - {\sum }_{d = 1}^{D} {\sum }_{t = 1}^{T} {\sum }_{n = 1}^{N} {\sum }_{c = 1}^{C} {\sum }_{e = 1}^{E ∈ c} LoadCon {rolOPP}_{t}^{n , c , d} [ ( 1 - {ϑ}_{t}^{n , c , d} ) {Load}_{t}^{n , c , e , d} ] + {\sum }_{d = 1}^{D} {\sum }_{t = 1}^{T} {\sum }_{n = 1}^{N} {\sum }_{∅ = 1}^{Q} {DOEOPP}_{t}^{n , d} [ ( {ϑ}_{t}^{n , ∅ , MinCap , d} {MinCap}^{n , ∅} ) - {\sum }_{e = 1}^{E} {NetLoad}_{t}^{n , ∅ , e , d} ] - {\sum }_{d = 1}^{D} {\sum }_{t = 1}^{T} {\sum }_{n = 1}^{N} {\sum }_{∅ = 1}^{Q} {DOEOPP}_{t}^{n , d} [ ( {ϑ}_{t}^{n , ∅ , MaxCap , d} {MaxCap}^{n , ∅} ) - {\sum }_{e = 1}^{E} {NetLoad}_{t}^{n , ∅ , e , d} ]$$

The objective of this exemplary function according to the fifth framework is to minimize the total cost of electricity services. The exemplary objective function as shown above has six components. The first is the total cost of electricity dispatched from the fleet of grid-connected generation units. The second cost is the total cost of energy discharged to the network from the fleet of dispatchable ESS units. The third is the opportunity cost to market participants for allowing their generation to be reduced. This third component is used to raise the overall cost of electricity services. This incentivizes the objective function to dispatch as little of distributed generation control as possible while adhering to the physical constraints of the network. The fourth is the opportunity cost to market participants for allowing their loads to be reduced. These actions similarly raise the overall cost of electricity services. The fifth is the opportunity cost for market participants operating with Net Loads that fall below their minimum DOE values. The sixth is the opportunity cost for market participants operating with Net Loads that lie above their minimum DOE values.

These six classes of variables to be solved for in this exemplary function are written as

$${ϑ}_{t}^{u , d}$$

representing the fraction of available grid-connected generation for unit (u) that is dispatched on day (d) and period (t);

$${ϑ}_{t}^{s , d}$$

representing the fraction of available dischargeable energy for ESS (s) on day (d) and period (t) that is allowed to be discharged as needed;

$${ϑ}_{t}^{n , d}$$

representing the portion of the expected uncontrollable distributed generation that is allowed to be generated for each market participant located on network node (n) on day (d) and period (t);

$$( {ϑ}_{t}^{n , d} )$$

is the generation opportunity lost due to the DER control activity;

$${ϑ}_{t}^{n , c , d}$$

representing the portion of expected uncontrollable appliance or end-use usage subject to control under load control program (c) active on network node (n) on day (d) and period (t), where (1−

$${ϑ}_{t}^{n , c , d} )$$

is the opportunity electricity services lost due to the load control activity (c);

$${ϑ}_{t}^{n , ∅ , MinCap , d}$$

representing a scale multiplier on the minimum physical operating capacity of network node (n) and phase (Ø) on day (d) and period (t), where

$$[ ( {ϑ}_{t}^{n , ∅ , MinCap , d} {MinCap}^{n , ∅} ) - {\sum }_{e = 1}^{E} {NetLoad}_{t}^{n , ∅ , e , d} ]$$

is the net power flow in violation of the Minimum DOE; and

$${ϑ}_{t}^{n , ∅ , MaxCap , d}$$

representing a scale multiplier on the maximum physical operating capacity of network node (n) and phase (Ø) on day (d) and period (t), where

$$[ ( {ϑ}_{t}^{n , ∅ , MaxCap , d} {MaxCap}^{n , ∅} ) - {\sum }_{e = 1}^{E} {NetLoad}_{t}^{n , ∅ , e , d} ]$$

is the net power flow in violation of the Maximum DOE.

This objective function, as part of the fifth exemplary framework, may indicate that the network operator can dispatch grid-connected generation, ESS, market participating non-grid connected generation, and market participating load control programs, and market participating DOEs in a way that reduces the cost of electricity services to all end users, both market and non-market participants.

In the exemplary function as shown above,

$${LMP}_{t}^{n , d}$$

is the locational marginal price ($/kWh) for power delivered to end users connected to network node (n) on day (d) and period (t);

$${ρ}_{t}^{n , u , d}$$

adjusts for generation unit (u) Transmission & Distribution losses associated with delivering power to network node (n) on day (d) and period (t);

$${GridGen}_{t}^{u , d}$$

is the available dispatchable generation for grid-connected generation unit (u) on day (d) and period (t);

$${ESSDischarge}_{t}^{s , d}$$

is the available dischargeable energy for ESS (s) on day (d) and period (t);

$${ρ}_{t}^{n , s , d}$$

adjusts for ESS (s) losses associated with discharging power to the network node (n) on day (d) and period (t);

$${GEN}_{t}^{n , e , d}$$

is the expected or forecasted uncontrollable distributed generation for market participant (e) located on network node (n) on day (d) and period (t);

$${GENOPP}_{t}^{n , d}$$

is the marginal value ($/kWh) market participants assign to forgoing a unit of distributed generation located on network node (n) on day (d) and period (t);

$${Load}_{t}^{n , c , e , d}$$

is end user (e) located on network node (n) expected uncontrolled appliance or end-use equipment power usage that is part of Load Control program (c) on day (d) and period (t);

$$LoadContro {lOPP}_{t}^{n , c , d}$$

is the marginal value ($/kWh) market participants assign to forgoing a unit of usage of appliance or end-use equipment that is under control by Load Control program (c);

$${DOEOPP}_{t}^{n , d}$$

is the marginal cost ($/kWh) market participants assign to violating their DOE minimum and/or maximum Net Load limits; D represents the number of days in the decision horizon; days within the decision horizon are indexed by (d); T represents the total number of time periods in a day (e.g., 288 five-minute intervals, 96 15-minute intervals, 48 30-minute time intervals, and 24 60-minute time intervals), where periods within a day in the decision horizon are indexed by (t); E∈P represents the list of end users (E) that agree to participate in the DER control market program; U represents the total number of grid-connected generation units, where individual generation units are indexed by (u); N represents the number of network connection points or nodes, where individual network nodes are indexed by (n); Q represents the number of phases for network node (n), where individual phases are indexed by ((Ø); E represents the total number of end users located on network node (n), where individual end users are indexed by (e); and C represents the list of active network operator dispatchable Load Control programs, where individual load control programs are indexed by (c).

The objective function may be subject to a number of constraints in this fifth framework to ensure an operationally feasible least cost dispatch solution. Examples of such constraints include energy balance constraints (net grid load and net grid supply), generation dispatch constraints, network capacity constraints (grid-edge and non-grid-edge), and network storage system constraints (ESS capacity and ESS charging).

Energy balance constraints may ensure net grid supply of power exactly offsets the net demand for power for each day (d) and period (t) in the decision horizon (D). The Energy Balance Constraint may be expressed from the perspective of the Network Operator as:

$${NetLoad}_{t}^{N , d} = {NetGridSupply}_{t}^{N , d}$$

In this example, the net load

$${NetLoad}_{t}^{N , d}$$

is a forecast of total delivered power less total received power from all end users served by the network (N) on day (d) and period (t). With grid-connected Energy Storage Systems (ESS) the net load may be augmented by the amount of power that is added to the ESS units via charging activity. To model DER control programs, end users may be segmented between those that have agreed to participate in the DER control program (indexed by P and p) versus end users that have not agreed to participate (indexed by NP and np). Given this segmentation, the elements that make up Net Load for power may be defined as three sets of equations. The first set of equations, which may indicate non-market participant delivered and received power, may be represented as:

$${NP\_Delivered}_{t}^{n ,} = IF [ ( {Load}_{t}^{n , e ∈ NP , d} - {GEN}_{t}^{n , e ∈ NP , d} ) \geq 0 ]$$

$${NP\_Received}_{t}^{n , e ∈ N P , d} = IF [ ( {Load}_{t}^{n , e ∈ NP , d} - {GEN}_{t}^{n , e ∈ NP , d} ) \leq 0 ]$$

The second set of equations, which may indicate market participant delivered and received power, may be represented as:

$${P\_Delivered}_{t}^{n , e ∈ P , d} = IF [ ( {Load}_{t}^{n , e ∈ P , d} - {ϑ}_{t}^{n , c , d} {Load}_{t}^{n , c , e ∈ c , d} - {ϑ}_{t}^{n , d} {GEN}_{t}^{n , e ∈ P , d} ) \geq 0 ]$$

$${P\_Received}_{t}^{n ,} = IF [ ( {Load}_{t}^{n , e ∈ P , d} - {ϑ}_{t}^{n , c , d} {Load}_{t}^{n , c , e ∈ c , d} - {ϑ}_{t}^{n , d} {GEN}_{t}^{n , e ∈ P , d} ) \leq 0 ]$$

Hence, the total net load (third set) may be represented as:

$${NetLoad}_{t}^{N , d} = {\sum }_{n = 1}^{N} {\sum }_{e = 1}^{E ∈ n} ( {NP\_Delivered}_{t}^{n , e ∈ NP , d} + {P\_Delivered}_{t}^{n , e ∈ P , d} ) + {\sum }_{n = 1}^{N} {\sum }_{e = 1}^{E ∈ n} ( {NP\_Received}_{t}^{n , e ∈ NP , d} + {P\_Received}_{t}^{n , e ∈ P , d} ) + {\sum }_{s = 1}^{S} ESSCh {arge}_{t}^{s , d}$$

With respect to these Net Load constraints as described in this example,

$${ESSCharge}_{t}^{s , d}$$

is the amount of gross energy that could be added to ESS (s) on day (d) and period (t);

$${Load}_{t}^{n , e , d}$$

is the demand for electricity regardless of how it is sourced for end user (e) served by network node (n) on day (d) and period (t);

$${DER}_{t}^{n , e , d}$$

represents on-premises generation that is used to offset on-premises demand for electricity for end user (e) on day (d) and period (t);

$${NP\_Delivered}_{t}^{n , e ∈ NP , d}$$

is the additional power required to be pulled in from the network node (n) to meet non-market participant (NP) end user (e) power requirements on day (d) and period (t);

$${NP\_Received}_{t}^{n , e ∈ NP , d}$$

is excess power pushed onto the network at node (n) from non-market participant (NP) end user (e) on day (d) and period (t);

$${P\_Delivered}_{t}^{n , e ∈ P , d}$$

is the additional power required to be pulled in from the network node (n) to meet market participant (P) end user (e) power requirements on day (d) and period (t), where the power required is adjusted by end user participation in load control activity

$$( {ϑ}_{t}^{n , c , d} {Load}_{t}^{n , c , e ∈ c , d} ) ; {P\_Received}_{t}^{n , e ∈ P , d}$$

is excess power pushed onto the network at node (n) from market participant (P) end user (e) on day (d) and period (t), where the power received is adjusted by end user participation in load control activity

$$( {ϑ}_{t}^{n , c , d} {Load}_{t}^{n , c , e ∈ c , d} ) ; {ϑ}_{t}^{n , d}$$

is the portion of the expected distributed generation that is allowed to be generated for each market participant (P) located on network node (n) on day (d) and period (t); and

$${ϑ}_{t}^{n , c , d}$$

is the portion of uncontrolled appliance or equipment power requirements that are reduced due to load control activity for program (c) active on network node (n) on day (d) and period (t).

The net grid-connected supply component of the Energy Balance Constraint may be similar to the third and fourth exemplary framework. In this example of the Energy Balance Constraint, the net grid-connected supply may be defined as the sum of grid-connected generation adjusted for Transmission and Distribution losses plus net (i.e., gross discharge less discharge losses) discharged power from grid-connected Energy Storage. This may be represented as:

$${NetGridSupply}_{t}^{N , d} = {\sum }_{n - 1}^{N} \{ {\sum }_{u}^{U} {ϑ}_{t}^{u , d} {ρ}_{t}^{n , u , d} {GridGen}_{t}^{u , d} + {\sum }_{s = 1}^{s} {ϑ}_{t}^{n , s , d} ( {ρ}_{t}^{n , s , d} {ESSDischarge}_{t}^{s , d} ) \}$$

With respect to the exemplary Net Grid Supply constraint equation,

$${ϑ}_{t}^{u , d}$$

is the fraction of available grid-connected generation for unit (u) that is dispatched on day (d) and period (t);

$${ρ}_{t}^{n , u , d}$$

adjusts for generation unit (u) Transmission & Distribution losses associated with delivering power to network node (n) on day (d) and period (t);

$${GridGen}_{t}^{u , d}$$

is the available dispatchable generation for grid-connected generation unit (u) on day (d) and period (t);

$$E {SSDischarge}_{t}^{s , d}$$

is the dischargeable energy stored in ESS (s) on day (d) and period (t);

$${ρ}_{t}^{n , s , d}$$

is the fraction of discharged energy that is delivered to the network node (n) from ESS (s) on day (d) and period (t); and

$${ϑ}_{t}^{s , d}$$

is the fraction of available dischargeable energy for ESS (s) on day (d) and period (t) that is allowed to be discharged as needed.

Generation dispatch constraints impose operating minimum and maximum values for each grid-connection generation resource. These constraints may impose dispatchable generation limits for each generation resource. These constraints may be similar to those in the first, second, third, and fourth exemplary frameworks. These constraints may be represented as:

$${ϑ}_{t}^{u , d} \leq 1.$$

$${\overline{ϑ}}_{t}^{u , d} \leq {ϑ}_{t}^{u , d}$$

As used in this representation,

$${ϑ}_{t}^{u , d}$$

is the fraction of available grid-connected generation for unit (u) that is dispatched on day (d) and period (t) and

$${\overline{ϑ}}_{t}^{u , d}$$

represents the minimum required fraction of generation unit (u) that must be dispatched on day (d) and period (t); minimum dispatchable fraction may be set prior to ensure the optimum solution satisfies the minimum generation requirements for the stability and security of the network.

In some examples of this formula, no feasible solution may exist when the minimum dispatchable generation requirements are combined with uncontrolled on-premises generation. Infeasibility may indicate a need to curtail a portion of distributed generation to satisfy the minimum dispatchable generation requirements.

Network capacity constraints may be similar to those of the first, second, third, and fourth exemplary frameworks. In such an example, the network capacity constraints may be grid-edge or non-grid-edge. Grid-edge network capacity constraints may represent the operating capacities of the network lines and equipment for delivering (i.e., delivered) and receiving power to/from end users located at the edge of the network. Non-grid-edge constraints may represent the operating capacities of the network lines and equipment for flowing power between network nodes. Together these constraints may ensure the physical feasibility of the optimal solution.

The grid-edge network capacity constraints may be represented as:

$${\sum }_{e = 1}^{E ∈ n} {Delivered}_{t}^{n , e , d} \leq {DeliveredCapacity}_{t}^{n , d} , ∀ n ∈ Grid Edge$$

$${\sum }_{e = 1}^{E ∈ n} \vert {Received}_{t}^{n , e , d} \vert \geq {ReceivedCapacity}_{t}^{n , d} , ∀ n ∈ Grid Edge$$

$${Op eratingCapacity}_{t}^{n , d} = {DeliverCapacity}_{t}^{n , d ,} + {ReceiveCapacity}_{t}^{n , d} , ∀ n ∈ Grid Edge$$

As used in this representation,

$${DeliveredCapacity}_{t}^{n , d}$$

represents the physical capacity for delivered power to all end users located on network node (n) on day (d) and period (t). The values for these time series will be non-negative. These constraints apply for all (∀) nodes (n) on network (N) that are located at the edge of the delivery network. Additionally, E∈n represents the list of end users (E) that are directly served by network node (e);

$${Delivered}_{t}^{n , e , d}$$

is total power delivered from network node (n) to end user (e) on day (d) and period (t);

$$R e c e i ν e d C a p a c i t {y}_{t}^{n , d}$$

represents the physical capacity for received power from all end users located on network node (n) on day (d) and period (t). The values for these time series will be non-positive. These constraints apply for all (∀) nodes (n) on network (N) that are located at the edge of the delivery network.

$${Received}_{t}^{n , e , d}$$

is the total power received by network node (n) from end user (e) on day (d) and period (t); convention is for received flows to be negative which is why the sum is over the absolute values of the received flows. Lastly,

$${OperatingCapacity}_{t}^{n , d}$$

is the total capacity for power flow through network node (n) on day (d) and period (t).

The non-grid-edge network capacity constraints may be represented as:

$${DeliveredCapacity}_{t}^{n , d} \geq {\sum }_{j = 1}^{J ∈ n} {Delivered}_{t}^{n , j , d} , ∀ n ∈ N$$

$${ReceivedCapacity}_{t}^{n , d} \leq {\sum }_{j = 1}^{J ∈ n} \vert {Received}_{t}^{n , j , d} \vert , ∀ n ∈ N$$

$${OperatingCapacity}_{t}^{n , d} = Deli v e r e d C a p a c i t {y}_{t}^{n , d ,} + R e c e ivedCapacit {y}_{t}^{n , d} , ∀ n ∈ N$$

As used in this representation,

$$D eliveredCapacit {y}_{t}^{n , d}$$

represents the physical capacity for flowing power to downstream nodes (j) that are directly connected to network node (n) on day (d) and period (t). The values for these time series will be non-negative. These constraints apply for all (∀) nodes (n) on network (N).

$${Delivered}_{t}^{n , j , d}$$

is total power delivered from network node (n) to downstream network node (j) that is directly connected to network node (n) on day (d) and period (t).

$${ReceivedCapacity}_{t}^{n , d}$$

represents the physical capacity for receiving power flowing from either downstream or upstream network nodes (j) that are directly connected to network node (n) on day (d) and period (t). The values for these time series will be non-positive. These constraints apply for all (∀) nodes (n) on network (N).

$${Received}_{t}^{n , j , d}$$

is the total power received by network node (n) upstream and downstream network nodes (j) that are directly connected to network node (n) on day (d) and period (t); convention is for received flows to be negative which is why the sum is over the absolute values of the received flows. Lastly,

$${OperatingCapacity}_{t}^{n , d}$$

is total capacity for power flow through network node (n) on day (d) and period (t).

Network storage system constraints may also be similar to the second, third, and fourth exemplary frameworks. They may similarly be used to represent imposed operating restrictions on how ESS units are charged and discharged. The charging and discharging activity may be determined by solving objective function subject to discharge constraints. In some examples of this second framework, the network storage system constraints may be represented as ESS capacity constraints and ESS charging constraints.

With respect to ESS capacity constraints, they may tie current energy stored to the prior period storage plus current period charging and discharging activity. In these constraints, charging activity may be treated as a demand for power from the network. Charging efficiency factors may be used to model energy losses as part of the charging process. In contrast, discharging activity may be treated as a supply of power to the network. The amount of energy discharged may be removed from the ESS. Discharge losses may be accounted for in the Energy Balance Constraints presented above. A separate set of constraints may be defined for each ESS (s) and day (d) and period in the decision horizon (D). An exemplary representation of these constraints may be:

$$E S S E n e r g {y}_{t}^{s , d} = E S S n e r g {y}_{t - 1}^{s , d} + ( {ρ}^{s} E S S C h a r g {e}_{t}^{s , d} ) - E S S D i s c h a r g {e}_{t}^{s , d}$$

Lower and upper bounds on the State of Charge (SOC) for each ESS (s) for each day (d) and period (t) may also be imposed by further constraints. These SOC bounds may be externally supplied operating constraints. These may be represented as:

$$E S S E n e r g {y}_{t}^{s , d} \leq ESS Max {SOC}^{s , D} E S S C a p a c i t {y}^{s , d}$$

$$ESSE n e r g {y}_{t}^{s , d} \geq ESS Min {SOC}^{s , D} E S S C a p a c i t {y}^{s , d}$$

With respect to ESS charging constraints, they may be represented by equations which place operating constraints on charging activity. A first set of constraints may be used to ensure that charging will always be non-negative. A second set of constraints may be used to ensure that charging activity in any period does not exceed the physical charging limits of the ESS. Hence, in this exemplary second framework, there may be be two sets of constraints for each ESS (s) for each day (d) and period (t). These constraints may be represented as:

$$E S S C h a r g {e}_{t}^{s , d} \geq 0$$

$$ESSC h a r g {e}_{t}^{s , d} \leq E S S C h a r g e C a {p}^{s , D}$$

ESS charging constraints may also include ESS discharge constraints, which may be represented by a set of equations used to place operating constraints on discharging activity. A first set of discharge constraints may be used to ensure that discharging will always be non-negative. A second set of discharge constraints may be used to ensure that discharging activity in any period does not exceed the physical discharge limits of the ESS. Thus, there may be two sets of constraints for each ESS (b) for each day (d) and period (t) in the decision horizon (D). These constraints may be represented as:

$$E S S D i s c h a r g {e}_{t}^{s , d} \geq 0$$

$$ESSD i s c h a r g {e}_{t}^{s , d} \leq E S S D i s c h a r g e C a {p}^{s , D}$$

With respect to the exemplary network storage system constraint formulae presented above,

$$E S S E n e r g {y}_{t}^{s , d}$$

is the total energy (MWh) stored in ESS (s) on day (d) and period (t); the prior period is indexed by (t−1); ESSCapacity^{s,D} is the energy capacity (MWh) of ESS (s) in the decision horizon (D); ESSMaxSOC^{s,D} is the targeted maximum SOC for ESS (s) in the decision horizon (D); ESSMinSOC^{s,D} is the targeted minimum SOC for ESS (s) in the decision horizon (D);

$${ESSCharge}_{t}^{s , d}$$

is the total gross charge (kW per period) of ESS (s) on day (d) and period (t); ESSChargeCaps^{s,D} is the charging capacity (kW per period) of ESS (s) in decision horizon (D); δ^{s} is the fraction of gross charge that is stored in ESS (s); 0≤d≤δ^{s}≤1;

$${ESSDischarge}_{t}^{s , d}$$

is the discharge (kWh per period) from ESS (s) on day (d) and period (t); and ESSDischargeCap^{s,D} is the discharge capacity (kW per period) from ESS (s) in decision horizon (D).

The fifth exemplary framework may also include functions for calculating DOEs. DOEs may establish energy and capacity limits within which end users that are participating (i.e., Market Participants or Participants) in wholesale energy and capacity markets can operate without network operator intervention. Aggregate DOEs may be defined as the difference between the operating capacity of the low voltage network to deliver and ingest energy and the aggregated forecast of delivered and received power for the bundle of non-market participants. The level of geospatial detail at which DOEs are defined may depend on the market rules used to govern market participation in trading of power and capacity. By way of example and not limitation, DOEs may be defined at the level of a delivery transformer and phase. In such examples, an aggregate DOE may be defined as the difference between the operating capacity of a transformer and phase and the forecasted net load of the non-market participants (i.e., non-market participating end users) that are connected to the transformer and phase. The computation of DOEs may proceed systematically.

The first portion of calculating or computing a DOE may involve determining that total delivered and received power flowing through a distribution transformer cannot exceed the transformer's minimum and maximum power limits. This may be represented as:

$${Min\_Power}_{t}^{n , ∅ , d} \leq {\sum }_{np = 1}^{NP} {Load}_{t}^{n , ∅ , np , d} + {\sum }_{p = 1}^{P} {Load}_{t}^{n , ∅ , p , d} - {\sum }_{np = 1}^{NP} {Gen}_{t}^{n , ∅ , np , d} - {\sum }_{p = 1}^{P} {Gen}_{t}^{n , ∅ , p , d} \leq {Max\_Power}_{t}^{n , ∅ , d}$$

In this example and without limitation, the limits on distribution transformer node (n) power flow are limits on total power flow as defined as the sum of power flow from network nodes upstream from the distribution transformer node (n) plus net reverse power flow from all end users served by network node (n). Reverse power flow may occur when on-premises generation exceeds consumption. In this example equation as shown above,

$${Min\_Power}_{t}^{n , ∅ , d}$$

is the minimum power flow required on day (d) and period (t) to stay within network node (n) and phase (θ) voltage and current ratings;

$${Max\_Power}_{t}^{n , ∅ , d}$$

is the maximum power flow required on day (d) and period (t) to stay within network node (n) and phase (θ) voltage and current ratings;

$${Load}_{t}^{n , ∅ , np , d}$$

is the total power consumption for non-market participant (np) served by network node (n) phase (θ) on day (d) and period (t);

$${Load}_{t}^{n , ∅ , p , d}$$

is the total power consumption for market participant (p) served by network node (n) phase (θ) on day (d) and period (t);

$${Gen}_{t}^{n , ∅ , np , d}$$

is the total on-premises power produced for non-market participant (np) served by network node (n) phase (θ) on day (d) and period (t);

$${Gen}_{t}^{n , ∅ , p , d}$$

is the total on-premises power produced for market participant (p) served by network node (n) phase (θ) on day (d) and period (t); NP is the total number of non-market participant end users indexed by (np) that are served by network node (n) phase (θ) on day (d) and period (t); P is the total number of market participant end users indexed by (p) that are served by network node (n) phase (θ) on day (d) and period (t); and NP+P is the total number of end users that are served by network node (n) phase (θ) on day (d) and period (t).

In some examples, non-market participant behavior can be taken as a given and their power consumption and generation can be subtracted from both sides of the above expression as follows:

$${Min\_Power}_{t}^{n , ∅ , d} + [ {\sum }_{np = 1}^{NP} {Gen}_{t}^{n , ∅ , np , d} - {\sum }_{np = 1}^{NP} {Load}_{t}^{n , ∅ , np , d} ] \leq {\sum }_{p = 1}^{P} {Load}_{t}^{n , ∅ , p , d} - {\sum }_{p = 1}^{P} {Gen}_{t}^{n , ∅ , p , d} \leq {Max}_{Powe {r}_{t}}^{n , ∅ , d} + [ {\sum }_{np = 1}^{NP} {Gen}_{t}^{n , ∅ , np , d} - {\sum }_{np = 1}^{NP} {Load}_{t}^{n , ∅ , np , d} ]$$

The two ends of this expression may be converted to indicate another definition of Aggregate Dynamic Operating Envelopes (DOEs) that the group of market participants (P) that are served by network node (n) and phase (θ) must operate within to avoid market applied penalties as follows:

$$Min\_Aggregate {\_DOE}_{t}^{n , ∅ , d} \leq {\sum }_{p = 1}^{P} {Load}_{t}^{n , ∅ , p , d} - {\sum }_{p = 1}^{P} {Gen}_{t}^{n , ∅ , p , d} \leq Max\_Aggregate {\_DOE}_{t}^{n , ∅ , d}$$

In this exemplary expression, the aggregate minimum and maximum DOEs vary with respect to the net load activity of the non-market participants. For these expressions as written,

$$Min\_Aggregate {\_DOE}_{t}^{n , ∅ , d}$$

is the minimum flow of power that the sum of the net loads of all market participants that are served by network node (n) phase (θ) on day (d) and period (t) must operate within; and

$$Max\_Aggregate {\_DOE}_{t}^{n , ∅ , d}$$

is the maximum flow of power that the sum of the net loads of all market participants that are served by network node (n) phase (θ) on day (d) and period (t) must operate within.

The next operation of computing or calculating the DOE, once these aggregate Minimum and Maximum DOE limits are established, may involve allocating the aggregate DOE limits across all market participants that are connected to the network node (n) and phase (θ). This may be performed according to a plurality of DOE allocation schemes. In some examples, only one scheme is used, while in other examples multiple schemes may be used in sequence, in parallel, upon subsets, or other approaches. The schemes and their application may be chosen based on, by way of example and not limitation, prevailing market rules. Three exemplary schemes, corresponding to market participant number, participating DER assets, and network node distance respectively are discussed below. Other examples include being based at least in part on neighboring service sites and/or grid topology/connectivity information. These schemes are discussed purely for example and not as limitations on DOE allocation schemes.

A first DOE allocation scheme may correspond to allocation proportional to a number of market participants. Under such a scheme, each market participant may be assigned DOE Delivered and Received capacity values in proportion to the number of active market participants that are all served by the same network node (n) and phase (θ). This may be represented as:

$$DOE\_Min {\_NetLoad}_{t}^{n , ∅ , d , p} = Min\_Aggregate {\_DOE}_{t}^{n , ∅ , d} \times \frac{1}{{P}_{t}^{n , ∅ , d}} , ∀ p ∈ {P}_{t}^{n , ∅ , d}$$

$$DOE\_Max {\_NetLoad}_{t}^{n , ∅ , d , p} = Max\_Aggregate {\_DOE}_{t}^{n , ∅ , d} \times \frac{1}{{P}_{t}^{n , ∅ , d}} , ∀ p ∈ {P}_{t}^{n , ∅ , d}$$

In these expressions as written,

$$DOE\_Min {\_NetLoad}_{t}^{n , ∅ , d , p}$$

is the DOE allotted minimum Net Load value for market participant (p) served by network node (n) and phase (Ø) on day (d) and period (t);

$$DOE\_Max {\_NetLoad}_{t}^{n , ∅ , d , p}$$

is the DOE allotted maximum Net Load value for market participant (p) served by network node (n) and phase (Ø) on day (d) and period (t); and

$$∀ p ∈ {P}_{t}^{n , ∅ , d}$$

the allocation applies for all (∀) market participants (p) that are served by network node (n) and phase (θ) on day (d) and period (t).

A second DOE allocation scheme may correspond to allocation proportional to participating DER assets. Under such a scheme, each market participant may be assigned DOE values in proportion to the capacity of the DER assets the end user may have bid into the market. This may be represented as:

$$DOE\_Min {\_NetLoad}_{t}^{n , ∅ , d , p} = {Min\_DOE}_{t}^{n , ∅ , d} \times \frac{{DERAssets}_{t}^{n , ∅ , d , e}}{{\sum }_{e = 1}^{E ∈ P} {DERAssets}_{t}^{n , ∅ , d , e}} , ∀ p ∈ {P}_{t}^{n , ∅ , d}$$

$$DOE\_Max {\_NetLoad}_{t}^{n , ∅ , d , p} = {Max\_DOE}_{t}^{n , ∅ , d} \times \frac{{DERAssets}_{t}^{n , ∅ , d , e}}{{\sum }_{e = 1}^{E ∈ P} {DERAssets}_{t}^{n , ∅ , d , e}} , ∀ p ∈ {P}_{t}^{n , ∅ , d}$$

In these expressions as written, in addition to the previously defined terms with respect to the first scheme,

$${DERAssets}_{t}^{n , ∅ , d , e}$$

is the total capacity of DER assets that end user (p) is utilizing to participate in the market. Examples of DER Assets include solar PV generation, direct load control, and price sensitive load control. Different DER assets can be used to participate in the market for Net Load restrictions.

A third DOE allocation scheme may correspond to allocation proportional to a distance from a network node. Under such a scheme, each market participant may be assigned DOE values in proportion to their distance from a network node (n) that may serve them. This may be represented as:

$$DOE\_Min {\_NetLoad}_{t}^{n , ∅ , d , p} = {Min\_DOE}_{t}^{n , ∅ , d} ∝ {Distance}^{n , ∅ , p} , ∀ p ∈ {P}_{t}^{n , ∅ , d}$$

$$DOE\_Max {\_NetLoad}_{t}^{n , ∅ , d , p} = {Max\_DOE}_{t}^{n , ∅ , d} ∝ {Distance}^{n , ∅ , p} , ∀ p ∈ {P}_{t}^{n , ∅ , d}$$

In these expressions as written, in addition to the previously defined terms with respect to the first and second schemes, Distance^{n,Ø,p} is market participant (p) distance from network node (n).

### End User Perspective

Generally, the techniques associated with end user management incorporating a DOE may have similar features to those associated with the PNO perspective. They may typically begin with receiving, at a service site, a DOE defining boundaries associated with electricity services. This DOE may be received from a network manager (which may be the PNO). The DOE may be received from a third party associated with a portion of assets associated with the service site, a neighbor, a third party associated with suggesting approaches to complying with DOEs, or a combination of the PNO and third party. There may be a neutrality or information requirement with respect to the entity providing the DOE. The DOE, resultant computations, and/or associated values may be received at a user device, a power meter, a smart appliance, a power control device, a web application, a software application, a mobile device, a third party, a central location, an on-premises device, an off-premises device, etc.

These boundaries may be similar to the various examples of DOE boundaries described with respect to the PNO perspective. These boundaries may be on a first amount of power that the service site puts onto the electricity grid, based at least in part on a permission, and a second amount of power that the service site draws from the electricity grid, also based at least in part on a similar or different permission. This may be during a period of time, or multiple periods of time. The techniques may also include receiving local information. This local information may be associated with local power generation (local power supply), local power storage, and/or local power demand associated with the service site and/or end-use equipment (or other assets) associated with the service site. This local information may be received, monitored, collected, and/or associated with multiple periods of time. The local information may be associated with the end user connected, at a premises, to the electricity grid, with the electricity grid managed by the network manager.

The techniques may also include controlling, based at least in part on the DOE, at least one of local power generation, local power storage, and/or local power demand. This control may be to maintain a power draw (input) from and/or a power put (output) onto the electricity grid. The control and/or the maintenance may be over multiple periods of time and/or occur at multiple times and/or multiple points in time. These multiple times and/or multiple points in time may occur in or be based at least in part on the multiple periods of time. These multiple periods of time may be the multiple periods of time associated with the boundaries, or may be different periods of time. For example, and without limitation, if it is known that from hours 01:00 AM to 04:00 AM the DOE will impose certain very high consumption boundaries, the control during a different period of time (such as 09:00 AM to 10:00 AM) may be to lower consumption because certain activities may have already been performed.

This control may be based at least in part on at least one objective function comprising at least one set of function elements, similar to the PNO perspective. The objective function may be based at least in part on the DOE and a decision horizon. The decision horizon may incorporate multiple periods of time, which may be any of the previously-discussed multiple periods of time. The objective function may include one or more objectives and/or control variables to be solved for. Examples, without limitation, of such objectives and/or elements include a minimum net power services cost, a minimum power generation cost, a minimum power storage cost, a minimum control cost, a minimum participation opportunity cost, a minimum equipment cost, a minimum user input cost, a minimum user need cost, and/or a minimum dynamic operating envelope compliance cost. The DOE may be known to the end user perspective objective function as based at least in part on information from the PNO. This information may be stored energy associated with the network manager of the electricity grid. The objective function may also be constrained by constraints, similar to the objective function(s) associated with the PNO perspective. Various elements and/or parameters of the objective function(s)/associated constraint(s) may be associated with user input, PNO input, regulation, machine-learned output, graphical user interface (GUI) elements or input, retrieved information, forecasts, historic information, etc. These elements (and related costs which may be represented) may be associated with general end user objectives (e.g., cost of not charging a vehicle) that may be user input or input/determined in other ways. Some of these elements may be provided by input of a user, administrator, other application, end user, and/or be determined by a machine-learned model based at least in part on historic information. These costs may be dynamic, static, historic, forecast, etc. The elements may also include inputting one or more forecasts, which may be based at least in part on the DOE and/or objective function solution(s).

The techniques may also include outputting one or more forecasts associated with the service site, which may be based at least in part on the DOE and/or objective function solution(s). These forecasts may indicate, by way of example and without limitation, future network (grid) status, future service point status, service costs, etc. These forecasts may be generated based off of an assumption that the DOE will be complied to either absolutely, or to a certain extent. This assumption may also be based off of constraints and/or the objective functions presented herein as portions of the exemplary frameworks. These forecasts may be based off of applying various inputs, perturbations, experimental parameters, event data, and/or other similar operations to the exemplary frameworks. The forecasts may comprise analyzing outputs of the exemplary frameworks, comparing outputs, visualizing outputs, determining metrics from the outputs, etc. The forecasts may, in some examples, be generated by an ML model trained on features associated with the exemplary frameworks and/or the particular service site/end user.

Some service sites may include an electric vehicle (EV) associated with the service site. The control may involve charging that EV. The techniques may include charging the EV to a variable charge level (which may also be referred to as a dynamic charge level or value), wherein the variable charge level may be determined based at least in part on the DOE. In some examples the variable charge level may be determined by an objective function, which may be the objective function used to determine the control. The variable charge level may further be based at least in part on a minimum acceptable value, which may also serve as an element, control, and/or parameter of the objective function. The minimum acceptable value may be, by way of example and without limitation, a minimum acceptable range, a minimum a customer or end user's minimum acceptable available range, a minimum permitted value, a customer/end user's minimum acceptable range, a minimum acceptable level, a minimum tolerable value, a minimum acceptable operating parameter, a minimum acceptable performance, and/or minimum acceptable variable range. The minimum acceptable range (used as a non-limiting example herein of minimum acceptable value) may, in some examples, be based on user preference and may be expressed in terms of an absolute number of miles, as a percentage of average miles driven per day, etc. In some examples, the minimum acceptable range may indicate or be based at least in part on a value and/or other representation of range anxiety. The range anxiety may comprise an indication of a value that the end user places on having sufficient range at any given time, a customer's tolerance for variance/reliability, a number of specific asset (EV, charging apparatus, etc.) parameters, and/or a factor of safety. The range anxiety, similar to other elements, may be determined in one or more ways (ML models, objective function models, fixed values provided, metric data, etc.), or a combination thereof. The variable charge level may be one singular variable charge level, a range, a distribution, a number of charge levels with various priorities, etc. The variable charge level may be a soft constraint or a hard constraint in various examples, and may be exceeded or not met based at least in part on a cost.

Similar to the range anxiety and minimum acceptable range, other assets and/or goals may be managed according to variable usage levels and/or variable anxieties/ranges. Network operator assets may also be similarly managed according to anxieties/ranges associated with the network operator.

Operations and features of the techniques discussed herein may be performed by computing devices. The computing devices may comprise a system including one or multiple components, some of which may be or may include non-transitory computer readable media which may cause processors to perform operations when executed. The components may, in other examples, be software, computational modules, specifically-developed computational algorithms, or trained machine-learned models. The components may, in other examples, be computing devices, processing units, or processors. By way of example and not limitation, the components may comprise one or more Central Processing Units (CPUs), Graphics Processing Units (GPUs), or any other device or portion of a device that processes electronic data to transform that electronic data into other electronic data that may be stored in registers and/or computer readable media. In some examples, integrated circuits (e.g., ASICs), gate arrays (e.g., FPGAs), and other hardware devices can also be considered processors insofar as they are configured to implement encoded instructions. The components may operate independently, in serial, or in parallel. In other examples, components and/or computing devices may be specifically printed chips optimized to perform the techniques disclosed herein, or logic circuits which perform the techniques herein based on instructions that may be encoded in software, hardware, or a combination of the two. The components and/or computing devices may be associated with access or authorization levels.

Computer readable media associated with the techniques herein may store an operating system and one or more software applications, instructions, programs and/or data to implement the techniques described herein and the functions attributed to the various systems. In various implementations, the computer readable media may be implemented using any suitable computer readable media technology, such as static random-access memory (SRAM), synchronous dynamic RAM (SDRAM), nonvolatile/Flash-type memory, or any other type of computer readable media capable of storing information. The architectures, systems, and individual elements described herein may include many other logical, programmatic, and physical components, of which those discussed herein are merely examples that are related to the discussion of the disclosed techniques. As can be understood, the features discussed herein are described as divided for exemplary purposes. However, the operations performed by the various features may be combined or performed by other features. Control, communication, intra- and inter-framework transmission, and/or received data may be performed digitally, physically, by signal, by sensor, by alarm, by sound, by phone, by mail, by other modalities, and/or any combination thereof.

Suitable computing devices for the operations of features herein may include, by way of example and not limitation, smart utility meters, photovoltaic inverters, home appliance hubs, electric vehicle charging stations, personal computers, mobile devices, etc.

Generally, in addition to the exemplary end user perspective frameworks as discussed herein, many of the considerations and features discussed may additionally apply to the exemplary PNO perspective frameworks, as well as vice versa. The frameworks from each perspective may be, in part or in whole, combined, interoperable, independent, parallel, sequential, dependent, etc.

### Example End User Framework 1

A first exemplary framework using an objective function for end user load management may be defined from the perspective of an individual market participant or end user that has agreed to keep their net loads within the bounds of a DOE assigned to them. This first framework may be based on an assumption that an end user can control a portion of their demand for electricity services. Under this framework, the end user may take as given at least: (1) an assigned DOE that spans the end user decision horizon; (2) a price for grid-supplied power; (3) a baseline or non-controllable power consumption forecast; and (4) a controllable power consumption forecast. The price (2) may be, in some examples, a market price for grid-supplied power. This may be calculated as per the examples previously discussed with respect to the PNO perspective. In some examples, the forecasted values for the non-controllable and controllable power consumption may be derived by the market participant. In other examples they may be derived by the PNO or a third party. In some such examples, the DOE may be based at least in part on the DOEs of neighbouring service sites. This framework may be referred to as a DOE constraint framework.

The objective of the constrained objective function may be to minimize the net cost of electricity services subject to net loads remaining within their assigned dynamic operating envelope. This may be represented as:

$$\frac{Minimize}{{ϑ}_{t}^{n , ∅ , e , a ∈ C , d}} {\sum }_{d = 1}^{D} {\sum }_{t = 1}^{T} {\sum }_{a = 1}^{A} - [ ( {LMP}_{t}^{n , ∅ , d} L o a {d}_{t}^{n , ∅ , e , a ∈ NC , d} ) + ( {LMP}_{t}^{n , ∅ , d} ( 1 - {ϑ}_{t}^{n , ∅ , e , a ∈ C , d} ) {Load}_{t}^{n , ∅ , e , a ∈ C , d} ) ]$$

This representation of the objective function may have an objective to minimize the total cost of electricity services consumed by end user (e), located on Network Node (n) and phase (Ø) on day (d) and period (t). In this representation, the negative sign flips the cost from a positive number to a negative number. As a result, total costs may be minimized when no load control activity is incurred.

In this representation as shown above,

$${LMP}_{t}^{n , ∅ , d}$$

is the locational marginal price (LMP) for end users served by network node (n) and phase (Ø) on day (d) and period (t);

$${Load}_{t}^{n , ∅ , e , a ∈ NC , d}$$

is the total expected power consumed by noncontrollable (NC) end user (e) appliance or end use equipment (a∈NC) on day (d) and period (t) served by network node (n) and phase (Ø);

$${Load}_{t}^{n , ∅ , e , a ∈ C , d}$$

is the total expected power consumed by controllable (C) end user (e) appliance or end use equipment (a∈C) on day (d) and period (t) served by network node (n) and phase (Ø); and

$${ϑ}_{t}^{n , ∅ , e , a ∈ C , d}$$

is the fraction of total expected power consumed by a controllable (C) end user (e) appliance or end use equipment (a∈C) on day (d) and period (t) that is expected to be consumed after load control activity is put in place by the end user.

The objective function may be subject to constraints. In this first framework, one exemplary constraint is the DOE itself. Alternative, non-DOE operating constraints related to the home network, user objectives, regulation, user anxiety, machine-learned model outputs, DOE compliance cost constraints, market energy cost constraints, neighbor energy constraints, or PNO-imposed constraints may also be incorporated. This DOE operating constraint may be represented as:

$$DOE\_Min {\_NetLoad}_{t}^{n , ∅ , e , d} \leq {\sum }_{a = 1}^{A} [ ( {Load}_{t}^{n , ∅ , e , a ∈ NC , d} ) + ( {ϑ}_{t}^{n , ∅ , e , a ∈ C , d} {Load}_{t}^{n , ∅ , e , a ∈ C , d} ) ]$$

$${\sum }_{a = 1}^{A} [ ( {Load}_{t}^{n , ∅ , e , a ∈ NC , d} ) + ( {ϑ}_{t}^{n , ∅ , e , a ∈ C , d} {Load}_{t}^{n , ∅ , e , a ∈ C , d} ) ] \leq DOE\_Max {\_NetLoad}_{t}^{n , ∅ , e , d}$$

In this example, in addition to the terms previously defined,

$$DOE\_Min {\_NetLoad}_{t}^{n , ∅ , e , d}$$

is the end user (e) assigned minimum allowable Net Load on day (d) and period (t); and

$$DOE\_Max {\_NetLoad}_{t}^{n , ∅ , e , d}$$

is the end user (e) assigned maximum allowable Net Load on day (d) and period (t).

### Example End User Framework 2

A second exemplary framework may be similar to the first framework, additionally replacing the hard constraints of the DOE boundaries with softer constraints. This second framework may establish a least cost of electricity services while meeting user needs. While the first framework may require a solution within the boundaries of the DOE, this second framework may determine a solution outside the boundaries of the DOE. This second framework may similarly be based on an assumption that an end user can control a portion of their demand for electricity services. This framework may enable the market participant to decide whether the benefit of operating outside the limits of the DOE is worth the costs of operating outside. This framework may be referred to as a DOE penalties framework.

These softer constraints may, by way of example and not limitation, take the form of financial penalties for any net load energy that is above or below the DOE bounds. Hence, the market participant may be deciding whether the benefit of operating outside the limits of the DOE is worth the financial penalties they will incur. Under this framework, the end user may take as given: (1) an assigned Dynamic Operating Envelope that spans the end user decision horizon; (2) a price for grid-supplied power; (3) a baseline or non-controllable power consumption forecast; (4) a controllable power consumption forecast; and (5) a DOE compliance penalty. The price (2) may be, in some examples, a market price for grid-supplied power. This may be calculated as per the examples previously discussed with respect to the PNO perspective. In some examples, the forecasted values for the non-controllable and controllable power consumption may be derived by the market participant. In other examples they may be derived by the PNO or a third party. In some such examples, the DOE may be based at least in part on the DOEs of neighbouring service sites. The penalties similarly may be static, dynamic, provided by the PNO, provided by a third party, provided by regulation, provided by the end user, etc.

The objective of the constrained objective function may be to minimize the net cost of electricity services subject to net loads remaining within their assigned dynamic operating envelope. This may be represented as:

$$\frac{Minimize}{{ϑ}_{t}^{n , ∅ , e , a ∈ C , d}} {\sum }_{d = 1}^{D} {\sum }_{t = 1}^{T} {\sum }_{a = 1}^{A} - [ ( {LMP}_{t}^{n , ∅ , d} {Load}_{t}^{n , ∅ , e , a ∈ N C , d} ) + ( {LMP}_{t}^{n , ∅ , d} ( 1 - {ϑ}_{t}^{n , ∅ , e , a ∈ C , d} ) {Load}_{t}^{n , ∅ , e , d} ) ] + {\sum }_{d = 1}^{D} {\sum }_{t = 1}^{T} {DOEPenalty}_{t}^{n , ∅ , d} [ DOE\_Min {\_NetLoad}_{t}^{n , ∅ , e , d} - {\sum }_{a = 1}^{A} [ ( {Load}_{t}^{n , ∅ , e , a ∈ N C , d} ) + ( {ϑ}_{t}^{n , ∅ , e , a ∈ C , d} {Load}_{t}^{n , ∅ , e , a ∈ C , d} ) ] ] + {\sum }_{d = 1}^{D} {\sum }_{t = 1}^{T} {DOEPenalty}_{t}^{n , ∅ , d} [ {\sum }_{a = 1}^{A} [ ( {Load}_{t}^{n , ∅ , e , a ∈ NC , d} ) + ( {ϑ}_{t}^{n , ∅ , e , a ∈ C , d} L o a {d}_{t}^{n , ∅ , e , a ∈ C , d} ) ] - DOE\_Max {\_NetLoad}_{t}^{n , ∅ , e , d} ]$$

This representation of the objective function may have an objective to minimize the total cost of electricity services consumed by end user (e), located on Network Node (n) and phase (Ø) on day (d) and period (t). In this representation, the negative sign flips the cost from a positive number to a negative number. As a result, total costs may be minimized when no load control activity is incurred. Additionally, the end user may face market established financial penalties,

$${DOEPenalty}_{t}^{n , ∅ , d} ,$$

for not operating within their assigned DOE bounds. The DOE penalties may form a soft constraint on Net Loads.

In this representation as shown above,

$$L M {P}_{t}^{n , ∅ , d}$$

is the locational marginal price (LMP) for end users served by network node (n) and phase (Ø) on day (d) and period (t);

$${Load}_{t}^{n , ∅ , e , a ∈ NC , d}$$

is the total expected power consumed by noncontrollable (NC) end user (e) appliance or end use equipment (a∈NC) on day (d) and period (t) served by network node (n) and phase (Ø);

$${Load}_{t}^{n , ∅ , e , a ∈ C , d}$$

is the total expected power consumed by controllable (C) end user (e) appliance or end use equipment (a∈C) on day (d) and period (t) served by network node (n) and phase (Ø);

$${ϑ}_{t}^{n , ∅ , e , a ∈ C , d}$$

is the fraction of total expected power consumed by a controllable (C) end user (e) appliance or end use equipment (a∈C) on day (d) and period (t) that is expected to be consumed after load control activity is put in place by the end user;

$$D O E {Penalty}_{t}^{n , ∅ , d}$$

power market established financial penalty for market participants served by network node (n) and phase (Ø) that are operating with Net Loads in violation of the end user assigned DOE bounds on day (d) and period (t);

$$DOE\_Min {\_NetLoad}_{t}^{n , ∅ , e , d}$$

is the end user (e) assigned minimum allowable Net Load on day (d) and period (t);

$$DOE\_Max {\_NetLoad}_{t}^{n , ∅ , e , d}$$

is the end user (e) assigned maximum allowable Net Load on day (d) and period (t).

The objective function may be subject to constraints. However, in some examples of this second framework, the DOE operating constraint may not be directly represented. In such examples, the DOE may be completely replaced with purely voluntary and/or penalty-based constraints already represented by the objective function. In other examples, there may be a mixture, where due to certain conditions, hard control or hard constraints may be implemented for some end users or for some periods of time. Alternative, non-DOE operating constraints related to the home network, user objectives, regulation, penalty cost constraints, user anxiety metric-tied constraints, machine-learned model output-related constraints, market energy cost constraints, neighbor energy constraints, or PNO-imposed constraints may also be incorporated.

### Example End User Framework 3

A third exemplary framework may be similar to the first and second frameworks, additionally introducing distributed generation by the end user. This third framework may establish a least cost of electricity services while meeting user needs. While the first and second frameworks may assume that the end user has control over at least a portion of the demand, this third framework may also incorporate distributed generation such as on-premise generation. This may serve as another asset an end user can utilize to remain in compliance with their assigned DOEs. This third exemplary framework may be similar to the second exemplary framework in that it may consider the DOE boundaries to be soft constraints, at least in part. The third exemplary framework may also, similar to the first framework, consider the DOE boundaries to be hard constraints, at least in part. This framework may be referred to as an on-premises generation DOE framework.

Under this framework, the end user may take as given at least: (1) an assigned Dynamic Operating Envelope that spans the end user decision horizon; (2) a price for grid-supplied power; (3) a baseline or non-controllable power consumption forecast; (4) a controllable power consumption forecast; and (5) a distributed generation forecast.

As before, forecasted values for the non-controllable and controllable power consumption may be derived by the market participant or in other ways. Also, the market participant may have access to a forecast of the distributed generation that they can utilize. This may, by way of example and not limitation, similarly be provided by the end user, the PNO, a third party, or a combination thereof. In some such examples, these may be based at least in part on information, including solutions to corresponding frameworks, associated with neighbouring service sites.

The objective of the constrained objective function may be to minimize the net cost of electricity services subject to net loads remaining within their assigned dynamic operating envelope. This may be represented as:

$$\frac{Minimize}{{ϑ}_{t}^{n , ∅ , e , a ∈ C , d} , {ϑ}_{t}^{n , ∅ , e , g , d}} \text{} {\sum }_{d = 1}^{D} {\sum }_{t = 1}^{T} {\sum }_{a = 1}^{A} - \text{} [ \text{} ( {LMP}_{t}^{n , ∅ , d} {Load}_{t}^{n , ∅ , e , a ∈ NC , d} ) + \text{} ( {LMP}_{t}^{n , ∅ , d} ( 1 - {ϑ}_{t}^{n , ∅ , e , a ∈ C , d} ) {Load}_{t}^{n , ∅ , e , a ∈ C , d} ) ] - {\sum }_{d = 1}^{D} {\sum }_{t = 1}^{T} {RFLMP}_{t}^{n , ∅ , d} {ϑ}_{t}^{n , ∅ , e , g , d} {Gen}_{t}^{n , ∅ , e , g , d}$$

This representation of the objective function may have an objective to minimize the total cost of electricity services consumed by end user (e), located on Network Node (n) and phase (Ø) on day (d) and period (t). In this representation, the negative sign flips the cost from a positive number to a negative number. As a result, total costs may be minimized when no load control activity is incurred. Additionally, the total cost of load consumption may be augmented by the cost savings of on-premises generation. The latter may be based on the going market value for Reverse Flow power.

In this representation as shown above,

$$L M {P}_{t}^{n , ∅ , d}$$

is the locational marginal price (LMP) for end users served by network node (n) and phase (Ø) on day (d) and period (t);

$$R F L M {P}_{t}^{n , ∅ , d}$$

is the locational marginal price (LMP) for reverse power flow from for end users served by network node (n) and phase (Ø) on day (d) and period (t);

$${Load}_{t}^{n , ∅ , e , a ∈ NC , d}$$

is the total expected power consumed by noncontrollable (NC) end user (e) appliance or end use equipment (a∈NC) on day (d) and period (t) served by network node (n) and phase (Ø);

$${Load}_{t}^{n , ∅ , e , a ∈ C , d}$$

is the total expected power consumed by controllable € end user (e) appliance or end use equipment (a∈C) on day (d) and period (t) served by network node (n) and phase (Ø);

$${Gen}_{t}^{n , ∅ , e , g , d}$$

is the total expected power generated by on-premises generation unit(s) (g) for end user (e) served by network node (n) and phase (Ø) on day (d) and period (t);

$${ϑ}_{t}^{n , ∅ , e , a ∈ C , d}$$

is the fraction of total expected power consumed by a controllable € end user € appliance or end use equipment (a∈C) on day (d) and period (t) that is expected to be consumed after load control activity is put in place by the end user; and

$${ϑ}_{t}^{n , ∅ , e , g , d}$$

is the fraction of total expected power generated by on-premises generation unit(s) (g) for end user (e) served by network node (n) and phase (Ø) on day (d) and period (t) that is allowed to be generated.

The objective function may be subject to constraints. However, in some examples of this third framework, the DOE operating constraint may not be directly represented. In such examples, the DOE may be completely replaced with purely voluntary and/or penalty-based constraints already represented by the objective function. In other examples, there may be a mixture, where due to certain conditions, hard control or hard constraints may be implemented for some end users or for some periods of time. Alternative, non-DOE operating constraints related to the home network, user objectives, user anxiety metric-tied constraints, machine-learned model output-related constraints, regulation constraints, penalty cost constraints, market energy cost constraints, neighbor energy constraints, or PNO-imposed constraints may also be incorporated.

In this particular non-limiting example of an objective function according to the third framework, the objective function does not consider DOE penalties as soft constraints, so DOE operating constraints may be represented, similarly to the first framework, as:

$$DOE\_Min {\_NetLoad}_{t}^{n , ∅ , e , d} \leq {\sum }_{a = 1}^{A} [ ( {Load}_{t}^{n , ∅ , e , a ∈ N C , d} ) + ( {ϑ}_{t}^{n , ∅ , e , a ∈ C , d} {Load}_{t}^{n , ∅ , e , a ∈ C , d} ) ] - {ϑ}_{t}^{n , ∅ , e , g , d} G e {n}_{t}^{n , ∅ , e , g , d} {\sum }_{a = 1}^{A} [ ( {Load}_{t}^{n , ∅ , e , a ∈ N C , d} ) + ( {ϑ}_{t}^{n , ∅ , e , a ∈ C , d} {Load}_{t}^{n , ∅ , e , a ∈ C , d} ) ] - {ϑ}_{t}^{n , ∅ , e , g , d} Ge {n}_{t}^{n , ∅ , e , g , d} \leq DOE\_Max {\_NetLoad}_{t}^{n , ∅ , e , d}$$

In this example, in addition to the terms previously defined,

$$DOE\_Min {\_NetLoad}_{t}^{n , ∅ , e , d}$$

is the end user (e) assigned minimum allowable Net Load on day (d) and period (t); and

$$DOE\_Max {\_NetLoad}_{t}^{n , ∅ , e , d}$$

is the end user (e) assigned maximum allowable Net Load on day (d) and period (t).

### Example End User Framework 4

A fourth exemplary framework may be similar to the first, second, and third frameworks, additionally introducing a distributed energy storage. This distributed energy storage may be an on-premises Battery Energy Storage System (BESS). While BESS specifically is used here for the purpose of this exemplary framework, other types of ESSs (e.g., fuel cells, kinetic storage, etc.) may additionally or alternatively be used. This fourth framework may establish a least cost of electricity services while meeting user needs. Similar to the third framework, the BESS may provide another asset for achieving compliance with a DOE. This fourth exemplary framework may be similar to the second exemplary framework in that it may consider the DOE boundaries to be soft constraints, at least in part. The fourth exemplary framework may also, similar to the first framework, consider the DOE boundaries to be hard constraints, at least in part. This framework may be referred to as a BESS & on-premises generation framework.

Under this framework, the end user may take as given at least: (1) an assigned Dynamic Operating Envelope that spans the end user decision horizon; (2) a price for grid-supplied power; (3) a baseline or non-controllable power consumption forecast; (4) a controllable power consumption forecast; and (5) a distributed generation forecast.

As before, forecasted values for the non-controllable and controllable power consumption may be derived by the market participant or in other ways. Also, the market participant may have access to a forecast of the distributed generation that they can utilize. This may, by way of example and not limitation, similarly be provided by the end user, the PNO, a third party, or a combination thereof. In some such examples, this may be based at least in part on information, including solutions to corresponding frameworks, associated with neighbouring service sites.

The objective of the constrained objective function may be to minimize the net cost of electricity services subject to net loads remaining within their assigned dynamic operating envelope. This may be represented as:

$$\frac{Minimize}{{ϑ}_{t}^{n , ∅ , e , a ∈ C , d} , {ϑ}_{t}^{n , ∅ , e , g , d}} {\sum }_{d = 1}^{D} {\sum }_{t = 1}^{T} {\sum }_{a = 1}^{A} - [ ( L M {P}_{c}^{n , ∅ , d} {Load}_{t}^{n , ∅ , e , a ∈ N C , d} ) + ( LM {P}_{t}^{n , ∅ , d} ( 1 - {ϑ}_{t}^{n , ∅ , e , a ∈ C , d} ) {Load}_{t}^{n , ∅ , e , a ∈ C , d} ) ] - {\sum }_{d = 1}^{D} {\sum }_{t = 1}^{T} R F L M {P}_{t}^{n , ∅ , d} {ϑ}_{t}^{n , ∅ , e , g , d} {Gen}_{t}^{n , ∅ , e , g , d} - {\sum }_{d = 1}^{D} {\sum }_{t = 1}^{T} LM {P}_{t}^{n , ∅ , d} ( {BESS\_Charge}_{t}^{n , ∅ , e , d} - ( ( 1 - {ρ}^{n , ∅ , e , BD} ) {BESS\_Discharge}_{t}^{n , ∅ , e , d} ) )$$

This representation of the objective function may have an objective to minimize the total cost of electricity services consumed by end user (e), located on Network Node (n) and phase (Ø) on day (d) and period (t). In this representation, the negative sign flips the cost from a positive number to a negative number. As a result, total costs may be minimized when no load control activity is incurred. Additionally, the total cost of load consumption may be augmented by the cost savings of on-premises generation. The latter may be based on the going market value for Reverse Flow power.

In this representation as shown above,

$$L M {P}_{t}^{n , ∅ , d}$$

is the locational marginal price (LMP) for end users served by network node (n) and phase (Ø) on day (d) and period (t);

$$R F L M {P}_{t}^{n , ∅ , d}$$

is the locational marginal price (LMP) for reverse power flow from for end users served by network node (n) and phase (Ø) on day (d) and period (t);

$${Load}_{t}^{n , ∅ , e , a ∈ NC , d}$$

is the total expected power consumed by noncontrollable (NC) end user (e) appliance or end use equipment (a∈NC) on day (d) and period (t) served by network node (n) and phase (Ø);

$${Load}_{t}^{n , ∅ , e , a ∈ C , d}$$

is the total expected power consumed by controllable € end user (e) appliance or end use equipment (a∈C) on day (d) and period (t) served by network node (n) and phase (Ø);

$${Gen}_{t}^{n , ∅ , e , g , d}$$

is the total expected power generated by on-premises generation unit(s) (g) for end user (e) served by network node (n) and phase (Ø) on day (d) and period (t);

$${BESS\_Charge}_{t}^{n , ∅ , e , d}$$

is the total on-premises BESS charge for end user (e) served by network node (n) and phase (Ø) on day (d) and period (t);

$${BESS\_Discharge}_{t}^{n , ∅ , e , d}$$

is the total on-premises BESS gross discharged energy for end user (e) served by network node (n) and phase (Ø) on day (d) and period (t); ρ^{n,Ø,e,BD} is the discharge efficiency of BESS for end user (e) served by network node (n) and phase (Ø), where (1−ρ^{n,Ø,e,BD}) is the fraction of gross discharge BESS energy that is delivered to the premises;

$${ϑ}_{t}^{n , ∅ , e , a ∈ C , d}$$

is the fraction of total expected power consumed by a controllable € end user € appliance or end use equipment (a∈C) on day (d) and period (t) that is expected to be consumed after load control activity is put in place by the end user; and

$${ϑ}_{t}^{n , ∅ , e , g , d}$$

is the fraction of total expected power generated by on-premises generation unit(s) (g) for end user (e) served by network node (n) and phase (Ø) on day (d) and period (t) that is allowed to be generated.

The objective function may be subject to constraints. However, in some examples of this fourth framework, the DOE operating constraint may not be directly represented. In such examples, the DOE may be completely replaced with purely voluntary and/or penalty-based constraints already represented by the objective function. In other examples, there may be a mixture, where due to certain conditions, hard control or hard constraints may be implemented for some end users or for some periods of time. Alternative, non-DOE operating constraints related to the home network, user objectives, user anxiety metric-tied constraints, machine-learned model output-related constraints, regulation constraints, penalty cost constraints, market energy cost constraints, neighbor energy constraints, or PNO-imposed constraints may also be incorporated.

In this particular non-limiting example of an objective function according to the fourth framework, the objective function does not consider DOE penalties as soft constraints, so DOE operating constraints may be represented, similarly to the first framework, as:

$$DOE\_Min {\_NetLoad}_{t}^{n , ∅ , e , d} \leq {\sum }_{a = 1}^{A} [ ( {Load}_{t}^{n , ∅ , e , a ∈ NC , d} ) + ( {ϑ}_{t}^{n , ∅ , e , a ∈ C , d} {Load}_{t}^{n , ∅ , e , a ∈ C , d} ) ] - {ϑ}_{t}^{n , ∅ , e , g , d} {Gen}_{t}^{n , ∅ , e , g , d} + ( {BESS\_Charge}_{t}^{n , ∅ , e , d} - ( ( 1 - {ρ}^{n , ∅ , e , B D} ) {BESS\_Discharge}_{t}^{n , ∅ , n , d} ) ) {\sum }_{a = 1}^{A} [ ( {Load}_{t}^{n , ∅ , e , a ∈ NC , d} ) + ( {ϑ}_{t}^{n , ∅ , e , a ∈ C , d} {Load}_{t}^{n , ∅ , e , a ∈ C , d} ) ] - {ϑ}_{t}^{n , ∅ , e , g , d} {Gen}_{t}^{n , ∅ , e , g , d} + ( {BESS\_Charge}_{t}^{n , ∅ , e , d} - ( ( 1 - {ρ}^{n , ∅ , e , B D} ) {BESS\_Discharge}_{t}^{n , ∅ , n , d} ) ) \leq DOE\_Max {\_NetLoad}_{t}^{n , ∅ , e , d}$$

In this example, in addition to the terms previously defined,

$$DOE\_Min {\_NetLoad}_{t}^{n , ∅ , e , d}$$

is the end user (e) assigned minimum allowable Net Load on day (d) and period (t); and

$$DOE\_Max {\_NetLoad}_{t}^{n , ∅ , e , d}$$

is the end user (e) assigned maximum allowable Net Load on day (d) and period (t).

Additionally, this exemplary objective function is subject to BESS energy capacity constraints. BESS energy capacity constraints may be separated into three sets, corresponding to ensuring the total available charge remains within certain thresholds, constraints on the charging rate, and constraints on the discharging rate.

With respect to the thresholds, these constraints may ensure the total available charge (kWh) remains within the maximum and minimum charge thresholds set by an end user (e). The actual BESS charge may be discounted by the charging efficiency of the BESS. In some examples, these constraints may be provided by user input, or depend on other factors such as user anxiety, historic information, forecasts, a machine-learned model, PNO input, technical limitations, and other similar factors, by way of example and not limitation. This may be represented in expressions as:

$${BESS\_Energy}_{t}^{n , ∅ , e , d} = {BESS\_Energy}_{t - 1}^{n , ∅ , e , d} + ( {ρ}^{n , ∅ , e , B C} {BESS\_Charge}_{t}^{n , ∅ , e , d} ) - {BESS\_Discharge}_{t}^{n , ∅ , e , d}$$

$${BESS\_SOC}_{t}^{n , ∅ , e , d} = {BESS\_Energy}_{t}^{n , ∅ , e , d} / BESS\_Rated {\_Capacity}_{t}^{n , ∅ , e}$$

$${BESS\_SOC}_{t}^{n , ∅ , e , d} \leq {BESS\_MaxSOC}^{n , ∅ , e , d}$$

$${BESS\_SOC}_{t}^{n , ∅ , e , d} \geq BESS\_Min {\_SOC}^{n , ∅ , e , d}$$

With respect to the charging rate constraints, these may ensure a rate of charge in a period (which may be measured in KW) does not exceed a charging capacity of the BESS. This may be represented in expressions as:

$${BESS\_Charge}_{t}^{n , ∅ , e , d} \leq {Delivered}_{t}^{n , ∅ , e , d} + {ϑ}_{t}^{n , ∅ , e , g , d} G e {n}_{t}^{n , ∅ , e , g , d} - ( {\sum }_{a = 1}^{A} [ ( {Load}_{t}^{n , ∅ , e , a ∈ NC , d} ) + ( {ϑ}_{y}^{n , ∅ , e , a ∈ C , d} {Load}_{y}^{n , ∅ , e , a ∈ C , d} ) ] )$$

$${ρ}^{n , ∅ , e , BC} {BESS\_Charge}_{t}^{n , ∅ , e , d} \leq ( BESS\_Rated {\_Capacity}^{n , ∅ , e} \times ( {BESS\_Max}_{-} {SOC}^{n , ∅ , e , d} - {BESS\_SOC}_{t - 1}^{n , ∅ , e , d} ) )$$

$${BESS\_Charge}_{t}^{n , ∅ , e , d} \leq BESS\_Rated {\_Charge}^{n , ∅ , e}$$

$${BESS\_Charge}_{t}^{n , ∅ , e , d} \geq 0$$

With respect to discharge constraints, these may ensure a rate of discharge in a period (which may be measured in KW) does not exceed a discharge capacity of the BESS. Further, the amount of discharge may be adjusted to account for the discharge efficiency of the BESS. This may be represented in expressions as:

$${BESS\_Discharge}_{t}^{n , ∅ , e , d} \leq ( BESS\_Rated {\_Capacity}^{n , ∅ , e} \times ( {BESS\_SOC}_{t - 1}^{n , ∅ , e , d} - BESS\_Min {\_SOC}^{n , ∅ , e , d} ) )$$

$${BESS\_Discharge}_{t}^{n , ∅ , e , d} \leq BESS\_Rated {\_Discharge}^{n , ∅ , e}$$

$${BESS\_Discharge}_{t}^{n , ∅ , e , d} \geq 0$$

In these examples of the BESS energy constraints as written,

$${BESS\_Energy}_{t}^{n , ∅ , e , d}$$

is the total energy (kWh) stored at day (d) and period (t) in BESS operated by end user (e) end user (e) served by network node (n) and phase (Ø);

$${BESS\_Charge}_{t}^{n , ∅ , e , d}$$

is the total on-premises BESS charge for end user (e) served by network node (n) and phase (Ø) on day (d) and period (t);

$${ρ}^{n , ∅ , e , BC}$$

is the charge efficiency of BESS for end user (e) served by network node (n) and phase (Ø); ρρ^{n,Ø,e,BC}) is the fraction of gross charge BESS energy that is stored;

$${BESS\_Discharge}_{t}^{n , ∅ , e , d}$$

is the total on-premises BESS discharge for end user (e) served by network node (n) and phase (Ø) on day (d) and period (t);

$${BESS\_SOC}_{t}^{n , ∅ , e , d}$$

is the State-of-Charge (SOC) for BESS operated by end user (e) served by network node (n) and phase (Ø) on day (d) and period (t); BESS_Rated_Capacity^{n,Ø,e} is the total energy capacity for BESS operated by end user (e) served by network node (n) and phase (Ø); BESS_MaxSOC^{n,Ø,e,d} is user-defined maximum state-of-charge for BESS operated by end user (e) served by network node (n) and phase (Ø) on day (d) and period (t); BESS_Min_SOC^{n,Ø,e,d} is user-defined minimum state-of-charge for BESS operated by end user (e) served by network node (n) and phase (Ø) on day (d) and period (t);

$${Delivered}_{t}^{n , ∅ , e , d}$$

is grid-supplied power for end user (e) served by network node (n) and phase (Ø) on day (d) and period (t); BESS_Rated_Charge^{n,Ø,e} is the maximum rate of charge (kW) for BESS operated by end user (e) served by network node (n) and phase (Ø); and BESS_Rated_Discharge^{n,Ø,e} is the maximum rate of discharge (kW) for BESS operated by end user (e) served by network node (n) and phase (Ø).

### Example End User Framework 5

A fourth exemplary framework may be similar to the first, second, third, and fourth frameworks, additionally introducing an electric vehicle (or other similar appliance) for charging. This fifth framework may establish a least cost of electricity services while meeting user needs.

This fifth framework may incorporate a decision framework for end user EV charging decisions. The decision framework may use one or more heuristic algorithms for the determination of battery charging and discharging to reduce an end user's electricity cost. The algorithms may account for time of use electricity rates in recognition that the cost of electricity varies over time (during the day, across days of the week, etc.). The algorithms may apply to actions that should be taken at a specific point in time given information available at that time. The algorithms may consider current: demand for power, solar PV generation, BESS capacity, BESS target minimum and maximum charge limits, and various Time of Use rate for delivered and received power. This information may include future demand for power or generation. The algorithms may be restricted to comparing to a maximum time of use rate, though comparing current to maximum time of use rates may lead to non-optimal outcomes.

By way of example, the following tables represent time of use rates that apply for the 24-hour period of 06:00 AM of one day to 05:55 AM of the next day of one particular example. The first table may indicate the cost to the consumer of buying electricity from the grid, while the second table may indicate the money the consumer would receive for each kWh sold back to the grid. The sale of the second table may only occur if the consumer produces more electricity than consumed.

Cost of Buying Power from the Grid to the Consumer

| TOU Block | Start Time | End Time | Dollars/kWh |
|---|---|---|---|
| 1 | Midnight | 05:55 | $0.145 |
| 2 | 06:00 | 15:55 | $0.448 |
| 3 | 16:00 | 20:55 | $0.512 |
| 4 | 21:00 | 23:55 | $0.145 |

Cost of Selling Power from the Consumer to the Grid

| TOU Block | Start Time | End Time | Dollars/kWh |
|---|---|---|---|
| 1 | Midnight | 05:55 | $0.05 |
| 2 | 06:00 | 15:55 | $0.05 |
| 3 | 16:00 | 20:55 | $0.05 |
| 4 | 21:00 | 23:55 | $0.05 |

Continuing the example, a decision may be made at a time such as 09:15 AM. The prevailing TOU, as per the exemplary table, may be $0.448 which is less than a maximum rate of $0.512. A decision algorithm's rules may imply that since the current rate is lower than the highest rate the optimal action is to charge the BESS with any available excess generation. The energy stored at 09:15 AM may then be considered to be available to offset consumption during the TOU period of 16:00 to 20:55. This may assume, however, that the consumer will be consuming electricity during the period 16:00 to 20:55. If the future consumption was zero, then the decision was suboptimal in that the consumer may have been better off selling the excess electricity back to the grid.

Wider decision windows may help mitigate this sub-optimal outcome. Again, by way of example and not limitation, one motivation for the use of a wider decision window may be in the decisions end users make when refueling their vehicle. When a driver is deciding to pull into a gas station to refuel their vehicle, they may be considered to make a quick calculation about whether they have sufficient gas to meet their driving requirements until the next time they need to stop for gas. In this example, the information they have at the time of their decision includes the remaining available range (measurable in miles), the minimum available range required during the current trip or day of driving (measurable in miles), expected required range between the current gas station and the next available gas station (measurable in miles), current cost of fuel versus expected cost of fuel at the next fueling decision (measurable in currency/gallon), and average fuel efficiency (measurable in mils/gallon).

The driver may also have a choice of gas stations, so they may consider relative utility of using one station over another. Utility may be measured by competing fuel prices, ease of fueling (which may include location of the station relative to a direction of travel), available amenities, etc. Added gas or driving range may depend on time available to fuel the vehicle (measurable in minutes), fueling efficiency (measurable in miles of range added per minute of fueling), minimum miles of range required before next fueling opportunity (measurable in miles), desired minimum miles of range before next fueling decision (measurable in miles), maximum miles of range(measurable in miles), and available budget (measurable in currency such as dollars).

Minimum miles of range required before the next fueling opportunity may represent the distance in miles to the next available gas station. This range may represent a minimum limit on the range that needs to be added to the vehicle to avoid running out of fuel before the vehicle can be refueled. For example, if the next available gas station is 25 miles away, the minimum miles of range required may be 25 miles. The desired minimum miles of range before the next fueling decision may determine the number of refueling stops that need to be made to meet the current or day of driving requirements.

If the distance between all refueling options is known, the difference between Minimum Required and Minimum Desired miles range will, in this example and without limitation, depend on the trade-off between time to refuel per stop. If the time to refuel is fixed per mile of range, then there may be no time advantage to adding more than the minimum required miles of range at every refueling point. An alternate representation of this example is that if the distance between refueling options is known, then range anxiety may be negligible. If the distance between refueling options is unknown, then range anxiety may be a higher level (such as palpable, a qualitative measurement, or 10, a quantitative measurement). In this case, Minimum Desired miles of range may push closer toward the maximum miles of range depending on the level of range anxiety.

Another exemplary factor that may lead to range anxiety is uncertainty around the minimum available range required. If the driver is uncertain about whether a trip requires 25 miles or 50 miles, then anxiety around the needed range may grow. Again, this may push the Minimum Desired miles of range toward the maximum capacity of the vehicle. How many miles of range are added may depend on a trade-off between available budget, time available to fuel the vehicle, and the cost a driver assigns to possibility of running out of fuel mid-trip. The quick calculation that the driver may go through, in this example, is how to minimize the cost of refueling subject to physical and desirable range constraints.

This example is similar to a decision process which may be undertaken with respect to charging electric vehicles (EVs). This decision may be taken by an algorithm, user, or other decision framework. For the purpose of illustration, one example will use the case where the decision is made by a human. When considering whether to recharge an EV when a driver arrives home, the quick calculation as to whether to recharge the EV or not depends on the remaining available range (measurable in miles), expected range needed for the next trip (measurable in miles), and amount of time available to recharge the EV. The driver may, in this example, recharge the EV if the remaining available range is less than the expected miles of range needed for the next trip. For this example, if the remaining available range is 75 miles and the expected need tomorrow is 100 miles, then the car may need to be recharged. However, if the expected need tomorrow is 15 miles, the car may not require recharging.

If the EV is to be recharged, then the amount of added range may depend on desired range before next charging session (measurable in % of battery charge capacity), maximum charge limit (measurable in % of battery charge capacity), a measurement of the lower value between desired range and maximum charge limit, minimum charge limit (measurable in % of battery charge capacity), a measurement of the higher value between desired range and minimum charge limit, time available before the vehicle needs to be ready to drive (measurable in minutes), and average charge time (measurable in miles/minute).

In an example where the driver is uncertain about the miles of range required for the next trip, the desired range of charge may be pushed towards the maximum charge limited. This is similar to the range anxiety decision process gas vehicle drivers may make, and thus may be considered an anxiety level, a tolerance, or uncertainty level in some examples.

The decision to recharge (similar to filling up with gas) an EV may depend on the current available range of charge (similar fuel in the tank) and the expectation of how much driving is going to be needed before the next charge session (similar to fueling session) takes place. This may mean the decision horizon extends past the current moment in time to account for future driving activity.

The gas tank of a car and the battery of an EV may allow energy to move forward in time to meet future energy services. In the same way, a Battery Energy Storage System (BESS) may allow electricity to move forward in time to meet future demand for power. The consideration of an EV in this framework may expand the options for how stored electricity can reduce the overall electricity costs of a premise. Thus, objective functions associated with this fifth framework may provide insight as to how decisions around EV charging and BESS charging/discharging when combined with on-site solar PV generation can minimize the costs of electricity services over a multiperiod decision horizon.

Similar to the third and fourth frameworks, the EV may provide another asset for achieving compliance with a DOE. The EV may also provide another goal with respect to DOE compliance. This fifth exemplary framework may be similar to the second exemplary framework in that it may consider the DOE boundaries to be soft constraints, at least in part. The fifth exemplary framework may also, similar to the first framework, consider the DOE boundaries to be hard constraints, at least in part. This framework may be referred to as an EV charging framework.

This fifth framework may include a multiperiod BESS/EV charging decision model. This model may be designed to produce optimal BESS charging/discharging, and EV charging decisions that minimize the overall cost of electricity services at a premise. The model may be designed to make optimal charging and discharging decisions for a minimum decision horizon. This minimum decision horizon may be 24 hours ahead. The decision horizon may be extended to span multiple days, weeks, and months, but the longer decision horizons may increasingly depend on accurate forecasts of baseline consumption and solar PV generation. Both elements may be subject to weather forecast error.

Under this framework, the end user may take as given at least: (1) an assigned Dynamic Operating Envelope that spans the end user decision horizon; (2) a price for grid-supplied power; (3) a baseline or non-controllable power consumption forecast; (4) a controllable power consumption forecast; and (5) a distributed generation forecast.

The non-controllable and controllable power forecasts may, whether taken alone or in combination, include EV charging forecast information. They may also include user uncertainty, anxiety, or tolerance information. As before, forecasted values for the non-controllable and controllable power consumption may be derived by the market participant or in other ways. Also, the market participant may have access to a forecast of the distributed generation that they can utilize. This may, by way of example and not limitation, similarly be provided by the end user, the PNO, a third party, or a combination thereof. In some such examples, this may be based at least in part on information, including solutions to corresponding frameworks, associated with neighbouring service sites.

The objective of a constrained objective function in the exemplary fifth framework may be to minimize the net cost of electricity services subject to net loads remaining within their assigned dynamic operating envelope. This may be represented as:

$$\frac{Minimize}{{ϑ}_{t}^{n , ∅ , e , a ∈ C , d} , {ϑ}_{t}^{n , ∅ , e , g , d}} {\sum }_{d = 1}^{D} {\sum }_{t = 1}^{T} {\sum }_{a = 1}^{A} - [ \text{} ( {LMP}_{t}^{n , ∅ , d} {Load}_{t}^{n , ∅ , e , a ∈ N C , d} ) + ( L M {P}_{t}^{n , ∅ , d} ( 1 - {ϑ}_{t}^{n , ∅ , e , a ∈ C , d} ) {Load}_{t}^{n , ∅ , e , a ∈ C , d} ) ] - {\sum }_{d = 1}^{D} {\sum }_{t = 1}^{T} R F L M {P}_{t}^{n , ∅ , d} {ϑ}_{t}^{n , ∅ , e , g , d} G e {n}_{t}^{n , ∅ , e , g , d} - {\sum }_{d = 1}^{D} {\sum }_{t = 1}^{T} L M {P}_{t}^{n , ∅ , d} ( {BESS\_Charge}_{t}^{n , ∅ , e , d} - ( ( 1 - {ρ}^{n , ∅ , e , B D} ) {BESS\_Discharge}_{t}^{n , ∅ , e , d} ) )$$

This representation of the objective function may have an objective to minimize the total cost of electricity services consumed by end user (e), located on Network Node (n) and phase (Ø) on day (d) and period (t). In this representation, the negative sign flips the cost from a positive number to a negative number. As a result, total costs may be minimized when no load control activity is incurred. Additionally, the total cost of load consumption may be augmented by the cost savings of on-premises generation. The latter may be based on the going market value for Reverse Flow power.

In this representation as shown above,

$$L M {P}_{t}^{n . ∅ , d}$$

is the locational marginal price (LMP) for end users served by network node (n) and phase (Ø) on day (d) and period (t);

$$RFLM {P}_{t}^{n , ∅ , d}$$

is the locational marginal price (LMP) for reverse power flow from for end users served by network node (n) and phase (Ø) on day (d) and period (t);

$${Load}_{t}^{n , ∅ , e , a ∈ NC , d}$$

is the total expected power consumed by noncontrollable (NC) end user (e) appliance or end use equipment (a∈NC) on day (d) and period (t) served by network node (n) and phase (Ø);

$${Load}_{t}^{n , ∅ , e , a ∈ C , d}$$

is the total expected power consumed by controllable € end user (e) appliance or end use equipment (a∈C) on day (d) and period (t) served by network node (n) and phase (Ø);

$${Gen}_{t}^{n , ∅ , e , g , d}$$

is the total expected power generated by on-premises generation unit(s) (g) for end user (e) served by network node (n) and phase (Ø) on day (d) and period (t);

$${BESS\_Discharge}_{t}^{n , ∅ , e , d}$$

is the total on-premises BESS charge for end user (e) served by network node (n) and phase (Ø) on day (d) and period (t);

$${BESS\_Discharge}_{t}^{n , ∅ , e , d}$$

is the total on-premises BESS gross discharged energy for end user (e) served by network node (n) and phase (Ø) on day (d) and period (t); ρ^{n,Ø,e,BD} is the discharge efficiency of BESS for end user (e) served by network node (n) and phase (Ø), where (1−ρ^{n,Ø,e,BD}) is the fraction of gross discharge BESS energy that is delivered to the premises; γ^{n,Ø,e,d} is the value of range anxiety assigned by end user (e) served by network node (n) and phase (Ø) on day (d), where range anxiety is measured by the difference between maximum available miles of charge and the actual miles of charge at the end of the EV charging period (t=EC); EV_Capacity^{n,θ,e} is the maximum available miles of charge for end user (e) served by network node (n) and phase (Ø); EV_Max_SOC^{n,Ø,e,d} is the end user (e) set maximum state-of-charge target for EV operated by end user (e) served by network node (n) and phase (Ø) on day (d);

$${EV\_Charge}_{t = EC}^{n , ∅ , e , d}$$

is the miles of charge at the end of the EV charging period (t=EC) by end user (e) served by network node (n) and phase (Ø) on day (d);

$${ϑ}_{t}^{n , ∅ , e , a ∈ C , d}$$

is the fraction of total expected power consumed by a controllable € end user € appliance or end use equipment (a∈C) on day (d) and period (t) that is expected to be consumed after load control activity is put in place by the end user; and

$${ϑ}_{t}^{n , ∅ , e , g , d}$$

is the fraction of total expected power generated by on-premises generation unit(s) (g) for end user (e) served by network node (n) and phase (Ø) on day (d) and period (t) that is allowed to be generated.

Range of cost anxiety may be included in the objective function instead of or in addition to representation as a constraint. Since mathematical objective function solutions may be very precise, uncertainties around constraints may not be permissible or effective when solving an objective function. By way of example, if a minimum required charge is 100 miles, then a least cost solution may be to charge to 100 miles and no further. Introducing cost or range anxiety into an objective function may allow simulation of or solutions for different personas ranging from no range anxiety to severe range anxiety. Personas with severe range anxiety may be represented by a large value for γ^{n,Ø,e,d} while personas with low or no range anxiety will represented by low or zero value for γ^{n,Ø,e,d}. This may be provided by user input as a direct measurement of anxiety or desired range or a percentage. This may also depend on factors such as a user anxiety classification, a user anxiety metric scale, historic information, forecasts, a machine-learned model, PNO input, technical limitations, and other similar factors, by way of example and not limitation.

The objective function may be subject to constraints. However, in some examples of this fifth framework, the DOE operating constraint may not be directly represented. In such examples, the DOE may be completely replaced with purely voluntary and/or penalty-based constraints already represented by the objective function. In other examples, there may be a mixture, where due to certain conditions, hard control or hard constraints may be implemented for some end users or for some periods of time. Alternative, non-DOE operating constraints related to the home network, user objectives, user anxiety metric-tied constraints, machine-learned model output-related constraints, regulation constraints, penalty cost constraints, market energy cost constraints, neighbor energy constraints, or PNO-imposed constraints may also be incorporated.

In this particular non-limiting example of an objective function according to the fourth framework, the objective function does not consider DOE penalties as soft constraints, so DOE operating constraints may be represented, similarly to the first framework, as:

$$DOE\_Min {\_NetLoad}_{t}^{n , ∅ , e , d} \leq {\sum }_{a = 1}^{A} [ ( {Load}_{t}^{n , ∅ , e , a ∈ NC , d} ) + ( {ϑ}_{t}^{n , ∅ , e , a ∈ C , d} {Load}_{t}^{n , ∅ , e , a ∈ C , d} ) ] - {ϑ}_{t}^{n , ∅ , e , g , d} {Gen}_{t}^{n , ∅ , e , g , d} + ( B {ESS}_{{Charge}_{t}^{n , ∅ , e , d}} - ( ( 1 - {ρ}^{n , ∅ , e , BD} ) B {ESS}_{{Discharge}_{t}^{n , ∅ , e , d}} ) ) + {EV\_Charge}_{t}^{n , ∅ , e , d}$$

$${\sum }_{a = 1}^{A} [ ( {Load}_{t}^{n , , ∅ , e , a ∈ NC , d} ) + ( {ϑ}_{t}^{n , ∅ , e , a ∈ C , d} {Load}_{t}^{n , ∅ , e , a ∈ C , d} ) ] - {ϑ}_{t}^{n , ∅ , e , g , d} {Gen}_{t}^{n , ∅ , e , g , d} + ( B {ESS}_{{Charge}_{t}^{n , ∅ , e , d}} - ( ( 1 - {ρ}^{n , ∅ , e , BD} ) B {ESS}_{{Discharge}_{t}^{n , ∅ , e , d}} ) ) + {EV\_Charge}_{t}^{n , ∅ , e , d} \leq DOE\_Max {\_NetLoad}_{t}^{n , ∅ , e , d}$$

In this example, in addition to the terms previously defined,

$$DOE\_Min {\_NetLoad}_{t}^{n , ∅ , e , d}$$

is the end user (e) assigned minimum allowable Net Load on day (d) and period (t); and

$$DOE\_Max {\_NetLoad}_{t}^{n , ∅ , e , d}$$

is the end user (e) assigned maximum allowable Net Load on day (d) and period (t).

Additionally, this exemplary objective function is subject to BESS energy capacity constraints. BESS energy capacity constraints may be separated into three sets, corresponding to ensuring the total available charge remains within certain thresholds, constraints on the charging rate, and constraints on the discharging rate.

With respect to the thresholds, these constraints may ensure the total available charge (kWh) remains within the maximum and minimum charge thresholds set by an end user (e). The actual BESS charge may be discounted by the charging efficiency of the BESS. In some examples, these constraints may be provided by user input, or depend on other factors such as user anxiety, historic information, forecasts, a machine-learned model, PNO input, technical limitations, and other similar factors, by way of example and not limitation. This may be represented in expressions as:

$${BESS\_Energy}_{t}^{n , ∅ , e , d} = {BESS\_Energy}_{t - 1}^{n , ∅ , e , d} + ( {ρ}^{n , ∅ , e , B C} {BESS\_Charge}_{t}^{n , ∅ , e , d} ) - {BESS\_Discharge}_{t}^{n , ∅ , e , d}$$

$${BESS\_SOC}_{t}^{n , ∅ , e , d} = {BESS\_Energy}_{t - 1}^{n , ∅ , e , d} / BESS\_Rated {\_Capacity}^{n , ∅ , e}$$

$${BESS\_SOC}_{t}^{n , ∅ , e , d} \leq {BESS\_MaxSOC}^{n , ∅ , e , d}$$

$${BESS\_SOC}_{t}^{n , ∅ , e , d} \geq BESS\_Min {\_SOC}^{n , ∅ , e , d}$$

With respect to the charging rate constraints, these may ensure a rate of charge in a period (which may be measured in KW) does not exceed a charging capacity of the BESS. This may be represented in expressions as:

$${BESS\_Charge}_{t}^{n , ∅ , e , d} \leq {Delivered}_{t}^{n , ∅ , e , d} + {ϑ}_{t}^{n , ∅ , e , g , d} {Gen}_{t}^{n , ∅ , e , g , d} - ( {\sum }_{a = 1}^{A} [ ( {Load}_{t}^{n , ∅ , e , a ∈ NC , d} ) + ( {ϑ}_{t}^{n , ∅ , e , a ∈ C , d} {Load}_{t}^{n , ∅ , e , a ∈ C , d} ) ] )$$

$${ρ}^{n , ∅ , e , BC} {BESS\_Charge}_{t}^{n , ∅ , e , d} \leq ( BESS\_Rated {\_Capacity}^{n , ∅ , e} \times ( BESS\_Max {\_SOC}^{n , ∅ , e , d} - {BESS\_SOC}_{t - 1}^{n , ∅ , e , d} ) )$$

$${BESS\_Charge}_{t}^{n , ∅ , e , d} \leq BESS\_Rated {\_Charge}^{n , ∅ , e}$$

$${BESS\_Charge}_{t}^{n , ∅ , e , d} \geq 0$$

With respect to discharge constraints, these may ensure a rate of discharge in a period (which may be measured in KW) does not exceed a discharge capacity of the BESS. Further, the amount of discharge may be adjusted to account for the discharge efficiency of the BESS. This may be represented in expressions as:

$${BESS\_Discharge}_{t}^{n , ∅ , e , d} \leq \text{} ( BESS\_Rated {\_ Capacity}^{n , ∅ , e} \times \text{} \text{} ( {BESS\_SOC}_{t - í}^{n , ∅ , e , d} - \text{} BESS\_Min {\_SOC}^{n , ∅ , e , d} ) )$$

$${BESS\_Discharge}_{t}^{n , ∅ , e , d} \leq BESS\_Rated {\_Discharge}^{n , ∅ , e}$$

$${BESS\_Discharge}_{t}^{n , ∅ , e , d} \geq 0$$

In these examples of the BESS energy constraints as written,

$${BESS\_Energy}_{t}^{n , ∅ , e , d}$$

is the total energy (kWh) stored at day (d) and period (t) in BESS operated by end user (e) end user (e) served by network node (n) and phase (Ø);

$${BESS\_Charge}_{t}^{n , ∅ , e , d}$$

is the total on-premises BESS charge for end user (e) served by network node (n) and phase (Ø) on day (d) and period (t); ρ^{n,Ø,e,BC} is the charge efficiency of BESS for end user (e) served by network node (n) and phase (Ø); ρ^{n,Ø,e,BC}) is the fraction of gross charge BESS energy that is stored;

$${BESS\_Discharge}_{t}^{n , ∅ , e , d}$$

is the total on-premises BESS discharge for end user (e) served by network node (n) and phase (Ø) on day (d) and period (t);

$${BESS\_SOC}_{t}^{n , ∅ , e , d}$$

is the State-of-Charge (SOC) for BESS operated by end user (e) served by network node (n) and phase (Ø) on day (d) and period (t); BESS_Rated_Capacity^{n,Ø,e} is the total energy capacity for BESS operated by end user (e) served by network node (n) and phase (Ø); BESS_MaxSOC^{n,Ø,e,d} is user-defined maximum state-of-charge for BESS operated by end user (e) served by network node (n) and phase (Ø) on day (d) and period (t); BESS_Min_SOC^{n,Ø,e,d} is user-defined minimum state-of-charge for BESS operated by end user (e) served by network node (n) and phase (Ø) on day (d) and period (t);

$${Delivered}_{t}^{n , ∅ , e , d}$$

is grid-supplied power for end user (e) served by network node (n) and phase (Ø) on day (d) and period (t); BESS_Rated_Charge^{n,Ø,e} is the maximum rate of charge (kW) for BESS operated by end user (e) served by network node (n) and phase (Ø); and BESS_Rated_Dischargeγ^{n,Ø,e,} is the maximum rate of discharge (kW) for BESS operated by end user (e) served by network node (n) and phase (Ø).

EV charging may also be computed as part of the fifth exemplary framework. This may be simulated by functions minimizing the overall net cost of power subject to consumer configurable EV charging targets. Exemplary governing equations may represent EV charging requirements, constraints on time specific EV charging rates (KW), and constraints on total EV charging energy (KWh).

With respect to the primary EV charging requirements function, this may represent how each day at the time an end user may normally plug in their EV to be charged (for example and not as a limitation, when they arrive home from work), a decision is made (by the user or in another way) whether EV charging is required to meet the driving needs of the next day. If there are sufficient miles of charge remaining, then the EV may not be plugged in to charge. This logic may be represented as:

$$\begin{matrix}Min {MilesRequired}_{t}^{n , ∅ , e , d} = MAX [ \{ MIN ( {ExpectedMiles}_{t}^{n , ∅ e , d} , EV\_ \\ {MAXMiles}_{t}^{n , ∅ , e , d} ) \\ - {PlugInMiles}_{t}^{n , ∅ , e , d} \} , 0 ]\end{matrix}$$

In this expression as shown,

$$Min {MilesRequired}_{t}^{n , ∅ , e , d}$$

is the minimum of miles of charge required to meet tomorrow's (d+1) driving requirements for end user (e) served by network node (n) and phase (Ø) on day (d) and period (t);

$${ExpectedMiles}_{t}^{n , ∅ , e , d}$$

is the expected number of miles that will be driven on day (d+1) for end user (e) served by network node (n) and phase (Ø) on day (d) and period (t);

$${EV\_MAXMiles}_{t}^{n , ∅ , e , d}$$

is the maximum mile range of the EV for end user (e) served by network node (n) and phase (Ø) on day (d) and period (t); and

$${PlugInMiles}_{t}^{n , ∅ , e , d}$$

is the number of miles of remaining charge at the time the EV is to be plugged in for end user (e) served by network node (n) and phase (Ø) on day (d) and period (t).

By way of example and not as limitation, the following table indicates a demonstration of these calculations.

| Miles @ Time | Next Day | EV Maximum | Min Miles of Charge |
|---|---|---|---|
| of Plug In | Expected Miles | Miles | Required @ Plug In |
| 200 | 30 | 300 | 0 |
| 170 | 450 | 300 | 130 |
| 0 | 30 | 300 | 30 |

In this example, on the first day at the time of plug in there are 200 miles of range remaining. The next day, the expected number of miles is 30, so 30 miles of range are needed the next day. The EV consistently has a maximum range of 300 miles at the first day (and, in this example, across all 3 days). Hence, there is plenty of charge remaining to meet the needs for tomorrow so no charging may be required. The following day at the time of the plug in there are 150 miles of range remaining, and the expectation is that the third day will use 450 miles. Hence, the EV may be plugged in, but only a further 130 miles of range may be added (bringing the total range available to 300) because of the maximum available EV miles. On the final day, there are 0 miles of charge remaining and an anticipated 30 miles of range needed, so 30 miles of charge will be required.

The minimum miles of charge required (in units of miles) may be converted to a minimum required charge (in units of kWh) as per the following expression:

$$Min\_Required {\_Charge}_{t}^{n , ∅ , e , d} = ( \frac{Min M i l e s R e q u i r e {d}^{n , ∅ , e , d}}{EV\_Eff {\_MilesPerKWh}^{n , ∅ , e}} )$$

In this expression as shown,

$$Min\_Required {\_Charge}_{t}^{n , ∅ , e , d}$$

is the minimum EV Battery charge required at the end of the charging period for end user (e) served by network node (n) and phase (Ø) on day (d) and period (t); and EV_Eff_MilesPerKWh^{n,Ø,e} is the operating efficiency of the EV in miles per kWh for end user (e) served by network node (n) and phase (Ø).

With respect to the constraint on time specific EV charging rate, a set of constraints may ensure the optimal and/or solved EV charging rate is non-negative and/or does not exceed the charging capacity (kW) of the EV charger. These constraints may be represented in expressions as:

$${EV\_Charge}_{t}^{n , ∅ , e , d} \leq ( {EV\_Capacity}^{n , ∅ , e} ( EV\_Max {\_SOC}^{n , ∅ , e , d + 1} - {EV\_SOC}_{t - 1}^{n , ∅ , e , d} ) )$$

$${EV\_Charge}_{t}^{n , ∅ , e , d} \leq EVCharger\_Rated {\_Power}_{t}^{n , ∅ , e , d}$$

$${EV\_Charge}_{t}^{n , ∅ , e , d} \geq 0$$

In these examples of the EV charging rate constraints as written,

$${EV\_Charge}_{t}^{n , ∅ , e , d}$$

is the amount of EV charge on day (d) and period (t) for end user (e) served by network node (n) and phase (Ø);

$${EV\_SOC}_{t - 1}^{n , ∅ , e , d}$$

is the State of Charge on day (d) and period (t−1) for end user (e) served by network node (n) and phase (Ø); EV_Capacity^{n,Ø,e} is the EV rated capacity (kWh) for end user (e) served by network node (n) and phase (Ø); EV_Max_SOC^{n,Ø,e,d+1} is the maximum State of Charge (SOC) for charging period (d+1) for end user (e) served by network node (n) and phase (Ø), which may be consumer set;

$$EVCharger\_Rated {\_Power}_{t}^{n , ∅ , e , d}$$

is the maximum EV Charge Rate for day (d) and period (t) for end user (e) served by network node (n) and phase (Ø).

These values may be set externally to the optimization framework. Simulation or calculation of EV charging programs that are designed to prevent EV charging during certain time periods (or other events or reasons to prevent EV charging during certain intervals) may be performed by setting values of a time series in this set of equations to 0 for time intervals covered by the program.

With respect to the constraint on total EV charging energy, a set of constraints may ensure the optimal and/or solved EV Charging activity does not exceed a desired maximum threshold charge. This may be set by the user, as per any of the previously discussed ways such thresholds may be set, or any combination thereof. These constraints may be represented in expressions as:

$${EV\_Energy}_{t}^{n , ∅ , e , d} = {EV\_Energy}_{t - 1}^{n , ∅ , e , d} + ( {ρ}^{n , ∅ , e , E V C} {EV\_Charge}_{t}^{n , ∅ , e , d} )$$

$${EV\_SOC}_{t}^{n , ∅ , e , d} = {EV\_Energy}_{t}^{n , ∅ , e , d} / {EV\_Capacity}^{n , ∅ , e}$$

$${EV\_SOC}_{t = {EC}_{d}}^{n , ∅ , e , d + 1} \leq EV\_Max {\_SOC}^{n , ∅ , e , d + 1}$$

$${EV\_SOC}_{t = {EC}_{d}}^{n , ∅ , e , d + 1} \leq EV\_Max {\_SOC}^{n , ∅ , e , d + 1}$$

$${EV\_Energy}_{t = {EC}_{d}}^{n , ∅ , e , d + 1} \geq Min\_Required {\_Charge}^{n , ∅ , e , d + 1}$$

In these examples of the EV charging energy constraints, ρ^{n,Ø,e,EVC} is the EV charge efficiency for end user (e) served by network node (n) and phase (Ø);ρ^{n,Ø,e,EVC}) is the fraction of gross charge energy that is stored;

$${EV\_Energy}_{t}^{n , ∅ , e , d}$$

EV battery energy level (kWh) at the end of the charging period (t) on day (d) for end user (e) served by network node (n) and phase (Ø); EV_Min_SOC^{n,Ø,e,d+1} is the minimum State of Charge (SOC) for charging period (d+1) for end user (e) served by network node (n) and phase (Ø); and EC_{d} is the End of Charging period on charging day (d) when the car needs to be ready to drive for end user (e) served by network node (n) and phase (Ø).

### ADDITIONAL INFORMATION

The techniques disclosed herein provide multiple technical and practical benefits. The techniques can be used to improve a functioning of a computer device in a number of ways. For example, in the context of computerized management of highly granular utility services, DOEs and objective functions provide computationally effective approaches to successfully implementing controls in a fashion that is impractical for a human to effectively perform. Additionally, the capacity to mix-and-match constraints and framework features increases the accuracy of the model in implementing a control to meet the needs of particular network configurations. Eliminating unnecessary elements or constraints reduces unnecessary computational operations when only certain features are appropriate. Also, splitting the objective functions between the PNO and end user perspective further increases computational efficiency. This speed may result in meaningful gains to a service site computing device or PNO computing device both in the form of less computing costs and more local autonomy of control of the local service site.

Increasingly effective controls as per the techniques herein meet user needs, meet PNO needs, lower costs, increase grid reliability and efficiency, improve dynamics between neighboring service sites, improve grid forecasts, and improve user satisfaction. The techniques herein enable interfacing with third parties for control, which reduces the computational overhead of implementing controls and improves flexibility of implementation. DOEs serve as a bridge between PNO needs (managing the grid-connected and non-grid connected load, storage, and generation assets they can schedule and dispatch) and end user needs (utilizing their appliances, equipment, storage, and generation to meet their needs).

Furthermore, the techniques disclosed herein may be used for training models and simulations with respect to controlling distributed resources. The forecasts, associated metrics, and/or function solutions may be used to allow humans to visualize information. They may also be used to test software relating to grid control, predict the effect of various events (such as weather, maintenance, outages, etc.), trends associated with a grid, or used in planning grids. The intricate dynamics of controls, DOEs, network situations, network events, the effects of distributed assets, and solutions to these objective functions may not be easily understood or evaluated by humans or users, and the techniques herein help in presenting those features.

Computer-implemented embodiments of the techniques herein may allow greater limitation of control access from unauthorized and/or illicit internal users, as user contact with the controls is not necessary if a DOE is implemented. Enabling limited authority internal users to implement the techniques herein because of this access control may be another advantage; companies may be able to delegate the task of creating these controls with greater flexibility because not all information needs to be made available to the limited authority internal users. The techniques herein also provide practical improvements because these solutions and forecasts using real data are more accurate and realistic than assumptions based on artificially generated data. These techniques also have benefits for creating robust control schemes and DOEs, because the objective functions and frameworks lower the risk of human bias that may be introduced.

The techniques disclosed herein enable flexibility on the part of information asymmetries between PNOs and end users. For example, an end user may have the knowledge they have consented to allow certain levels of control or communicated information over specific appliances or assets at a service site. The end user will have the freedom and autonomy to act without having sacrificed total control, receive incentives associating with participating, etc. The end user can, according to the techniques herein, also be confident that their activity is more optimal and tuned specifically to their status and/or peculiarities. The PNO can receive additional information regarding appliances and assets at service sites “behind the meter,” which is useful for managing grids and may be commercially useful, while also being able to rely on the DOE to separate from harvesting data in order to comply with privacy regulation or privacy concerns/obligations.

### FIGURE DISCUSSION

The techniques described herein can be implemented in a number of ways. Example implementations are provided below with reference to the following figures. Although discussed in the context of a specific electric grid, the systems, methods, and apparatuses described herein can be applied to a variety of systems (e.g., water grids, internet grids, gas grids, fiber-optic networks, cellular networks, financial dependency networks, non-utility networks where distributed inputs/outputs are relevant), and is not limited to electric grids. In another example, the techniques can be utilized on an internet storage system. Additionally, the techniques described herein can be used with real data, simulated data, or any combination of the two.

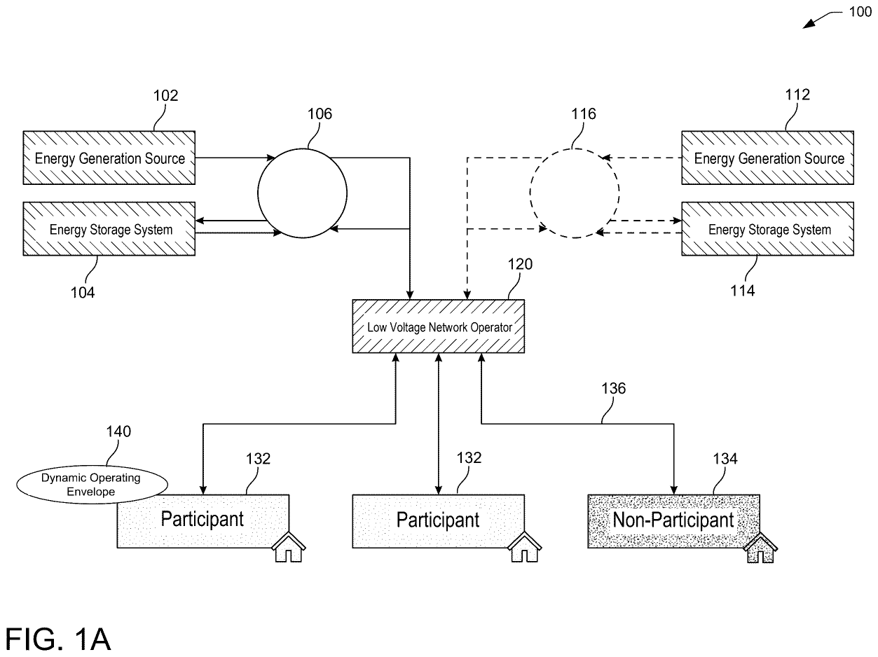

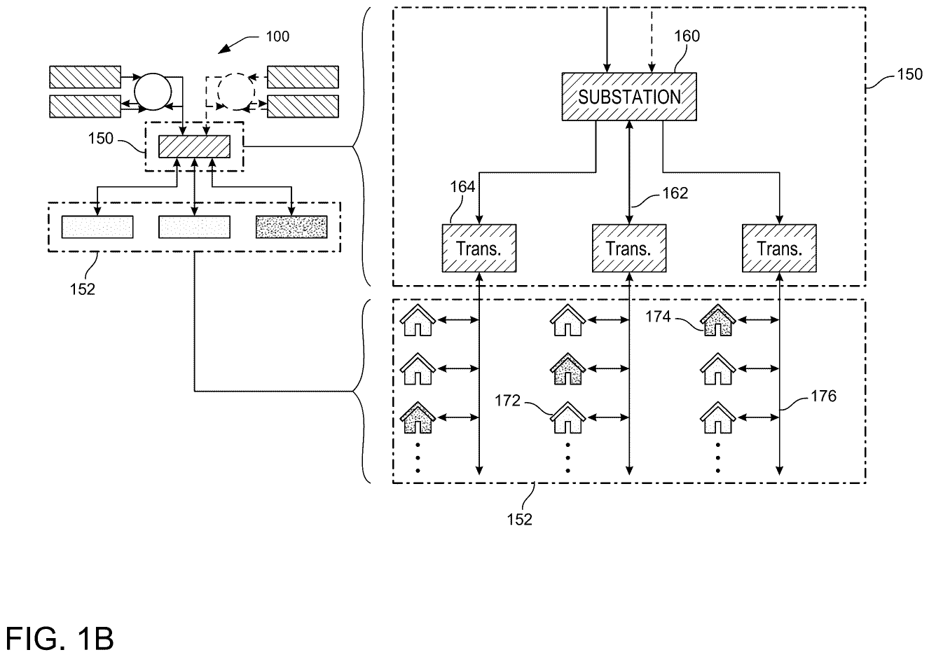

FIG. 1A is a schematic view of a network managed by an LVDERMS. In the illustrated example, network 100 has a PNO who is a low voltage network operator (LVNO) 120. The network includes an electricity generation source 102, an energy storage system (ESS) 104, and an upstream connection 106. Electricity generation source 102, ESS 104, and connection 106 may all be high voltage assets, while in other examples, electricity generation source 102, ESS 104, and/or connection 106 may be low voltage assets. Electricity generation source 102, ESS 104, and/or connection 106 may be managed by the same PNO, illustrated by the solid lines. In alternate examples, the PNO may not manage any generators, ESS, or upstream connections directly. As can be illustrated by the bidirectional solid arrows connecting LVNO 120 to connection 106 and ESS 104, energy may be provided to be stored into an ESS 104 in addition to being retrieved. The generator also provides energy which may be routed to the LVNO 120 and/or the ESS 104. Connection 106 may represent a connection of the energy generation source(s), energy storage device(s), and the low voltage network operator assets such as substations. The connection 106 may, in some examples without limitation, include upstream electrical network(s), electrical connection(s), and/or device(s) which regulate the flow of power between the electricity generation sources, electricity storage systems, and other low voltage network operator assets. While in this example a single connection 106 is shown, in other examples multiple such connections 106 may be included, and may comprise multiple instances and/or combinations of the various configurations of connections 106.

The network 100 may also include additional generator(s) 112, ESS(s) 114, and/or upstream connection(s) 116. These may be similar to electricity generation source 102, ESS 104, and/or connection 106. However, as illustrated by the dashed lines, generator(s) 112, ESS(s) 114, and/or upstream connection(s) 116 may be managed by a different operator or be at a different voltage level. For example, a PNO may purchase additional power or request power be stored by a different provider, such as an ADMS network operator, therefore interfacing through the dashed lines to generator(s) 112, ESS(s) 114, and/or upstream connection(s) 116.

The LVNO 120 may then have bidirectional connections 136 with multiple service sites downstream. Connections 136 and the connections between the LVNO and the upstream assets may be electrical connections, in addition to representing other forms of connection such as communication connections or information transmission channels. These service sites may be categorized into participant service sites 132 and non-participant service sites 134. The connections 136 may indicate receiving information, transmitting electricity, and/or communicating a DOE according to the techniques described herein. One or more participant service sites 132 may include a Dynamic Operating Envelope (DOE) 140. This may have been transmitted along with the associated connection 136.

FIG. 1B is an additional schematic view of a network 100 managed by an LVDERMS. In this illustration, a first portion 150 of the infrastructure managed by the LVNO has been expanded to illustrate one exemplary substation 160 connected to various transformers 164 by connections 162. The connections 162 may be reciprocal and allow the flow of electricity as input and output. The transformers may be connected to a second portion 152 of the infrastructure which has been expanded to illustrate various service sites. The service sites in the second portion 152 may be participants 172 or non-participants 174 distributed (in this example) heterogeneously under various transformers. The service sites may be connected to the transformers by connections 176.

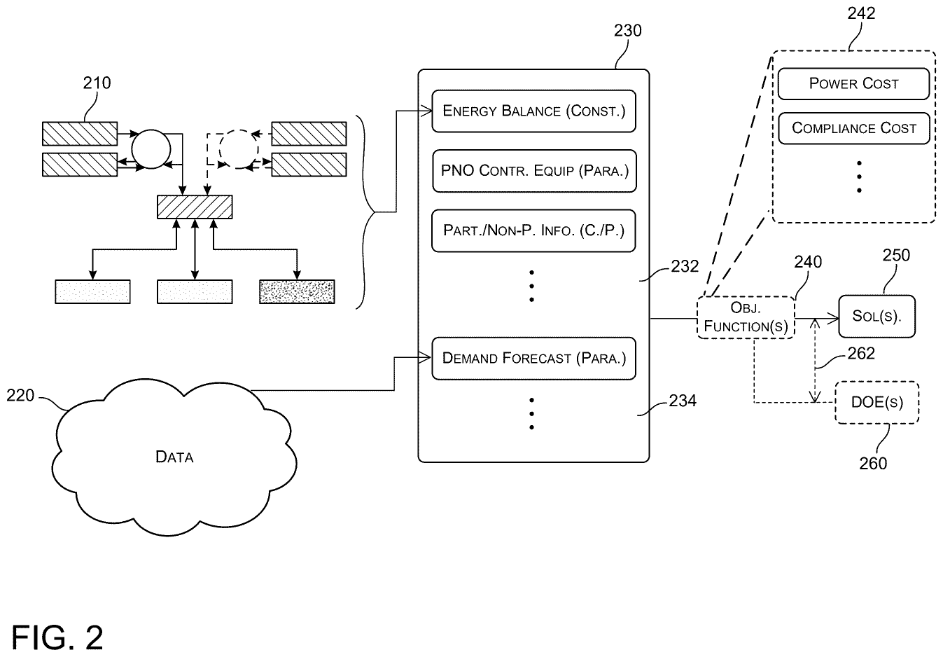

FIG. 2 represents an example of using an implemented framework from the perspective of a PNO. This illustration corresponds at least in part to the previously-discussed fifth exemplary framework. Information from a network 210 corresponding to the network of FIGS. 1A-B, comprising assets corresponding to the energy generation sources, ESS, and LVNO of FIGS. 1A-B, non-participants, and participants comprises a portion of the set 230 of objective function elements. A plurality of elements 232 may be derived, which may serve as constraints and/or parameters. In this figure, as exemplary elements 232, energy balance is a constraint element from network 210, PNO controllable equipment information is a parameter from network 210, and the information with respect to participant and non-participant service sites can be used as both a constraint and/or a parameter from network 210. Additional elements 234 may be derived from data 220. In this figure, as an exemplary element 234, the demand forecast is a parameter from data 220. In some examples, elements 232 and 234 may be the same, in other examples they may be different. In some examples, constraints may be elements 232, and parameters may be elements 234. These elements 232 and 234 may then be used by objective function(s) 240 to determine solution(s) 250 for various goal(s) which may be based at least in part on the set 230 of elements. Objective function(s) 240 may include objectives 242, some of which (power cost, compliance cost) are listed as examples in FIG. 2. Objective function(s) 240 may also be used to determine DOE(s) 260, which may then be conveyed (e.g. by an operation 262) when the objective function(s) 240 determine solution(s) 250.

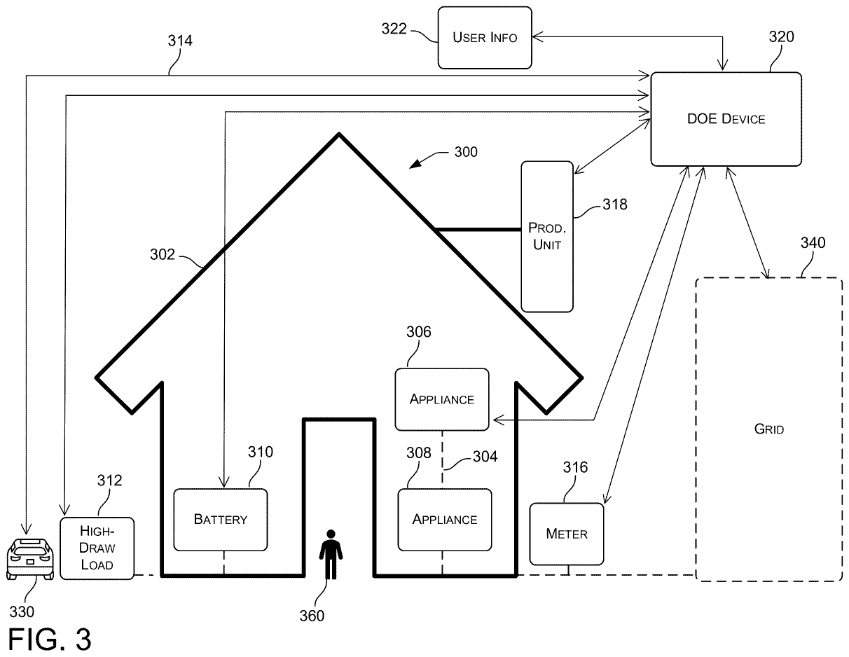

FIG. 3 is a schematic view representing an example service site 300 at a premises 302. The service site 300 may have an electric wiring 304 connected to energy loads such as appliances 306 and 308 as well as high-draw use 312 (such as a high-draw load). The electric wiring 304 may also be connected to energy storage such as battery 310. The high-draw use 312 may be, for example, a charging of an electric vehicle 330. The electric wiring 304 may also include a local energy source/generation such as production unit 318, which may be a solar panel or similar source. Non-limiting examples of such similar source(s) include solar energy source(s) (passive, photovoltaic, etc.), wind energy source(s), hydroelectric energy source(s), heat pump energy source(s) (air heat pump, ground heat pump, etc.), kinetic energy source(s), geothermal energy source(s), biomass energy source(s) (digestion, burning, gasification, etc.), and/or fuel energy source(s) (fossil fuel, natural gas, coal, gasoline, diesel, reactor, etc.). Electric wiring 304 may also be connected to an electricity network (grid 340), which may be managed by a PNO. This connection to the grid 340 may be governed at least in part by meter 316. A DOE device 320, which may be local, may be in the cloud, may be remote, may be at a central location, may be associated with the meter, may be distributed in portions across various computing devices, may be on a cellular device associated with an end user 360 (who may or may not be at the premises), etc. is also illustrated. This DOE device may determine a DOE or receive a DOE. The DOE device 320 can be any computing device capable of determining, receiving, or otherwise obtaining the DOE and controlling the grid connected assets (generation, storage, loads, etc.) or coordinating with one or more other devices to control the grid connected assets according to the DOE. The DOE device 320 has bilateral connections 314 with various assets associated with service site 300, including user info 322. Hence, the DOE device 320 may receive information from the various appliances, batteries, grid, meter, production units, vehicles, etc. However, the DOE device 320 may not receive information for all devices at the service site, such as for example appliance 308 which in this example lacks the ability to communicate directly with the DOE device 320 and whose information may be indirectly transferred via the meter 316. Additionally, the DOE device 320 may be able to, according to the techniques herein, determine one or more controls which it may implement via the connections 314. The connections 314 may be one or more of wired, Wi-Fi, Bluetooth®, etc.

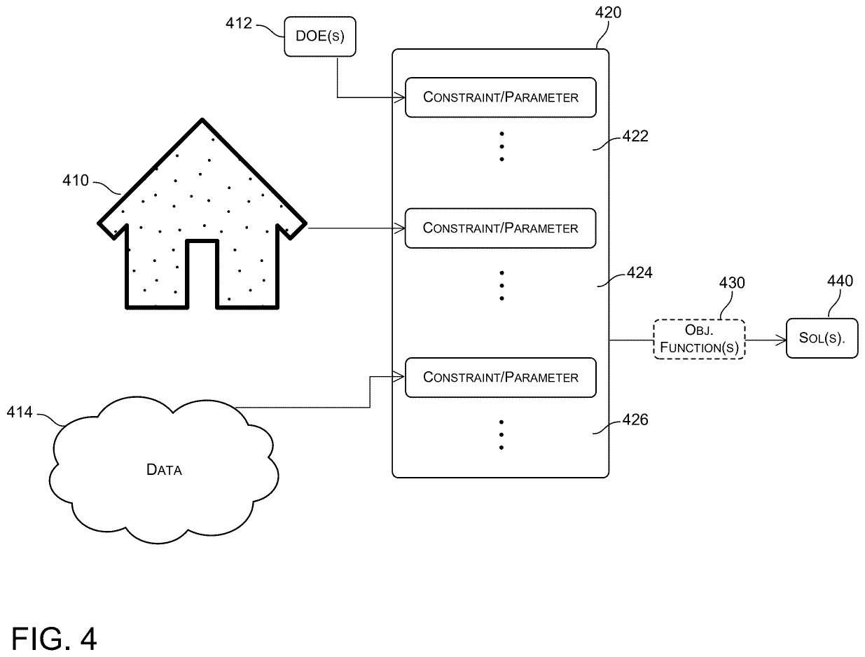

FIG. 4 is a similar schematic diagram to FIG. 2. Here, the set of elements 420 includes information from participant premises 410, data 414 (which may include information on non-participant premises), and information from DOE(s) 412. This may result in DOE-associated elements 422, service site elements 424, and other elements 426. The set of elements 420 may be used by objective function(s) 430 to determine solution(s) 440. This is similar to any of exemplary end user perspective framework(s) 1-5.

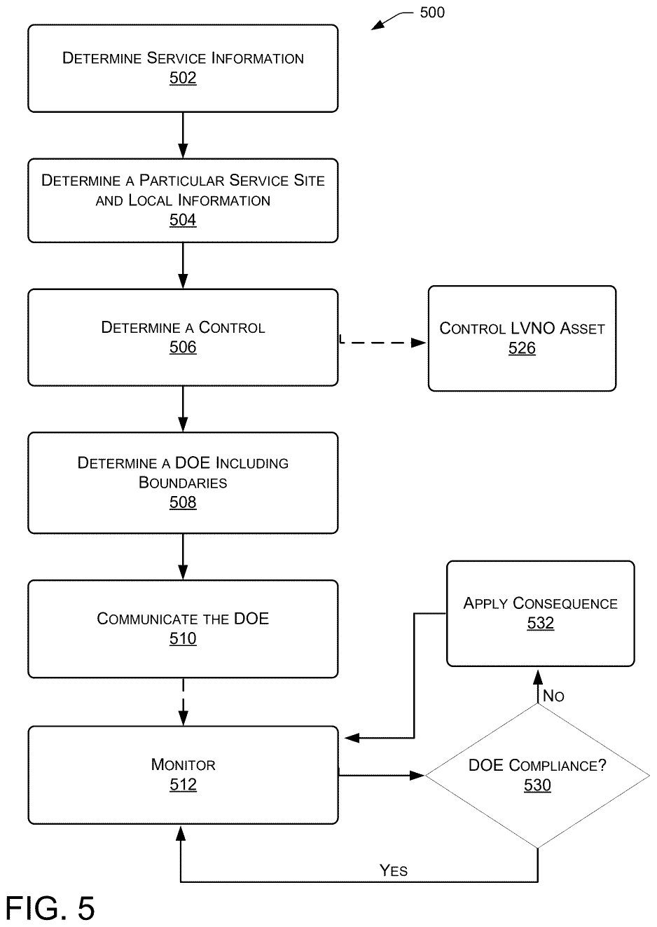

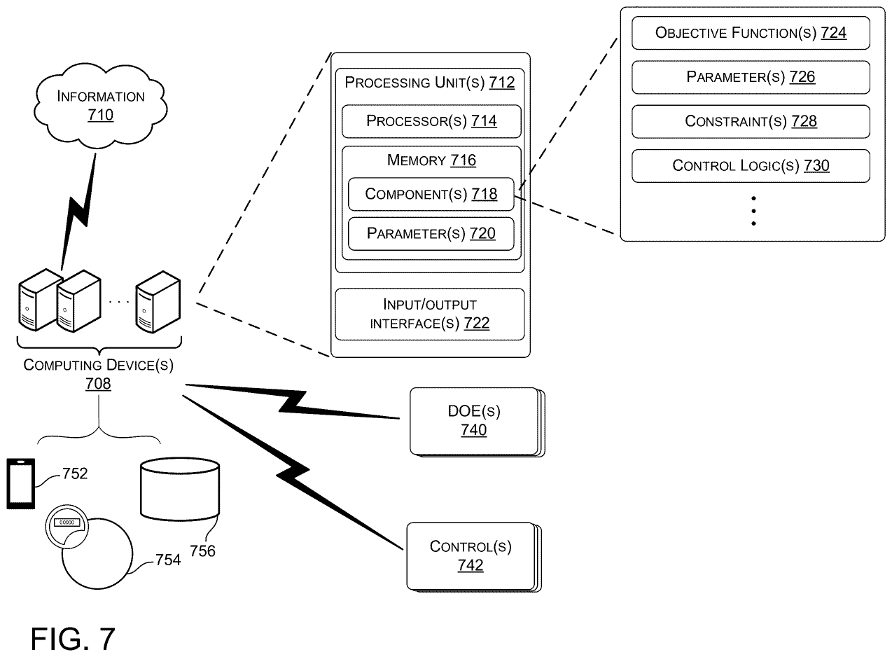

FIG. 5 illustrates a flowchart depicting an example process 500. For example some or all of the process 500 may be performed by one or more components in FIG. 7, as described herein. For example, some or all of the process 500 may be performed by the computing device(s) 708.

At operation 502, the process 500 determines service information, such as an amount of electricity production available for provision to a plurality of service sites served by an electricity network operator operating an electricity grid (of which FIGS. 1A-B are examples), where the electricity grid may include at least one low voltage network portion, at least one power storage source and receives energy from at least one power generation source. The plurality of service sites may comprise participant service sites and non-participant service sites. This service information may be partially pre-processed service information or raw service information to be processed at operation 502 or later operations. This may be determined on a computing device or received over an internet or intranet network. In other examples, the service information may be manually input or provided directly to the process via stored memory. In some examples, operation 502 may dynamically or simultaneously receive additional information, for example as part of a pipeline.

At operation 504, the process 500 determines a particular service site and local information. The particular service site may be determined based at least in part on a classification, such as a participation, hence the particular service site may be a particular participant service site. The particular service site may be associated with or include the local information. The local information may represent that the particular service site includes at least one of a local energy generation source, a local energy storage device, or one or more loads. In some examples, the determination may be deterministic or based at least in part on an input. In other examples, operation 504 may dynamically adapt to additional datasets or information.

At operation 506, a control may be determined. This may be a passive control, an active control, or another form of control. This may be performed based at least in part on the service site, local information, and/or service information. This may be performed by using an objective function as part of a framework as previously discussed. The framework may be selected for implementation in order to determine this control at operation 506 in a variety of ways, as previously discussed. For brief illustration, this may be based on information associated with the service or local information, specific parameters (e.g., user input, company policy, intended use of the process, computational efficiency, user/PNO needs, geographic information, demographic information, alterations for testing, predictions, assumptions, commercial value), or underlying data information associated with data (e.g., geographic information, demographic information, consumption data, equipment information) included in the information handled by the framework and process 500. This information may include examining features of the information, the PNO network, and the service sites and/or determining similarities between various features. This operation 506 may also include pre-defined and/or dynamic thresholds by which the information, parameters, and/or determined similarities may be used to determine appropriate framework. This may be performed probabilistically or deterministically, and may be performed by a trained machine-learned model or algorithmic computer program. This operation 506 may include predictions regarding the control, an evaluation of the control after operation 508 (DOE) to check for further control needs, and/or a determined sequence of controls to be executed. Operation 506 may perform some of its determinations as part of an evaluation of the information only after at least one execution of operation 508 to increase computational efficiency. For example, operation 506 may evaluate the information for control after operation 508 performs a DOE determination to check for issues that would merit additional processing. Operation 506 may also subdivide the information or perform other forms of processing to prepare the information for operation 508. Operation 506 may determine that only one or multiple portions of the information is useful. In some examples, operation 506 may determine that no additional control is necessary for part or all of the assets managed by DOEs determined in operation 508, thereby determining that the DOE of operation 508 is the control of operation 506. In some examples, operation 506 may dynamically adapt to additional information or inputs.

At operation 508, a DOE including a set of boundaries may be determined. This may be based at least in part on an objective function using the amount of electricity production available to the plurality of service sites. The DOE may define an amount of power that the particular participant service site is permitted to put onto or take off the electricity grid during a period of time. Operation 508 may be implemented in parallel to operation 506, and may be implemented by parallel processing or subdividing the service or local information. Operation 508 may be the entire control of operation 506, or only a portion. Operation 508 may dynamically adapt to additional information or inputs.

At operation 510, the DOE may be communicated. This may be communicated to the PNO, a third party, or an end user. This may be communicated along with additional control(s) from operation 506. Operation 510 may include a verification that the communication/DOE meets certain parameters or needs. The communication may directly communicate the boundaries, may communicate an indication, may communicate an action, and/or may communicate a visual representation. Operation 510 may configure the DOE and/or additional information to meet the parameters and needs, such as communicability. In some examples, those needs may be visualizing or efficiency. In other examples, operation 510 may prepare the DOE for storage in memory, storage on the cloud, input to another process, regulatory activity, and/or commercial activity. The DOE may be provided to a machine-learning model as input or training, may be provided to a human for inspection, or further analyzed as a metric or metadata. In some examples, only one DOE is communicated, while in other examples multiple DOEs may be output to cover various scenarios or times.

FIG. 5 also demonstrates two additional optional operations: operation 526 and operation 512. In some examples, a control determined at operation 506 may include control of an LVNO asset. In that case, the process 500 may comprise implementing the control of the LVNO asset as shown in operation 526, which may include controlling at least one of a network operator managed generation source, a network operator managed distribution source, or a network operator managed storage device to balance a power consumption with a power provided at least in part by the local energy generation source or the local energy storage device.

Operation 512 may include monitoring service site(s) for consumption, and/or compliance with the DOE. Operation 530 may include a decision, based on the monitoring operation 512. This may include a binary decision (yes/no) and a “no” may determine execution of an operation 532 applying consequence(s) such as a penalty or direct control. In other implementation(s) the binary decision may represent whether or not the DOE was violated, hence a “yes” decision would result in operation 532. Following operation 532 and/or upon receiving a “no” decision in operation 530, the process may return to monitoring in operation 530. Operation 530 may include a decision based at least in part on the service site exceeding the boundaries placed by the DOE. This may execute for an amount of time and/or number of iterations.

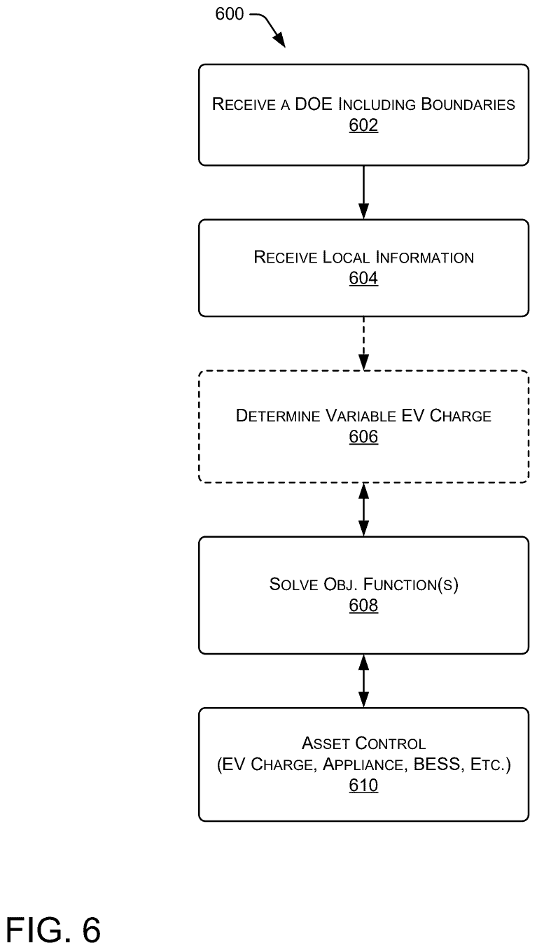

FIG. 6 illustrates a flowchart depicting an example process 600. For example some or all of the process 600 may be performed by one or more components in FIG. 7, as described herein. For example, some or all of the process 600 may be performed by the computing device(s) 708.

At operation 602, the process 600 receives a DOE including boundaries. This receiving may be performed by a device associated with a service site. These boundaries may be on a first amount of power that the service site is permitted to put onto an electricity grid during a period of time and a second amount of power that the service site is permitted to draw from the electricity grid during the period of time. This DOE may be based at least in part on service information. This service information may be partially pre-processed service information or raw service information to be processed at operation 602 or later operations. This may be determined on a computing device or received over an internet or intranet network. In other examples, the service information may be manually input or provided directly to the process via stored memory. This may be received from the PNO. In some examples, operation 602 may dynamically or simultaneously receive additional information, for example as part of a pipeline.

At operation 604, the process 600 determines local information. The local information may include a classification, such as a participation. The local information may be associated with local power generation, local power storage, and local power demand, hence representing that the service site includes at least one of a local energy generation source, a local energy storage device, or one or more loads. The local information may describe information associated with end-use equipment associated with a premises. The premises may be connected to an electric grid managed by a PNO and associated with the service site. In some examples, the local information may be deterministic or based at least in part on an input. In some examples, the local information may be associated with local power generation, local power storage, and local power demand over multiple periods of time. In other examples, operation 604 may dynamically adapt to additional datasets or information.

At operation 606, a variable EV charge level may be determined. Operation 606 may be an optional operation, and may correspond to features of the fifth exemplary framework from the end user perspective as previously discussed. The variable charge level may be determined based at least in part on the dynamic operating envelope. The variable charge level may be determined based at least in part on an objective function, and may be performed in parallel, in sequence, and/or after operations 608 and 610.

At operation 608, one or more objective functions may be solved based at least in part on the local information and the DOE from operations 602 and 604. This objective function may be associated with features of one of the previously discussed frameworks. This objective function may be based at least in part on operation 606.

At operation 610, a control may be determined. This may be a passive control, an active control, or another form of control. This control may alter at least one of the local power generation, the local power storage, or the local power demand to maintain a power draw from, or a power put onto, the electricity grid This may be performed based at least in part on the other operations 602-608. This may be performed by using the solutions of an objective function as part of a framework as previously discussed.

The framework may be selected for implementation in order to determine this control at operations 606-610 in a variety of ways, as previously discussed. For brief illustration, this may be based on information associated with the service or local information, specific parameters (e.g., user input, company policy, intended use of the process, computational efficiency, user/PNO needs, geographic information, demographic information, alterations for testing, predictions, assumptions, commercial value), or underlying data information associated with data (e.g., geographic information, demographic information, consumption data, equipment information) included in the information handled by the framework and process 500. This information may include examining features of the information, the PNO network, and the service sites and/or determining similarities between various features. This operation 606-610 may also include pre-defined and/or dynamic thresholds by which the information, parameters, and/or determined similarities may be used to determine appropriate framework. This may be performed probabilistically or deterministically, and may be performed by a trained machine-learned model or algorithmic computer program. This operation 606-610 may include predictions regarding the control, an evaluation of the control after operations 606-610 to check for further control needs, and/or a determined sequence of controls to be executed. Operations 606-610 may perform some of their determinations as part of an evaluation of the information only after at least one execution of another operation to increase computational efficiency. For example, operation 608 may solve its objective function(s) after operation 606 performs an EV determination to check for issues that would merit additional processing. Operation 610 may also subdivide the information or perform other forms of processing to prepare the information for implementing control(s). Operations 606-610 may determine that only one or multiple portions of the information is useful. In some examples, operations 606-610 may determine that no additional control is necessary for part or all of the assets due to the EV charging control(s), thereby determining that the solution(s) in operation 606 are the solution(s) of operation 608 and control of 610.

Operation 610 may include a verification that the control meets certain parameters or needs. The control may directly control the assets, may communicate an indication, may communicate an intention, may indicate a plan, may indicate a forecast, and/or may communicate a visual representation. Operation 610 may configure the control to meet the parameters and needs, such as communicability. In some examples, those needs may be a visualization, priorities, or efficiency. In other examples, operation 610 may prepare the determined solution(s) for storage in memory, storage on the cloud, input to another process, regulatory activity, and/or commercial activity. The solution(s) may be provided to a machine-learning model as input or training, may be provided to a human for inspection, or further analyzed as a metric or metadata. In some examples, only one solution/plan/control is communicated/implemented, while in other examples multiple may be output to cover various scenarios or times. In some examples, operation 610 may dynamically adapt to additional information or inputs.

FIG. 7 is a schematic view of computing device(s) configured to execute exemplary techniques according to the frameworks associated with the PNO perspective. The computing device(s) 708 may receive information 710 (which may be received through input/output interface(s) 722) and may output DOE(s) 740 and/or control(s) 742. The DOE(s) 740 and/or control(s) 742 (e.g. load control(s), generation control(s), storage control(s), direct control(s), communication(s), penalty(s)) may be configured according to certain requirements, which may be reflected in parameter(s) 720 and/or information 710, and output through input/output interface(s) 722. The computing device(s) may include processing unit(s) 712. Processing unit(s) 712 may include processor(s) 714 and memory 716. Memory 716 may include one or multiple components 718, and may include one or multiple parameters 720. In some examples, the DOE(s) 740 may correspond to the frameworks associated with the PNO perspective and the control(s) 742 may correspond to the frameworks associated with the end user perspective. In some examples computing device(s) 708 may be capable of outputting both the DOE(s) 740 and the control(s) 742, in other examples the computing device(s) may output one or the other depending upon a framework implemented.

The computing device(s) may, as shown by way of example in FIG. 7, be included in multiple computing configurations. Examples include user device(s) 752 (e.g. smartphones, personal computers, internet of things (IoT) devices, handheld devices, smart watches, minicomputers, mainframe computers, vehicle mounted computers, ESS-associated computers), electric meters 754, and centralized processing devices (such as databases) 756.

The component(s) 718 may include component(s) which process, by way of example and not limitation: objective function(s) 724 similar to those previously discussed; parameter(s) 726 which may be processed, translated, and/or extracted from the information 710; constraint(s) 728 as previously discussed; control logic(s) 730 which govern the determination and/or analysis of control(s) as previously discussed, and/or additional processes.

The component(s) 718 may be or may include non-transitory computer readable media, as in this example. However, component(s) 718 may, in other examples, be computing device(s) 708, processing unit(s) 712, or processor(s) 714. In other examples, component(s) 718 and/or computing device(s) 708 may be specifically printed chips optimized to perform the techniques disclosed herein, or logic circuits which perform the techniques herein based on instructions that may be encoded in software, hardware, or a combination of the two.

Processing unit(s) 712 may also include input/output interface(s) 722 which may be used to input information 710, parameter(s) 720, memory 716, or other information. Input/output interface(s) 722 may also be used to output DOE(s) 740 and/or control(s) 742, or other information. Input/output interface(s) 722 may also facilitate input/output between multiple computing device(s) 708, processing unit(s) 712, or component(s) 718. Input/output interface(s) 722 may receive or dispense information via network or direct memory.

It should be noted that while FIG. 7 is illustrated as an associated system, in alternative example components of the computing device(s) 708 may be distributed. Further, aspects of the various processes and frameworks can be performed on any of the devices discussed herein.

FIGS. 1-7 illustrate example processes in accordance with examples of the disclosure. These processes are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

The methods described herein represent sequences of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes. In some embodiments, one or more operations of the method may be omitted entirely. Moreover, the methods described herein can be combined in whole or in part with each other or with other methods.

The various techniques described herein may be implemented in the context of computer-executable instructions or software, such as program modules, that are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

### EXAMPLE CLAUSES

A: A system comprising: one or more processors; and one or more non-transitory computer-readable media storing instructions that, when executed by the one or more processors, cause the system to perform operations comprising: determining an amount of electricity available for provisioning to a plurality of service sites served by an electricity network operator operating an electricity grid, wherein the electricity grid comprises a low voltage grid; determining a particular service site, from among the plurality of service sites, that includes a load and at least one of a local energy generation source or a local energy storage device; using an objective function to determine a dynamic operating envelope for the particular service site, wherein the dynamic operating envelope defines, as a portion of the amount of electricity available to the plurality of service sites, an amount of power that the particular service site is permitted to put onto or take off the electricity grid during a period of time; and communicating the dynamic operating envelope to the particular service site.
B: The system of paragraph A, wherein the operations further comprise controlling at least one of a network operator managed generation source, a network operator managed distribution source, or a network operator managed storage device to balance a power consumption with a power provided at least in part by the local energy generation source or the local energy storage device.
C: The system of paragraph A or B, wherein the plurality of service sites comprise participant service sites and non-participant service sites; the particular service site is a particular participant service site; and the dynamic operating envelope is determined for the particular service site based at least in part on an amount of power associated with the non-participant service sites.
D: The system of any of paragraphs A-C, wherein the operations further comprise: monitoring a net power put onto the electricity grid or taken off the electricity grid by the particular service site during the period of time; determining whether the net power put onto the electricity grid or taken off the electricity grid by the particular service site during the period of time exceeds the amount of power that the particular service site is permitted by the dynamic operating envelope to put onto the electricity grid or take off the electricity grid during the period of time; and applying a consequence to the particular service site based at least in part on the net power exceeding the amount of power that the particular service site is permitted by the dynamic operating envelope to put onto the electricity grid or take off the electricity grid during the period of time.
E: The system of any of paragraphs A-D, wherein the operations further comprise: managing, by the particular service site and based at least in part on the dynamic operating envelope, at least one of the local energy generation source or the local energy storage device to maintain a net power put onto the electricity grid or taken off the electricity grid by the particular service site during the period to be within the amount of power that the particular service site is permitted by the dynamic operating envelope to put onto the electricity grid or take off the electricity grid during the period of time.
F: The system of any of paragraphs A-E, wherein the objective function comprises at least one objective, and the at least one objective is at least one of: a minimum total power delivery cost, a minimum power generation cost, a minimum power storage cost, a minimum control cost, a minimum participation opportunity cost, or a minimum dynamic operating envelope compliance cost.
G: A method comprising: determining, by an electricity network operator operating an electricity grid, an amount of electricity available for provisioning to a plurality of service sites served by the electricity network operator; determining a particular service site, from among the plurality of service sites, that includes at least one of a local energy generation source, a local energy storage device, or a load; using an objective function to determine a dynamic operating envelope for the particular service site, wherein the dynamic operating envelope defines a set of boundaries comprising an amount of power that the particular service site is permitted to put onto or take off the electricity grid during a period of time, and wherein the amount of power that the particular service site is permitted to put onto or take off the electricity grid is a portion of the amount of electricity available to the plurality of service sites; and communicating the dynamic operating envelope to the particular service site.
H: The method of paragraph G, wherein the electricity grid comprises a low voltage grid and receives energy from an energy generation source.
I: The method of paragraph H, wherein the electricity grid includes an energy storage device, and wherein the dynamic operating envelope is based at least in part on a status of the energy storage device.
J: The method of paragraph I, further comprising: monitoring a received power provided by the energy generation source and the status of the energy storage device; monitoring a net power associated with the particular service site during the period of time; and based at least in part on the dynamic operating envelope, at least one of controlling a network operator managed asset or applying a consequence to the particular service site.
K: The method of any of paragraphs G-J, wherein the plurality of service sites comprise: a first plurality of non-participant service sites, and a second plurality of participant service sites including the particular service site; and wherein the dynamic operating envelope is determined for the particular service site based at least in part on an amount of power associated with the first plurality of non-participant service sites.
L: The method of any of paragraphs G-K, wherein the set of boundaries indicated by the dynamic operating envelope are based at least in part on the amount of electricity available for provisioning to the plurality of service sites during the period of time and an amount of power available for provisioning during another period of time.
M: The method of any of paragraphs G-L, further comprising: determining, based at least in part on the dynamic operating envelope, a forecast associated with the electricity grid.
N: The method of any of paragraphs G-M, wherein the dynamic operating envelope is based at least in part on an objective function, wherein the objective function comprises a plurality of function elements associated with at least one of grid information, service site information, status information, or objective function parameter information.
O: The method of paragraph N, wherein the objective function comprises at least one objective, and the at least one objective is at least one of: a minimum total power delivery cost, a minimum power generation cost, a minimum power storage cost, a minimum control cost, a minimum participation opportunity cost, or a minimum dynamic operating envelope compliance cost.
P: The method of any of paragraphs G-O, wherein the local energy generation source is at least one of a solar energy source, a wind energy source, a hydroelectric energy source, a heat pump energy source, a geothermal energy source, a biomass energy source, or a fuel energy source.
Q: One or more non-transitory computer-readable media storing instructions that, when executed by one or more processors, cause the one or more processors to perform operations comprising: determining an amount of electricity available for provisioning to a plurality of service sites served by an electricity network operator that is operating an electricity grid, wherein the electricity grid includes a low voltage grid and a network operator managed energy storage device, and wherein the electricity grid receives energy from at least one high or medium voltage energy generation source; determining a particular service site, from among the plurality of service sites, that includes at least one of a local energy generation source, a local energy storage device, or a load; using an objective function to determine a dynamic operating envelope for the particular service site, wherein the dynamic operating envelope defines, as a portion of the amount of electricity available to the plurality of service sites, an amount of power that the particular service site is permitted to put onto or take off the electricity grid during a period of time; and communicating the dynamic operating envelope to the particular service site.
R: The one or more non-transitory computer-readable media of paragraph Q, wherein the operations further comprise: monitoring a power provided by the at least one high or medium voltage energy generation source; monitoring a status of the network operator managed energy storage device, wherein the dynamic operating envelope is based at least in part on the status of the network operator managed energy storage device; monitoring a power consumption of the electricity grid; and controlling, based at least in part on the dynamic operating envelope, a network operator managed asset to balance the power consumption with the power provided by the at least one high or medium voltage energy generation source and the network operator managed energy storage device.
S: The one or more non-transitory computer-readable media of paragraph Q or R, wherein the operations further comprise: monitoring a net power associated with the particular service site during the period of time; and based at least in part on the dynamic operating envelope, applying a consequence to the particular service site.
T: The one or more non-transitory computer-readable media of any of paragraphs Q-S, wherein the plurality of service sites comprise participant service sites and non-participant service sites; the particular service site is a particular participant service site; and the dynamic operating envelope is determined for the particular participant service site based at least in part on an amount of power associated with the non-participant service sites.
U: The one or more non-transitory computer-readable media of any of paragraphs Q-T, wherein the amount of power indicated by the dynamic operating envelope varies based at least in part on multiple periods of time.
V: The one or more non-transitory computer-readable media of any of paragraphs Q-U, wherein the objective function comprises at least one objective, and the at least one objective is at least one of: a minimum total power delivery cost, a minimum power generation cost, a minimum power storage cost, a minimum control cost, a minimum participation opportunity cost, or a minimum dynamic operating envelope compliance cost.
W: A system comprising: one or more processors; and one or more non-transitory computer-readable media storing instructions that, when executed by the one or more processors, cause the system to perform operations comprising: receiving, from a network manager of an electricity grid and by a device at a service site, a dynamic operating envelope defining boundaries on a first amount of power that the service site is permitted to put onto the electricity grid during a period of time and a second amount of power that the service site is permitted to draw from the electricity grid during the period of time; receiving local information associated with local power generation, local power storage, and local power demand associated with the service site over multiple periods of time; and controlling, based at least in part on the dynamic operating envelope, at least one of the local power generation, the local power storage, or the local power demand to maintain a power draw from, or a power put onto, the electricity grid over the multiple periods of time.
X: The system of paragraph W, wherein controlling at least one of the local power generation, the local power storage, or the local power demand is based at least in part on: an objective function that uses a set of function elements associated with local asset management and end user needs; the dynamic operating envelope and compliance with the dynamic operating envelope; and a decision horizon comprising the multiple periods of time.
Y: The system of paragraph X, wherein the objective function comprises at least one objective, and the at least one objective is at least one of: a minimum net power services cost, a minimum power generation cost, a minimum power storage cost, a minimum control cost, a minimum participation opportunity cost, a minimum equipment cost, a minimum user need cost, or a minimum dynamic operating envelope compliance cost.
Z: The system of any of paragraphs W-Y, further comprising: determining a variable charge level to which to charge an electric vehicle associated with the service site based at least in part on the dynamic operating envelope and a minimum acceptable range; and charging the electric vehicle to the variable charge level.
AA: The system of any of paragraphs W-Z, wherein the dynamic operating envelope is based at least in part on at least one of a network energy storage device or a network energy generation source associated with the network manager of the electricity grid.
AB: A method comprising: receiving, by a device associated with a service site, a dynamic operating envelope defining boundaries on a first amount of power that the service site is permitted to put onto an electricity grid during a period of time and a second amount of power that the service site is permitted to draw from the electricity grid during the period of time; receiving local information associated with local power generation, local power storage, and local power demand; and controlling, as a control, at least one of the local power generation, the local power storage, or the local power demand to maintain a power draw from, or a power put onto, the electricity grid.
AC: The method of paragraph AB, wherein: the dynamic operating envelope is received from a network manager; the local information is associated with an end user connected, at a premises, to the electricity grid, the electricity grid being managed by the network manager; and the local information further describes power supply, power storage, and power demand associated with end-use equipment associated with the premises.
AD: The method of paragraph AB or AC, wherein the local information is associated with local power generation, local power storage, and local power demand over multiple periods of time.
AE: The method of any of paragraphs AB-AD, wherein controlling at least one of the local power generation, the local power storage, or the local power demand is based at least in part on an objective function using a set of function elements.
AF: The method of paragraph AE, wherein the objective function comprises at least one objective, and the at least one objective is at least one of: a minimum net power services cost, a minimum power generation cost, a minimum power storage cost, a minimum control cost, a minimum participation opportunity cost, a minimum equipment cost, a minimum user need cost, or a minimum dynamic operating envelope compliance cost.
AG: The method of paragraph AE or AF, wherein the objective function uses a decision horizon comprising multiple periods of time.
AH: The method of any of paragraphs AB-AG, further comprising: determining a variable charge level to which to charge an electric vehicle associated with the service site based at least in part on the dynamic operating envelope; and charging the electric vehicle to the variable charge level.
AI: The method of any of paragraphs AB-AH, wherein the dynamic operating envelope is based at least in part on at least one of a network energy storage device or a network energy generation source associated with a network manager of the electricity grid.
AJ: The method of any of paragraphs AB-AI, wherein the control occurs at multiple times during multiple periods of time.
AK: The method of any of paragraphs AB-AJ, further comprising: determining, based at least in part on the control, a forecast associated with the service site.
AL: One or more non-transitory computer-readable media storing instructions that, when executed by one or more processors, cause the one or more processors to perform operations comprising: receiving, from a network manager of an electricity grid and by a device at a service site, a dynamic operating envelope defining boundaries on a first amount of power that the service site is permitted to put onto the electricity grid during a period of time and a second amount of power that the service site is permitted to draw from the electricity grid during the period of time; receiving local information associated with local power generation, local power storage, and local power demand associated with the service site over multiple periods of time; and controlling, as a control and based at least in part on the dynamic operating envelope, at least one of the local power generation, the local power storage, or the local power demand to maintain a power draw from, or a power put onto, the electricity grid over the multiple periods of time.
AM: The one or more non-transitory computer-readable media of paragraph AL, wherein controlling at least one of the local power generation, the local power storage, or the local power demand is based at least in part on an objective function using a set of function elements, the dynamic operating envelope, and a decision horizon comprising the multiple periods of time.
AN: The one or more non-transitory computer-readable media of paragraph AM, wherein the objective function comprises at least one objective, and the at least one objective is at least one of: a minimum net power services cost, a minimum power generation cost, a minimum power storage cost, a minimum control cost, a minimum participation opportunity cost, a minimum equipment cost, a minimum user input cost, or a minimum dynamic operating envelope compliance cost.
AO: The one or more non-transitory computer-readable media of any of paragraphs AL-AN, further comprising: determining a variable charge level to which to charge an electric vehicle associated with the service site based at least in part on the dynamic operating envelope and a minimum acceptable range, wherein the minimum acceptable range is based at least in part on a range anxiety value; and charging the electric vehicle to the variable charge level.
AP: The one or more non-transitory computer-readable media of any of paragraphs AL-AO, further comprising: determining, based at least in part on the control, a forecast associated with the service site.

While the example clauses described above are described with respect to one particular implementation, it should be understood that, in the context of this document, the content of the example clauses can also be implemented via a method, device, system, computer-readable medium, and/or another implementation. Additionally, any of examples A-AP may be implemented alone or in combination with any other one or more of the examples A-AP.

### CONCLUSION

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the operations herein can be presented in a certain order, in some cases the ordering can be changed so that certain inputs are provided at different times or in a different order without changing the function of the systems and methods described. For example, swapping of information may occur before any stripping and assignment of anonymous identifiers. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A system comprising:
one or more processors; and
one or more non-transitory computer-readable media storing instructions that, when executed by the one or more processors, cause the system to perform operations comprising:
determining an amount of electricity available for provisioning to a plurality of service sites served by an electricity network operator operating an electricity grid, wherein the electricity grid comprises a low voltage grid;
determining a particular service site, from among the plurality of service sites, that includes a load and at least one of a local energy generation source or a local energy storage device;
using an objective function to determine a dynamic operating envelope for the particular service site, wherein the dynamic operating envelope defines, as a portion of the amount of electricity available to the plurality of service sites, an amount of power that the particular service site is permitted to put onto or take off the electricity grid during a period of time; and
communicating the dynamic operating envelope to the particular service site.

2. The system of claim 1, wherein the operations further comprise controlling at least one of a network operator managed generation source, a network operator managed distribution source, or a network operator managed storage device to balance a power consumption with a power provided at least in part by the local energy generation source or the local energy storage device.

3. The system of claim 1, wherein the plurality of service sites comprise participant service sites and non-participant service sites;
the particular service site is a particular participant service site; and
the dynamic operating envelope is determined for the particular service site based at least in part on an amount of power associated with the non-participant service sites.

4. The system of claim 1, wherein the operations further comprise:
monitoring a net power put onto the electricity grid or taken off the electricity grid by the particular service site during the period of time;
determining whether the net power put onto the electricity grid or taken off the electricity grid by the particular service site during the period of time exceeds the amount of power that the particular service site is permitted by the dynamic operating envelope to put onto the electricity grid or take off the electricity grid during the period of time; and
applying a consequence to the particular service site based at least in part on the net power exceeding the amount of power that the particular service site is permitted by the dynamic operating envelope to put onto the electricity grid or take off the electricity grid during the period of time.

5. The system of claim 1, wherein the operations further comprise:
managing, by the particular service site and based at least in part on the dynamic operating envelope, at least one of the local energy generation source or the local energy storage device to maintain a net power put onto the electricity grid or taken off the electricity grid by the particular service site during the period to be within the amount of power that the particular service site is permitted by the dynamic operating envelope to put onto the electricity grid or take off the electricity grid during the period of time.

6. The system of claim 1, wherein the objective function comprises at least one objective, and the at least one objective is at least one of:
a minimum total power delivery cost,
a minimum power generation cost,
a minimum power storage cost,
a minimum control cost,
a minimum participation opportunity cost, or
a minimum dynamic operating envelope compliance cost.

7. A method comprising:
determining, by an electricity network operator operating an electricity grid, an amount of electricity available for provisioning to a plurality of service sites served by the electricity network operator;
determining a particular service site, from among the plurality of service sites, that includes at least one of a local energy generation source, a local energy storage device, or a load;
using an objective function to determine a dynamic operating envelope for the particular service site, wherein the dynamic operating envelope defines a set of boundaries comprising an amount of power that the particular service site is permitted to put onto or take off the electricity grid during a period of time, and wherein the amount of power that the particular service site is permitted to put onto or take off the electricity grid is a portion of the amount of electricity available to the plurality of service sites; and
communicating the dynamic operating envelope to the particular service site.

8. The method of claim 7, wherein the electricity grid comprises a low voltage grid and receives energy from an energy generation source.

9. The method of claim 8, wherein the electricity grid includes an energy storage device, and wherein the dynamic operating envelope is based at least in part on a status of the energy storage device.

10. The method of claim 9, further comprising:
monitoring a received power provided by the energy generation source and the status of the energy storage device;
monitoring a net power associated with the particular service site during the period of time; and
based at least in part on the dynamic operating envelope, at least one of controlling a network operator managed asset or applying a consequence to the particular service site.

11. The method of claim 7, wherein the plurality of service sites comprise:
a first plurality of non-participant service sites, and a second plurality of participant service sites including the particular service site; and
wherein the dynamic operating envelope is determined for the particular service site based at least in part on an amount of power associated with the first plurality of non-participant service sites.

12. The method of claim 7, wherein the set of boundaries indicated by the dynamic operating envelope are based at least in part on the amount of electricity available for provisioning to the plurality of service sites during the period of time and an amount of power available for provisioning during another period of time.

13. The method of claim 7, further comprising: determining, based at least in part on the dynamic operating envelope, a forecast associated with the electricity grid.

14. The method of claim 7, wherein the dynamic operating envelope is based at least in part on an objective function, wherein the objective function comprises a plurality of function elements associated with at least one of grid information, service site information, status information, or objective function parameter information.

15. The method of claim 14, wherein the objective function comprises at least one objective, and the at least one objective is at least one of:
a minimum total power delivery cost,
a minimum power generation cost,
a minimum power storage cost,
a minimum control cost,
a minimum participation opportunity cost, or
a minimum dynamic operating envelope compliance cost.

16. The method of claim 7, wherein the local energy generation source is at least one of a solar energy source, a wind energy source, a hydroelectric energy source, a heat pump energy source, a geothermal energy source, a biomass energy source, or a fuel energy source.

17. One or more non-transitory computer-readable media storing instructions that, when executed by one or more processors, cause the one or more processors to perform operations comprising:
determining an amount of electricity available for provisioning to a plurality of service sites served by an electricity network operator that is operating an electricity grid, wherein the electricity grid includes a low voltage grid and a network operator managed energy storage device, and wherein the electricity grid receives energy from at least one high or medium voltage energy generation source;
determining a particular service site, from among the plurality of service sites, that includes at least one of a local energy generation source, a local energy storage device, or a load;
using an objective function to determine a dynamic operating envelope for the particular service site, wherein the dynamic operating envelope defines, as a portion of the amount of electricity available to the plurality of service sites, an amount of power that the particular service site is permitted to put onto or take off the electricity grid during a period of time; and
communicating the dynamic operating envelope to the particular service site.

18. The one or more non-transitory computer-readable media of claim 17, wherein the operations further comprise:
monitoring a power provided by the at least one high or medium voltage energy generation source;
monitoring a status of the network operator managed energy storage device, wherein the dynamic operating envelope is based at least in part on the status of the network operator managed energy storage device;
monitoring a power consumption of the electricity grid; and
controlling, based at least in part on the dynamic operating envelope, a network operator managed asset to balance the power consumption with the power provided by the at least one high or medium voltage energy generation source and the network operator managed energy storage device.

19. The one or more non-transitory computer-readable media of claim 17, wherein the operations further comprise:
monitoring a net power associated with the particular service site during the period of time; and
based at least in part on the dynamic operating envelope, applying a consequence to the particular service site.

20. The one or more non-transitory computer-readable media of claim 17, wherein the plurality of service sites comprise participant service sites and non-participant service sites;
the particular service site is a particular participant service site; and
the dynamic operating envelope is determined for the particular participant service site based at least in part on an amount of power associated with the non-participant service sites.

21. The one or more non-transitory computer-readable media of claim 17, wherein the amount of power indicated by the dynamic operating envelope varies based at least in part on multiple periods of time.

22. The one or more non-transitory computer-readable media of claim 17, wherein the objective function comprises at least one objective, and the at least one objective is at least one of:
a minimum total power delivery cost,
a minimum power generation cost,
a minimum power storage cost,
a minimum control cost,
a minimum participation opportunity cost, or
a minimum dynamic operating envelope compliance cost.
